(19) United States
(12) Patent Application Publication
(10) Pub. No.: US 2007/0027715 A1
(43) Pub. Date: Feb. 1, 2007

(54) Private health information interchange and related systems, methods, and devices

(75) Inventors: Adrian Gropper, Watertown, MA (US); William L. Donner, Bronxville, NY (US); Sean Doyle, Watertown, MA (US)

Correspondence Address: FISH & NEAVE IP GROUP;ROPES & GRAY LLP, ONE INTERNATIONAL PLACE, BOSTON, MA, 02110-2624, US

(73) Assignee: MedCommons, Inc., Watertown, MA (US)

(21) Appl. No.: 11/451,899

(22) Filed: Jun. 13, 2006

Related U.S. Application Data
(60) Provisional application No. 60/689,803, filed on Jun. 13, 2005.

(51) Int. Cl. G06Q 10/00

(52) U.S. Cl. 705/2

(57) ABSTRACT

A healthcare information interchange system including a sender for originating one or more healthcare information documents associated with a patient, a first repository in communication with the sender for i) storing the one or more healthcare information documents received from the sender and ii) distributing the one or more healthcare information documents based on consent rules associated with each of the one or more documents, a recipient for receiving the one or more healthcare information documents based on the consent rules, and an identity provider for assigning first and second identities to the patient, the first identity being presented to the first repository by the sender to identify the patient, the second identity being presented by the first repository to the recipient to identify the patient.

### REFERENCE TO RELATED APPLICATIONS

This application claims the benefit of and priority to U.S. Provisional Application No. 60/689,803, filed on Jun. 13, 2005, entitled “A Sustainable Patient-Centric Network For Private Health Information Interchange,” the entire teachings of which are incorporated herein by reference.

This application also incorporates by reference the entire contents of the following co-pending U.S. Patent Applications: U.S. Ser. No. 11/352,704, filed on Feb. 10, 2006, U.S. Ser. No. 11/089,592, filed on May 17, 2004, and U.S. Ser. No. 11/089,567, filed on Mar. 19, 2004.

### FIELD OF THE INVENTION

The invention relates generally to systems, methods and devices for the electronic distribution of healthcare information. More particularly, in various embodiments, the invention relates to the interchange of health information between different healthcare entities.

### BACKGROUND

Healthcare or medical information systems are typically sold to medical institutions and, not surprisingly, focus on the needs of institutions. As data management shifts from paper and film to digital protocols, sharing data outside of healthcare institutions, and thereby comparing healthcare across institutions, has become an ever larger problem for both patients and payors (including Medicare). Numerous information management standards such as the Integrating the Healthcare Enterprise (IHE) and mandates such as the Health Insurance Portability and Accountability Act (HIPAA) are aimed at integrating and aggregating data between vendors of healthcare information systems. Although these standards and mandates address some of the technical impediments to integration of data across institutions, their effectiveness is limited by the inherent lack of motivation of the institutional customers and the systems vendors that serve them.

The sharing of medical data or healthcare information across institutions having medical document repositories raises valid concerns about patient privacy and the risk of intrusion by payors into the practice of medicine. These concerns have been used by health care institutions to effectively delay implementation of meaningful data sharing technologies.

The interoperability between healthcare information or medical document repositories of unaffiliated enterprises or institutions is desirable from the point of view of both the patient and society. Unfortunately, broad sharing of personal medical information poses the risk of unintended or unlawful disclosure of private medical and/or healthcare information. The registries that have been proposed for broad interoperability and national-scale information access are uneconomical (relative to their benefit) because of the cost of getting informed consent from the patient/owner of the personal medical information.

Existing technologies provide ways to communicate authorizations across federated entities to enable the exchange of healthcare documents among healthcare entities such as hospitals. Recent initiatives designed to align the incentives of patients and payors to make more individualized and less wasteful choices include health savings accounts (HSA) for patients and pay-for-performance plans for physicians. These initiatives are most effective when they allow crossing of enterprise boundaries by patients and cross-enterprise comparisons of quality and performance and, in turn, call for interoperability and archival stability that we took for granted with paper and film medical records.

Early attempts at digital interchange of protected health information (PHI) have been based on massive regional registries of information that is mostly opaque to patients and typically expensive to access for research or public health reasons because of limited ability to seek informed consent by the patient. Thus, there is a need for a less restrictive and more cost effective, yet secure, approach to enabling the interchange of PHI information.

### SUMMARY

The invention, in various embodiments, addresses deficiencies in the prior art by providing systems, methods and devices that enable secure, yet cost efficient, interchange of private health information among various patient-authorized entities.

The invention includes a method, system, or device for private and secure digital communications among health care providers and patients using standard protocols and the Internet where at least two of the principals to a transfer of protected health information (PHI) (e.g.: sender, recipient, patient) is assigned and controls a private repository. Repositories are accessed using standard protocols such as the ASTM Continuity of Care Record (CCR) and Secure HTTP (SSL). Transfers between repositories are managed by a service, e.g., MedCommons, according to consent agreements that are executed between the sender and the patient. The service also provides editing and display technology for the contents of each user's repository and their associated security (e.g.: HIPAA) logs.

With appropriate configuration and management policies, a patient-centric network of repositories can provide private communications between any consenting parties, regardless of institutional affiliation, at very low actual cost while avoiding the hidden costs of vendor lock-in to proprietary formats and methods and without the usual risk to privacy that results from collecting and indexing massive amounts of private information in readily “mined” and very tempting registries.

In various aspects, the invention establishes a system, method, and/or protocol by which a first (sending) information repository mediates the consent of a sender, e.g., a patient's physician, to transfer private medical information or PHI to a second repository that is under the control of a recipient, e.g., a hospital, that may be utilizing a standard federation or single-sign on mechanism. For example, the mechanism may include the Liberty Alliance federation and privacy specifications and the use of ASTM-CCR as standards.

In one aspect, the invention utilizes certain protocols as a point-to-point potential standard such as, without limitation, the Commons eXchange Protocol (CXP), which features the innovation that the protocol carries information about the first (sending) repository as well as the second (receiving) repository. Therefore, the invention allows the first repository to, under certain conditions, enforce an account-based consent prior to disclosure of information, e.g., PHI, to second (receiving) repository.

In one configuration the invention uses CXP (CCR-based documents and multiple registries) and federation standards, e.g., Liberty, in combination to enable patient consent of the exchange of their associated PHI between their repository service and a federated service. In another feature, the invention provides a point-to-point protocol between any sender and any repository via, for example, the Internet, to enable PHI interchange using standards-based federation and standards-based medical documents.

In another aspect, the invention includes a healthcare information interchange system including a sender for creating one or more healthcare information documents and a first repository in communication with the sender. The first repository may be configured for storing the one or more healthcare information documents received from the sender and ii) distributing the one or more healthcare information documents based on an access control rule associated with each of the one or more documents. The information system may also include a second repository in communication with the first repository for receiving the one or more healthcare information documents based on the access control rule associated with each the one or more healthcare information documents.

In one feature, the access control rule is based on a consent agreement between the sender and the first repository. The consent agreement may be derived from a patient healthcare information restriction form. The access control rule may be based on whether the one or more healthcare information documents are encrypted. In another feature, the first repository distributes the one or more healthcare information documents if the one or more healthcare information documents are determined to be encrypted.

In one configuration, the system includes a recipient for accessing the one or more healthcare information documents at the second repository. In another configuration, the system includes an identity provider for publishing public encryption key information related to the recipient. In one feature, the access control rule includes determining that the one or more healthcare information documents has been encrypted using an encryption key related to the recipient.

In another feature, the access control rule is based at least on a PIN associated with the one or more healthcare information documents that is shared between the sender and recipient. The PIN may be presented by the recipient to one of the first and second repositories to enable access to the one or more healthcare information documents. The sender may be a patient, a physician, a healthcare professional, a hospital, or another healthcare-related entity that handles PHI.

In a further aspect, the invention includes a healthcare information interchange system having a sender for originating one or more healthcare information documents associated with a patient, a first repository in communication with the sender for i) storing the one or more healthcare information documents received from the sender and ii) distributing the one or more healthcare information documents based on consent rules associated with each of the one or more documents, a recipient for receiving the one or more healthcare information documents based on the consent rules, and an identity provider for assigning first and second identities to the patient, the first identity being presented to the first repository by the sender to identify the patient, the second identity being presented by the first repository to the recipient to identify the patient.

### BRIEF DESCRIPTION OF THE DRAWINGS

These and other features and advantages of the invention will be more fully understood by the following illustrative description with reference to the appended drawings, in which like elements are labeled with like reference designations and which may not be to scale.

FIG. 1 is a system diagram showing the logical connections between two institutions and a central facility according to an illustrative embodiment of the invention.

FIG. 2 is a system diagram showing a multiplicity of institutions connected to the central facility according to an illustrative embodiment of the invention.

FIG. 3 is a diagram of the logical elements of a system router component according to an illustrative embodiment of the invention.

FIG. 4 is a diagram of the logical elements of a system access interface component according to an illustrative embodiment of the invention.

FIG. 5 is a diagram of the logical elements of the system central facility according to an illustrative embodiment of the invention.

FIG. 6 is a diagram of the logical elements of the router, access interface, and central facility in an operational variation of the invention utilizing CCOW.

FIG. 7 is a table detailing a first method of transfer of data between institutions and the central facility where the data is aggregated by the central facility according to an illustrative embodiment of the invention.

FIG. 8 is a table detailing a second method of transfer of data between institutions and the central facility where the data is streamed by the central facility according to an illustrative embodiment of the invention.

FIG. 9 shows the system connected to a DICOM LAN of an institution while functionally appearing similar to a typical modality connection such as a workstation according to an illustrative embodiment of the invention.

FIG. 10 is a diagram detailing the flow of data, orders, encryption keys, and requests for studies between two routers, the central facility and a workstation, according to an illustrative embodiment of the invention.

FIG. 11 is a diagram of the logical elements included in a transmitted Study according to an illustrative embodiment of the invention.

FIG. 12 is a diagram of the display in a DICOM viewer showing the order form and series thumbnails with an image series selected and displayed above according to an illustrative embodiment of the invention.

FIG. 13 is a diagram of the display in a DICOM viewer showing the order form and series thumbnails with the order form selected and displayed above according to an illustrative embodiment of the invention.

FIG. 14 is a conceptual diagram of a healthcare information system according to an illustrative embodiment of the invention.

FIG. 15 is an exemplary view of a user registration page according to an illustrative embodiment of the invention.

FIG. 16A is an exemplary view of secure site logon form according to an illustrative embodiment of the invention.

FIG. 16B is an exemplary view of a secure logon form including a tracking number input according to an illustrative embodiment of the invention.

FIG. 17 is an exemplary continuity of care and/or electronic referral form according to an illustrative embodiment of the invention.

FIGS. 18A-C include an exemplary request to restrict patient information according to an illustrative embodiment of the invention.

FIG. 19 is an exemplary view of a continuity of care electronic folder stack according to an illustrative embodiment of the invention.

FIG. 20 is an exemplary view of an account page form including a HIPAA log link according to an illustrative embodiment of the invention.

FIG. 21A is a flow diagram of a process for updating patient healthcare information and establishing patient control of access to the information according to an illustrative embodiment of the invention.

FIG. 21B is a flow diagram of a process for providing electronic referrals with patient notification according to an illustrative embodiment of the invention.

FIG. 21C is a flow diagram of a process for providing electronic referrals via an information gateway according to an illustrative embodiment of the invention.

FIG. 22 is a conceptual diagram of a healthcare system including a registry to enable patient control of healthcare information according to an illustrative embodiment of the invention.

FIG. 23 is an exemplary table of a registry according to an illustrative embodiment of the invention.

FIGS. 24A-D include exemplary views of the process of a physician sign on to obtain access to a CCR according to an illustrative embodiment of the invention.

FIGS. 25A-C include exemplary views of the process of sending a patient CCR to a regional health organization according to an illustrative embodiment of the invention.

FIGS. 26A-D include exemplary views of the process of a patient sign on to access their healthcare information according to an illustrative embodiment of the invention.

FIG. 27 is a conceptual flow diagram of the interaction of various system users and systems elements that enable the interchange of PHI according to an illustrative embodiment of the invention.

FIG. 28 is a conceptual block diagram showing a system that enables the interchange of PHI via a central repository while using an ID provider to provide PHI security according to an illustrative embodiment of the invention.

FIG. 29 is a conceptual block diagram of a system including sending and receiving repositories of PHI according to an illustrative embodiment of the invention.

### ILLUSTRATIVE DESCRIPTION

The invention, in various embodiments, provides systems, methods and devices that enable to the efficient, yet secure, interchange of PHI between at least two patient-authorized entities.

“Individually identifiable health information” includes information that is a subset of health information, including demographic information collected from an individual, and; (1) Is created or received by a health care provider, health plan, employer, or health care clearinghouse; and (2) Relates to the past present, or future physical or mental health or condition of an individual; the provision of health care to an individual; or the past, present, or future payment for the provision of health care to an individual; and (i) That identifies the individual; or (ii) With respect to which there is a reasonable basis to believe the information can be used to identify the individual. “Protected Health Information” includes individually identifiable health information that is: (1) Transmitted by electronic media; (2) Maintained in electronic media.

“Electronic media” includes: (1) Electronic storage media including memory devices in computers (hard drives) and any removable/transportable digital memory medium, such as magnetic tape or disk, optical disk, or digital memory card; or (2) Transmission media used to exchange information already in electronic storage media. Transmission media includes, for example, the internet (wide-open), extranet (using internet technology to link a business with information accessible only to collaboration parties), leased lines, dial-up lines, private networks, and the physical movement of removable/transportable electronic storage media.

“health care provider” includes providers of medical or health services, and any other person or organization who furnishes, bills, or is paid for health care in the normal course of business.

“Trusted Intermediary” includes an entity for communication and storage of health information. The Trusted Intermediary may be compliant with certain laws and/or regulations. In certain embodiments, the Intermediary is HIPAA compliant and operates as a Trust Service Provider.

“Trust Service Provider” includes an entity that provides services to authenticated patients, and/or other authenticated parties, relating to storage and transfer of health information. Preferably, the Trust Service Provider employs cryptographic techniques.

“Central registry log” includes a file on electronic media relating to each instance of communication of Protected Health Information containing the information necessary to maintain HIPAA compliance by the Client entities covered by HIPPA and document the privacy practices of a registry as implied in its contract with the patient.

“Authentication” includes the verification of the identity of an entity, the corroboration that a person is who he/she is claiming to be, and/or the verification that a message has not be altered or originated from a particular entity.

“HIPAA” includes the combined regulations of the Health Insurance Portability and Accountability Act of 1996 and 45 CFR Parts 160 and 164.

“HIPAA-compliant DICOM router” includes a networking device which processes DICOM data using HIPAA based rules for the selection, assembly, transmission or display of logical entities of Protected Health Information.

“DICOM” means the Digital Imaging and Communications in Medicine standard jointly developed by the American College of Radiology and the National Electrical Manufacturers Association for the communication of digital images and associated data.

“DICOM LAN” includes a local area network utilizing the DICOM standard.

“PACS” means Picture Archiving and Communication Systems.

“Continuity of Care Record” (CCR), includes a standard specification that has been developed jointly by ASTM International, the Massachusetts Medical Society (MMS), the Health Information Management and Systems Society (HIMSS), the American Academy of Family Physicians (AAFP), the American Academy of Pediatrics, the American Medical Association (AMA), the Patient Safety Institute, the American Health Care Association, the National Association for the Support of Long Term Care, and the Mobile Healthcare Alliance. This new specification is intended to foster and improve continuity of patient care, to reduce medical errors, and to assure at least a minimum standard of health information transportability when a patient is referred or transferred to, or is otherwise seen by, another provider.

An “Affinity Domain” includes people and the information systems they employ that have agreed to policies in advance which address governance and operational structure, privacy, security, normalized patient identification, and coded vocabularies. Although this kind of formal prearrangement is reasonable between institutions, it may be inconvenient and unmanageable for individual patients (and even doctors) that want to deal with new entities and individuals that may not have pre-established an Affinity Domain relationship.

“Cross-enterprise Data Sharing” (XDS) includes a vendor-accepted data communications standard for linking institutions and exchanging information.

“Regional Health Information Organization” (RHIO) includes a multi-stakeholder organization that enables the exchange and use of health information, possibly in a secure manner, for the purpose of promoting the improvement of health quality, safety and efficiency. RHIOs may be considered the building blocks for the national health information network (NHIN). When complete the NHIN will provide universal access to electronic health records. RHIOs may eliminate some administrative costs associated with paper-based patient records, provide quick access to automated test results and offer a consolidated view of a patient's history.

“Registry ID” includes a user and/or patient identifier assigned by a registry and/or central facility. The registry ID may also be referred to as an account ID, voluntary ID, or a user enterprise ID under certain conditions.

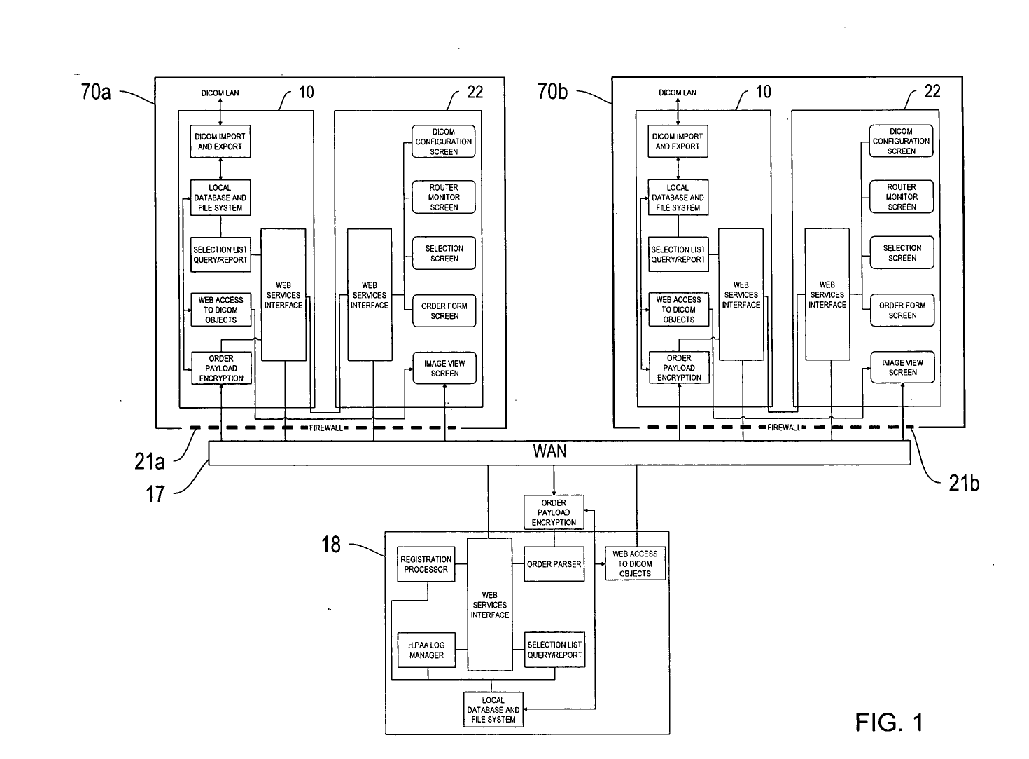

FIG. 1 shows a system and method for electronically moving DICOM data between institutions A and B under the control of an intermediary central facility 18 according to an illustrative embodiment of the invention. For simplification of our description and without limitation, we refer to A as the sender and B as the receiver. The suggested implementation of the invention include a computer system 70 on the institutional DICOM LAN that has DICOM Picture Archiving and Communication System (PACS). These systems may be under the control of one or more User(s) with access privileges. For example, a user may be allowed by an institution to install and/or operate a DICOM workstation. Furthermore, institution A may include computer system 70A while institution B includes computer system 70B. The computer system 70 may include one or more processors and/or computer servers supporting applications that perform various functions of the invention.

The institutions A and B and central facility 18 communicate over a WAN 17, which typically is the Internet but may be any communication network. The elements of the system are comprised of router 10, access interface 22 and intermediary central facility 18. We use the term central facility in a generic sense and it is not intended to be limiting. It is intended that multiple central facilities may be part of the infrastructure for the purposes of redundancy as a fail-over mechanism to increase reliability, to provide sufficient throughput and resource allocation, and to provide for regional segregation to satisfy, for instance, national regulatory issues, etc. Our description is of a single central facility to simplify the explanation in the embodiment.

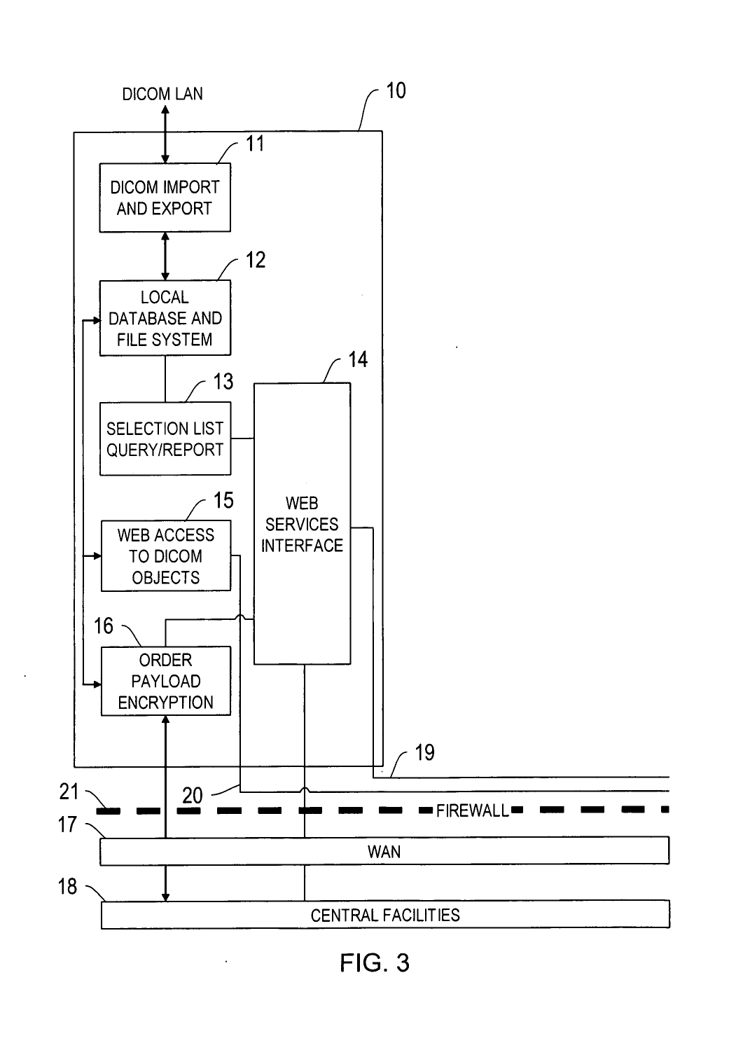

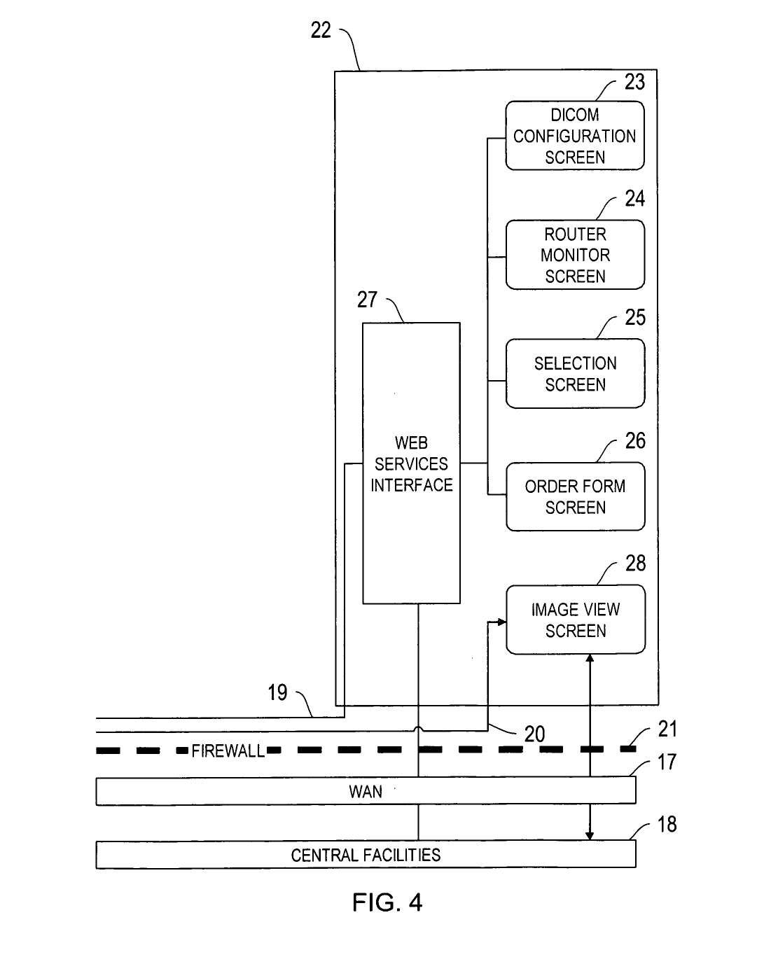

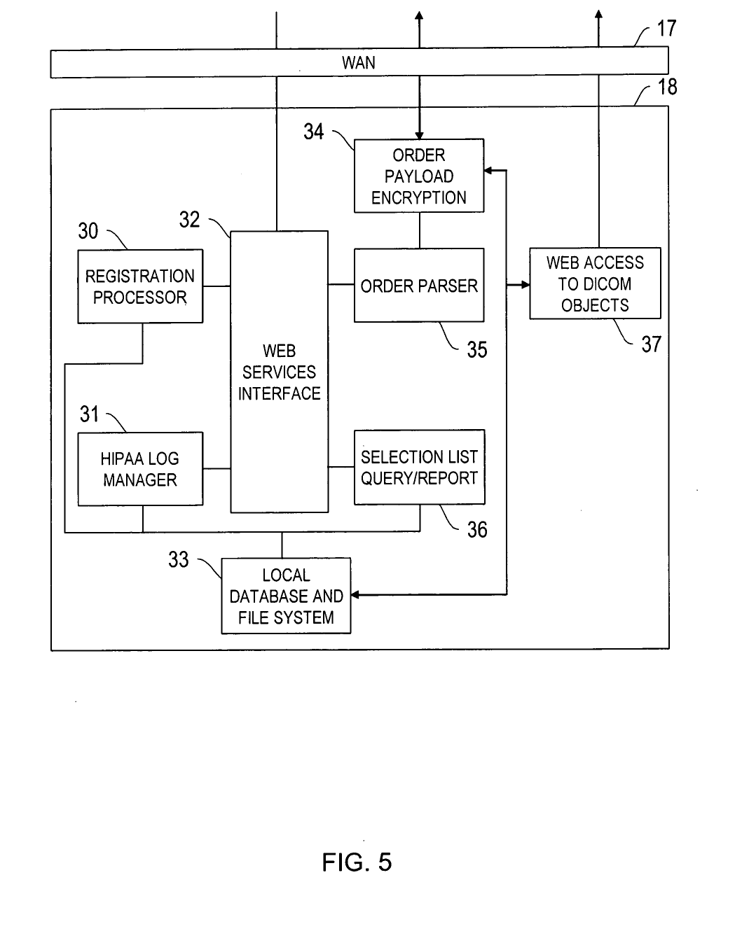

Referring to FIG. 3, FIG. 4 and FIG. 5 a DICOM Configuration Screen 23 configures the Router 10 to join the DICOM network, though automated methods which search and discover the environment may be incorporated. The DICOM Import and Export 11 is used to populate and update a Local Database and File System 12 of imaging studies in accordance to a user's privileges and role relative to the PACS. Though a local database is preferable, it is conceivable that “local database” data would be provided via the network via other devices or network storage devices. The Local Database and File System 12 provides temporary storage of imaging studies and items such as pending orders that might be the subject of a transfer. A Selection List Query/Report 13 responds to parameters entered by the User on Selection Screen 25 with a report that populates a list on the Selection Screen 25 with items from Local Database and File System 12. Alternate embodiments would build a Selection List Query Report 13 by a query to the PACS directly. Web Services Interface 14 and 27 relay messages between the Router 10 and Access Interface 22 using standard protocols over LAN connections 19 and 20. The web interface represents an example of network interconnection and protocol. The Router 10 can be located on a different computer form the Access Interface 22 and multiple Access Interfaces 22 can communicate with multiple Routers 10.

In use the User picks one or more items from the Selection Screen 25. Each item typically represents a DICOM Study. The item(s) selected populate the payload field of an instance of an Order as displayed on the Order Form Screen 26. Information such as the Patient's name, and Referring Physician are derived from the DICOM Study metadata and can be used to populate other fields of the Order Form Screen 26. Furthermore, the Order Form Screen 26 can use the Web Services Interface 27 to fetch additional information form the intermediary central facility 18 by using Patient, Physician and other information such Procedure that is available in the DICOM metadata.

An Image View Screen 28 may be available to the User for quality control purposes during the Order creation process. A Web access to DICOM Objects (WADO) 15 module supports the Image View Screen 28. Alternate embodiments would have DICOM access to the Router 10 by a Diagnostic or 3D Workstation or could access images directly from the Local Database and File System 12.

Finalization of the Order, as communicated via the Web Services Interface 14, triggers the Order payload encryption 16 to package the payload and Order information for transport over the WAN to the intermediary central facility 18. In alternate embodiments, transport of Order and Payload are subject to various optimizations such as the encryption and speculative streaming of DICOM images as they come in or the use of image compression. The intent of 16 is to provide privacy mechanism over to 10. Hence, private lines, SSL and other methods known in the art of information security may be applicable. A wireless WAN module or other means in the Router 10 can provide an alternative way to bypass the institutional firewall and preferably have the Router serve that firewall function in order not to compromise the institution's network. In cases where the Order does not require the central facility to store the Payload, direct Router to Router Transfers are possible, with the central facility performing all the coordination, auditing and payment accounting, but not transfer of the actual Payload data blocks.

The intermediary central facility 18 provides temporary buffering and routing for studies of the way to Routers 10 at other facilities. In some cases, 18 may provide archiving as a secondary function. Orders are typically decrypted and re-encrypted with keys that are specific to the destination Router 10. We can represent in FIG. 1 source router 10 in Box A and Destination router 10 in Box B. Payload metadata may be examined to assist in routing if the Order Form itself does not have sufficient information. Payload images and reports are made available directly to Web browsers using a WADO module 37 at the intermediary central facility 18. The intermediary central facility 18 keeps a HIPAA log of transfers that is accessible to the Patient and to other authorized Users and further provides long term archiving. The intermediary central facility 18 allows the speculative capture of images accompanied by incomplete or poorly specified Order Forms. Manual intervention can be used to update and finalize an Order. The intermediary central facility 18 is designed in a way that is compatible with transport and storage of payloads that are encrypted with keys that are not available to the intermediary central facility 18. The HIPAA log contains information that can document privacy and security breaches including a time/date stamp, a tracking number or other link to transaction details and a record of the parties to the transaction such as the Operator of the sending device, the Recipient of the PHI and the Authority that validated their credentials. Other non-HIPAA logging information, such as, without limitation, payment information, Quality of Service information, and other forms of reporting, may be included. Although logs, including security logs, are common, logs which are controlled by an institution (e.g.: a hospital) or the vendor to an institution (e.g.: a PACS vendor) are not under the control of a patient or a physician in the sense of the present invention. The central facility we describe is novel, at least because, it serves the legal and practical requirement for logs (e.g. the HIPAA Log) without the permission or control of the institutions that manage the network and viewing technology being used by an individual physician or patient.

Referring to FIG. 1 and FIG. 5, the intermediary central facility 18 services requests that come in through, preferably, a Web Services Interface 32 from a typical Web browser and Web Access to DICOM Objects 37 and via Order Forms that travel with DICOM payloads. The Registration processor 30 is used to create and update a User or Institution profile in the Local Database and File System 33. The Registration Processor 30 can provide information about a User (Patient, Physician) or Institution as an Order Form is being filled out to improve the reliability and security of Order processing. The Registration Processor 30 is also able to issue Tracking Numbers to confirm an acceptable Order and as a Pre-requisite to finalizing an Order Form. A finalized Order Form is one that has been confirmed by both the intermediary central facility 18 and the User. Intermediary central facility 18 confirmation is typically associated with the issuance of a Tracking Number.

User confirmation is typically associated with an electronic signature on the Order Form. A credit card transaction is optionally associated with the finalization of the Order Form and may be processed by the Registration Processor 30 or by a separate charge capture mechanism. A finalized Order Form arrives at the intermediary central facility 18 in association with an encrypted payload. The Order Parser 35 interprets visible and hidden fields of the Order Form as storage and routing instructions. If an Order is incomplete or otherwise inadequate, the payload may be sequestered pending additional manual intervention. The Order Parser 35 directs the Order Payload Encryption 34 module to decrypt the payload for storage in the Local Database and File System 33. Alternatively, payloads may be stored without decryption. The Order Parser 34 directs the Order Payload Encryption module 34 to encrypt the payload with a new key associated with the destination Router and User. The Order Payload Encryption module 34 can then forward the payload to the destination Router using protocols appropriate to WAN transport of large objects. A registered User may access Studies and in-process Orders via the Selection List Query/Report 36 accessed through Web Services or directly from a Web Browser. A Study listed in a Selection List Query/Report 36 can be viewed directly from the intermediary central facility via the WADO viewer 37. Intermediary central facility 18 WAN transport protocols include Web Services over HTTP and HTTPS, direct HTTP (S) interactions with Web Browsers and other protocols that are more appropriate to the transport of Binary Large Objects. It is assumed that most Routers 10 and Access Interfaces 22 will be located behind firewalls 21, 21A, 21B that the intermediary central facility 18 has no control over. To cross firewalls 21,21A, 21B with little or no reconfiguration, Routers 10 work with the Intermediary central facility 18 in a manner that allows the Routers 10 to initiate transfers either as a result of User actions or automatically using a polling mechanism.

According to one feature, the system is designed and configured to partition the health care specific elements which function in accordance with health care related standards, such as DICOM, from the non health care related components which function in accordance with standards other than health care standards. This partitioning is expressed in the health care related components of the system being associated with the router 10 and non health care components being associated with access interface 22. This design enables generalizable development of the non-health care related components such as security, certificate signing, workflow, etc.

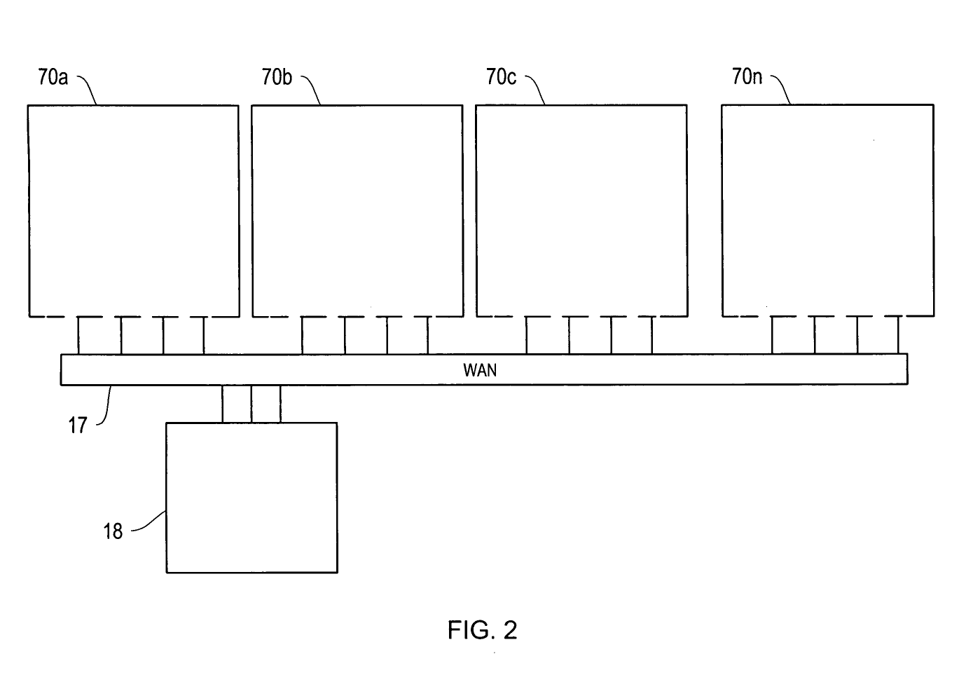

FIG. 2 depicts the connection of any number (1, 2, 3, n) of numerous institutions via numerous computer systems 70a, 70b, 70c, and 70n that connect to the intermediary central facility 18. The primary connection of each institution is to the intermediary central facility 18. The institutions require no functional direct connection to each other and without the actions and management of the intermediary central facility 18 no usable data transfers occurs. In alternate embodiments employing the direct transfer of encrypted payload components between institutions, the transferred components are not useable until a matching Order arrives from the central facility 18.

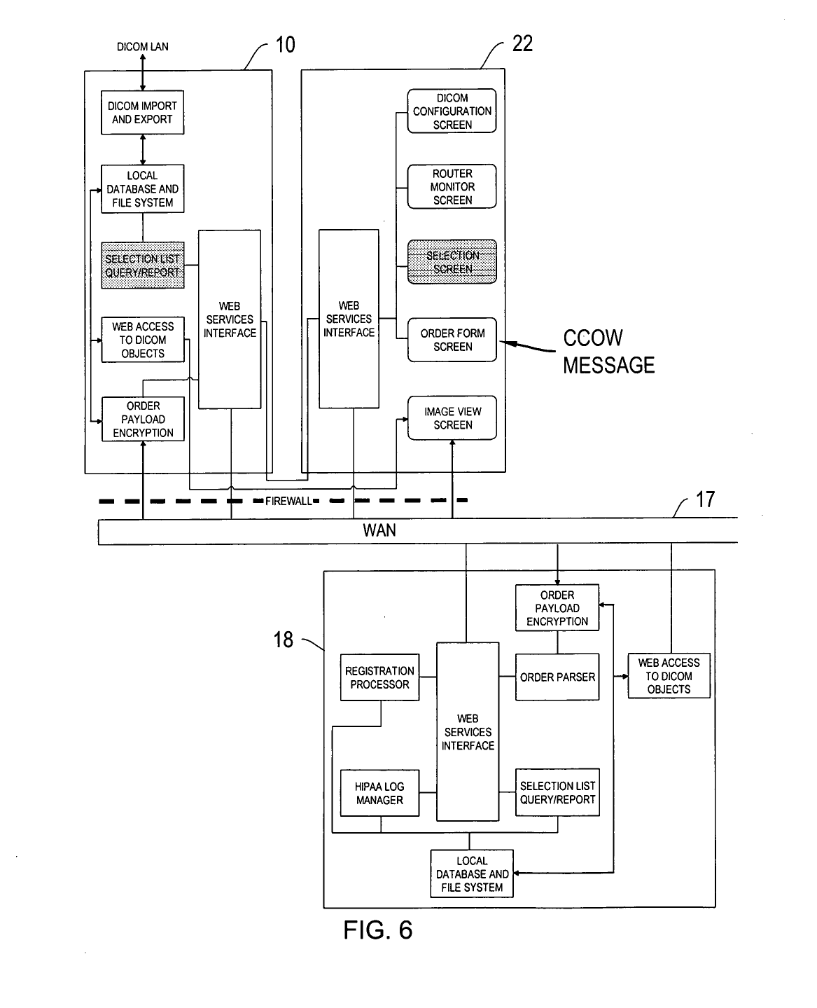

A variation of the utilization of the system is shown in FIG. 6. The acronym CCOW stands for “Clinical Context Object Workgroup”, a reference to the standards committee within the HL7 group that developed the standard. CCOW is a vendor independent standard developed by the HL7 organization to allow clinical applications to share information at the point of care. Using a technique called “context management”; CCOW allows information in separate healthcare applications to be unified so that each individual application is referring to the same patient, encounter or user. CCOW works for both client-server and web-based applications. This means that when a clinician signs onto one application within a CCOW environment, and selects a patient, that same sign-on is simultaneously executed on all other applications within the same environment, and the same patient is selected in all the applications, saving clinician time and improving efficiency. As shown in FIG. 6 in a facility where the Electronic Medical Record (EMR) or PACS supports CCOW, the entire selection process 13 and 25 might be eliminated. A patient or study focus in the EMR will be communicated directly and automatically to the Order Form Screen 26.

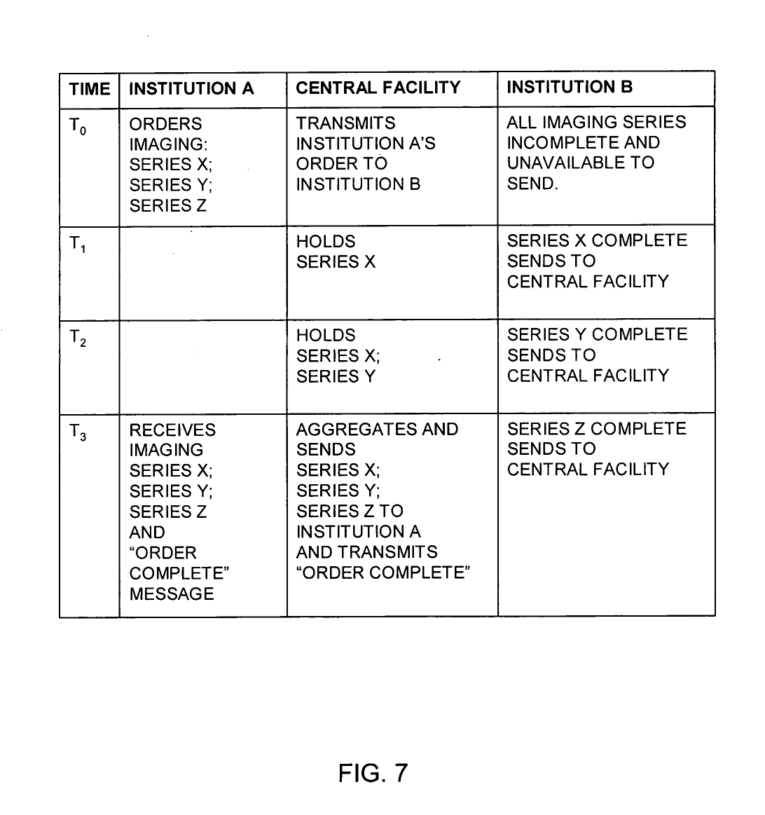

The precise action of the intermediary central facility 18 with regard to the actual transfer of radiological digital image data is flexible and can be adjusted to suit the institutions involved. FIG. 7 is a table showing the nature of the data transfer with respect to two institutions and time. When the data is initially requested by institution A it is unavailable at institution B. Subsequently, as the data becomes available, institution B transfers Series X, Series Y, Series Z to the intermediary central facility which holds and aggregates the Series X,Y and Z until complete and then transfers the data to institution A.

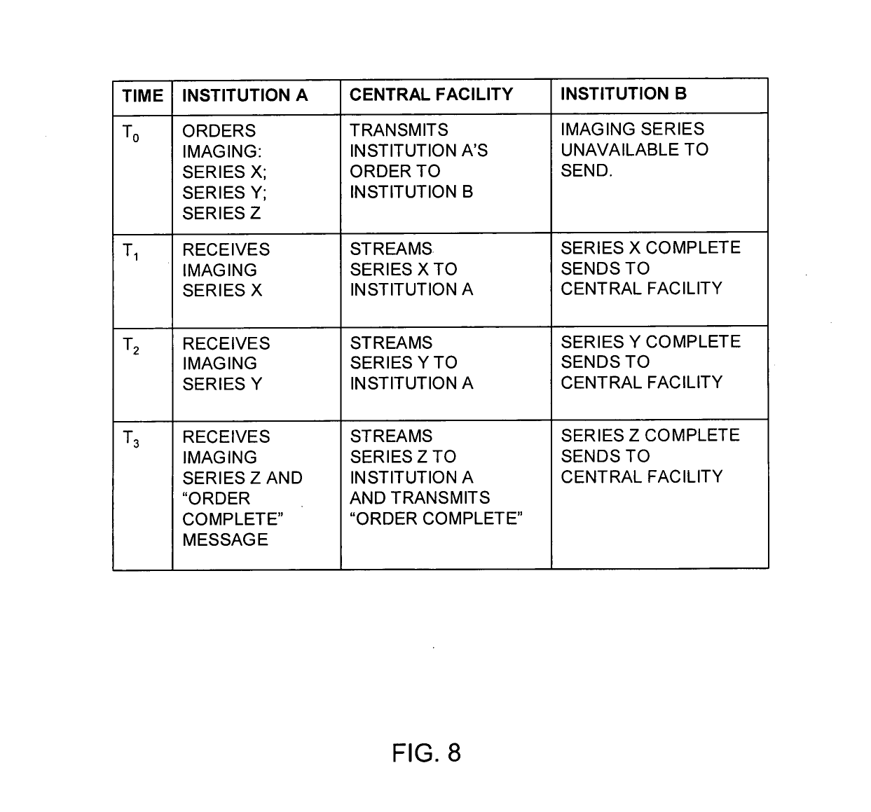

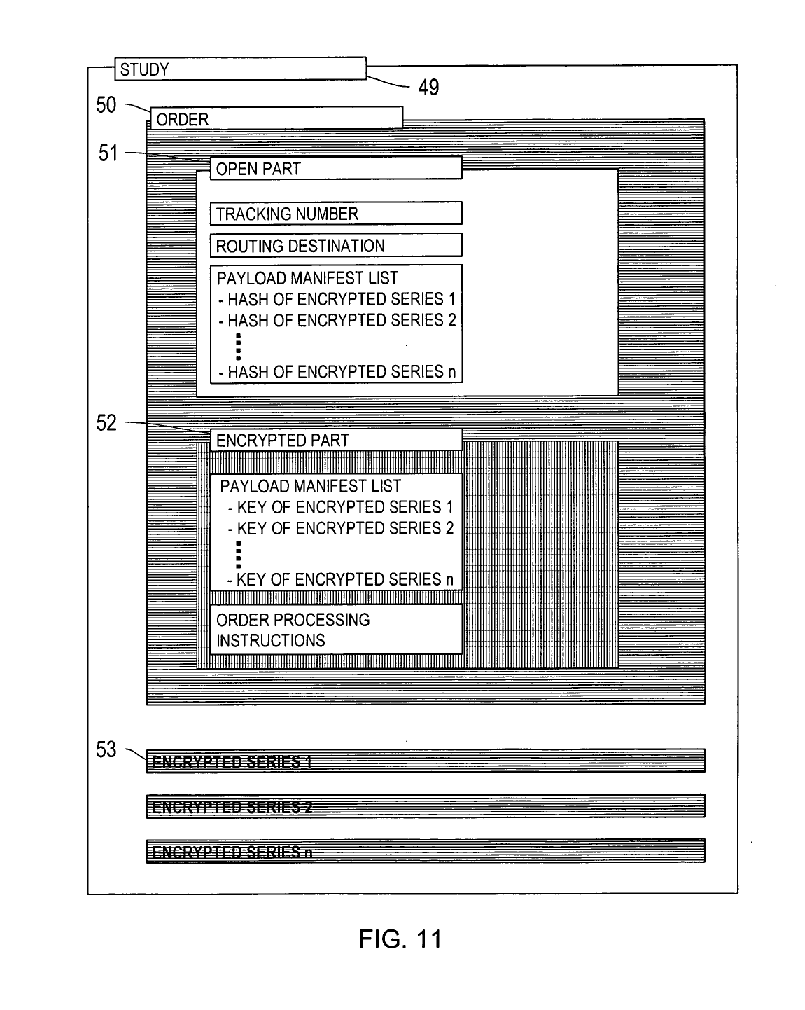

FIG. 8 includes a table similar to FIG. 7, which again shows the nature of data transfer with respect to two institutions over a period of time. As in FIG. 7 when the data is initially requested by institution A it is unavailable at institution B. In FIG. 8 rather than hold and aggregate the data the intermediary central facility streams the data to institution A contemporaneously as it is received from institution B. An alternate embodiment allows the image data, but not the Order, to bypass the central facility 18. The Order 50 (FIG. 11) may travel as a supplemental Series to an original Study or independently when the Encrypted Series bypass the central facility 18. In time-sensitive streaming applications, each Series may travel separately as it becomes available and the Order 50 would be updated by the central facility 18 as each Series completes.

The intermediary central facility manages the data transfer between institutions and could also effect, through the appropriate management of encryption/decryption and authentication keys, the direct transfer of data (aggregated or streamed) from institution B to institution A or the reverse.

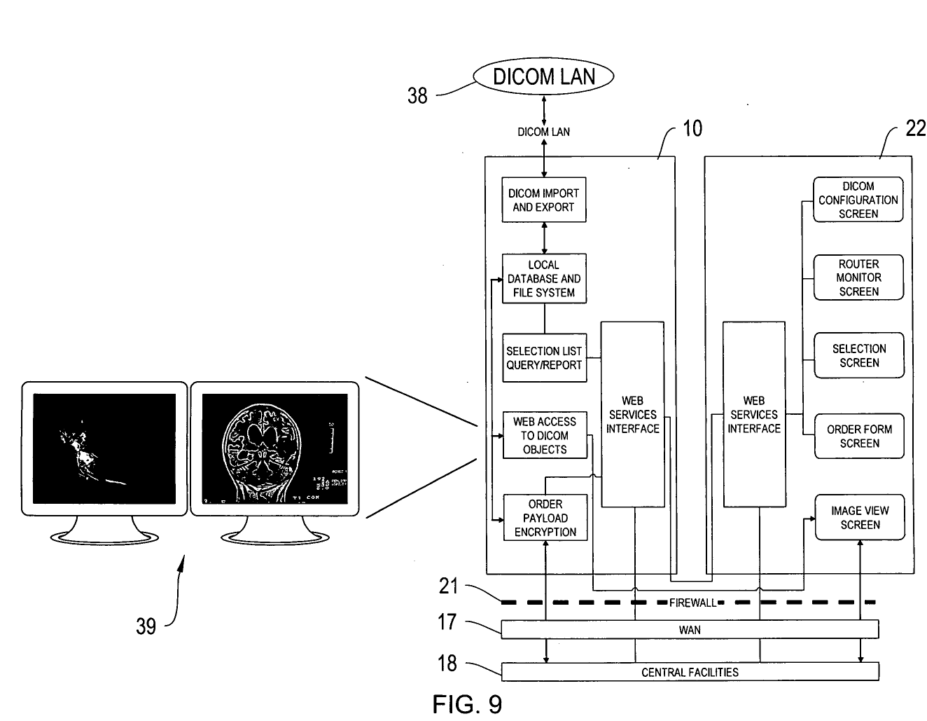

An important aspect of the system is its “Virtual” nature. Institutional networks are complicated by technical, administrative, legal, and regulatory requirements. Opening up these networks directly to each other is a complex problem that is normally not attempted. As shown in FIG. 9 the system 10, 22, 21, 17, 18 of the present invention effects a routine connection to an institution's DICOM LAN 38 in a manner that makes the entire system of the present invention appear as a “Virtual Modality” similar to a workstation 39 or any other modality on the DICOM LAN 38 requiring just routine technical, administrative, legal or regulatory involvement.

Though optional, the system may include one or more of user/institution provisioning (bootstrap) and registry services and related components. As some of the techniques are cryptographic in nature, keys must be provisioned to the appropriate entities. Institutions may have public and/or private keys registered by the central facility or another related component external of the central facility which for simplicity of description we assume exists at the central facility. Keys, and similarly, passwords, PINs, token authentication, other authenticators, etc. are associated with the institution to provide for private and authentic communication, user authentication and/or user authorization to enable services such as user registration, payment, secure messaging, reporting and account administration by or for the central facility.

For simplicity of discussion and without being limiting, a Public Key Infrastructure example is provided, though other methods using techniques known in the art of secure communication, data security and cryptography are possible. For our example, the central facility includes a PKI Certification Authority (CA) though; the Certification authority component may be external of the central facility. We refer to the component approving the generation of a certification for a router, similarly a user/patient, as a Registration Agent. Upon contractual agreement between the Registration Agent and a medical institution, a PKI Certificate (e.g., X.509) of the institution based on the institution's public key is generated and published using techniques commonly used and understood in the area of Public Key Infrastructure and cryptography. Furthermore, specific aspects of the contractual agreement may be incorporated in the certificate. This may include key aspects of the contract such as effective period, agreed upon privacy control mechanisms, insurance obligations, points of contacts, regions with appropriate licenses, etc., In essence, an institution may securely communicate with the central facility and, moreover, if desired in the system, communicate with others who have been approved. Non-public key and public key without Certification Authority approaches are possible as well.

Not all the information needs to be embedded into a certificate but rather registries such as a database may be used. We will refer to such a database as a Registry. Therefore, either through the Registry or certificates key points of the contract between institutions may be viewed securely.

A bootstrapping process for individuals related to an institution may also be incorporated. Though it is envisioned, but not required, that users associated with an institution do not have separate contracts. It is, however, envisioned that some users are associated with more than one institution. With the PKI example, such a user may have more than one certificate. Certificates for individual users may describe roles of users (e.g., primary physician, Radiologist, System Administrator, Medical Admin, Nurse, etc.), Licenses of the individual (including region), locality, validity period of certificate, Affiliated Institution, relevant contractual provisions, training and education, approved services that using is providing, rights provided by the institution, rights provided by other parties, etc. Many of these may also be incorporated in the institutions certificate.

Though our example is of a certification authority it is possible that a registry institution and individual information are kept external of the PKI as well. It may, for instance, be a local registry held at the central facility or external of the central facility.

In addition to the above information, institution or users may place in a registry (or certificates) additional information to support in routing of documents including trust models (e.g., types of security controls placed at institutions), cost to process data (e.g., cost to process order), region (including country), priority (e.g., medical emergency), quality of server (e.g., from a rating service), time to deliver (e.g., it takes a specific number of hours to process order), favored relationships, etc. Some of the information may be private and only available to the central facility (e.g., favored relationships) which express preferred vendors and some may have limited exposure (e.g., a group a facilities but not all).

When documents (e.g., orders) are routed, the above information may support the routing of the document. It may be used by the sending router to do a direct routing to the recipient, which may bypass the central facility, or may be routed to central facility whereupon the central facility make determination of recipient.

It should be noted that our examples are generally demonstrating the Push model of data transfer wherein data is pushed to the recipient. However, a pull model is also possible. That is, data (e.g., orders) are sent to from sending router to the central facility 18 where they are stored. Recipient routers poll for data which the central facility provides using some determination mechanism, including but not limited to the first requestor as being the only one, the lowest cost requestor, and/ or other form of criteria (e.g., licenses, region processing will be performed in, favored relationships with sending institutions).

Furthermore, patients or owners of patient data may require a means to directly enter data or control who may receive the data. (By owner of patient data we mean someone who has a right to read and transfer a patient's data). Hence, data may be stored at the central facility, central enterprise, or other facility, on a long-term basis. In such a case, the user may request that data be routed to some institution(s) or entities at a time much later than when it was received by the central facility. The routing may be a push (i.e., sent directly to recipient) or pull (e.g., recipient is notified but must extract data). Patient or owner of data may place restrictions on who may receive data or specify criteria on who may receive information.

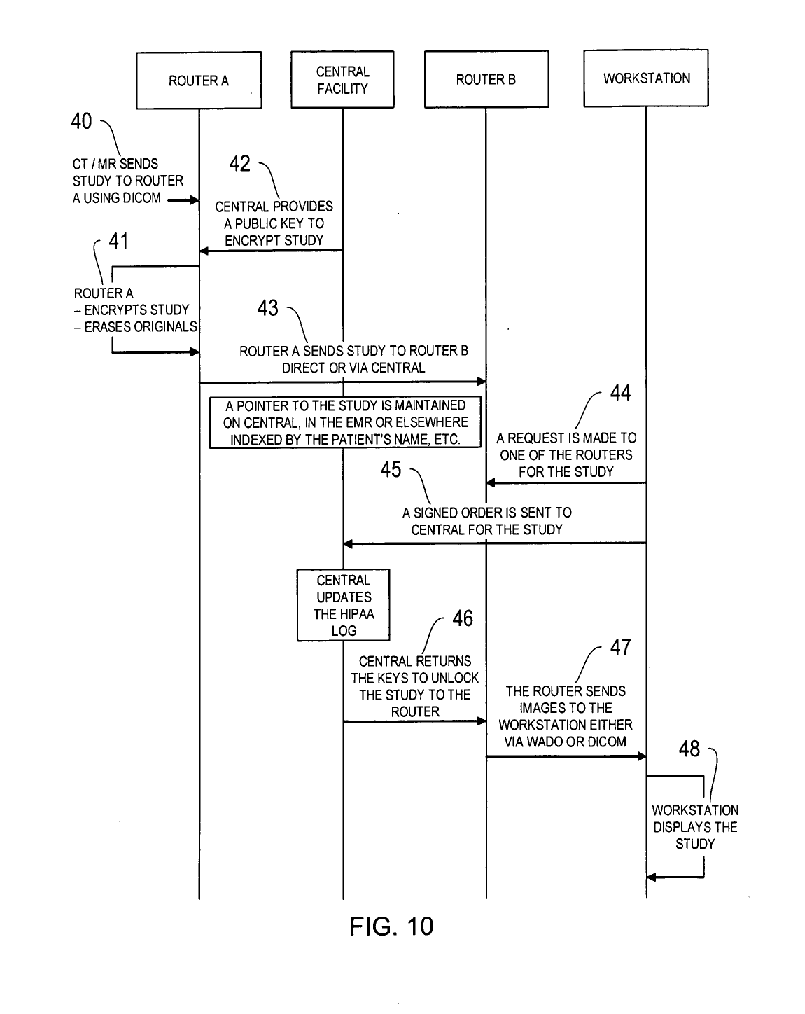

FIG. 10 generally depicts the method of the invention. Router A refers to the part of the system that is behind the firewall in institution A and Router B refers to the part of the system that is behind the firewall in institution B. The workstation can be anywhere in the system. Starting at 40 a CT/MR etc. sends a Study to Router A using DICOM. At 41, Router A encrypts the study with a public key of the central facility 18 provided at 42 by the central facility 18. Router A then sends 43 the study to either the central facility or Router B. At 44 and 45, a request is made to Router B for the study and a signed Order is sent to the central facility for the Study. The central facility 18 at 46 updates the HIPAA log and returns the random keys which are described in the paragraph below to Router B to unlock the study. Router B sends at 47 the study to the workstation via either WADO or DICOM. At 48, the workstation displays the study. Public key encryption is the preferred method, however, other methods known in the art of secure transmission are applicable.

Upon routing either at the router or, preferably at the central facility, rights controls may be wrapped or embedded onto the patient information. That is, Digital Rights management techniques incorporating rights protection of digital content as is known in the art of Computer Security, Data Security and Cryptography may be placed to provide pro-active restriction on who can view the data as well as logging of who has accessed information. Oftentimes digital rights management techniques require a wrapper around the information, which the recipient must “unwrap”. This “unwrapping” process may be done at the recipient router though it leaves the document exposed between the router and final end destination. However, the final point of destination may not be able to handle “wrapped” data and therefore unwrapping at the destination router has many benefits.

Moreover, watermarks which embed information into documents and images may be incorporated. Watermarks provide re-active controls in which each image or document is “serialized” and therefore can be audited. Watermarks are known in the art of Cryptography and Digital Rights Management and have been used to protect music and other media.

The techniques described in this embodiment provide several mechanisms for discretionary access control, which may be used on their own or in combination. Rights management is one technique, encryption and routing of data to only appropriate destination routers, specification of requirements to route to destination address, access rights embedded in patient information internally in the document or externally of the document(s) (e.g., in the order), access controls at the destination router, etc.

As part of the method, the intermediary central facility 18 manages encryption which is done primarily by the routers 10. Referring to FIG. 11, each Series 53 is encrypted with its own random Key. The Key will travel with the Order 50. Each Series 53 has a Hash calculated prior to encryption at the origin that validates its contents. In addition, calculating a second Hash of the encrypted Series 53 enables validation of integrity during intermediate transfers without compromising security because the second Hash can be recalculated at each intermediate point. Calculations of the Hash are facilitated by the use of standard algorithms such as SHA-1. Another approach is to use keyed and un-keyed authentication such as Message Authentication Codes, digital signatures, Message Integrity Checks and other data authentication methods known in the art of cryptography and data security. Here in this embodiment without being limiting, we use un-keyed hashing.

Referring to FIG. 10 and FIG. 11, the order 50 is, preferably, an XML document, which has a closed or encrypted part 52 and an open part 51. The open part 51 lists one Hash for each Series 53 in the Payload. This makes it possible to validate or discard duplicate Series at anytime. The closed or encrypted part 52 lists one key for each series 53. The encrypted part of the order 50 is always encrypted with the Public key of the destination. When the order 50 is traveling from Router A to the central facility 18, the order 50 is encrypted with the central facility 18 public key. Where the order 50 is traveling from the central facility 18 to Router B, the order 50 is encrypted with the public key of Router B. If the order 50 is considered as a supplemental series in the payload, then the original series need not be encrypted with PKI but can use the more efficient symmetric key algorithms. The central facility 18 does not have to re-encrypt the original series. The order, study, or encrypted series, individual or in combination, may also be authenticated using techniques such as digital signatures or message authentication codes which are known in the art of data security and cryptography. Furthermore, Public key (asymmetric) encryption is exemplary and symmetric key encryption may be used throughout. Key management can be performed through various techniques known in the art such as the use of Kerberos. When asymmetric encryption is used, techniques such as enveloping (i.e., public key encrypts a session key and session key is used to encrypt message part) may be used to improve performance.

As part of the method of the invention, the central facility 18 decrypts the order using its Private key. The order is modified to remove fields that Router B should not have or the User should not see. The modified order is re-encrypted with Router B's Public key and sent to Router B. A HIPAA Log entry is made that IDs the User, the original Router A order and the Router B order. Router B receives the modified order and attaches it to the appropriate Series by checking the Hashes in the open part of the order. Router B de-crypts the order using its Private key and can stream the series to the Workstation using WADO or send it on the LAN using DICOM.

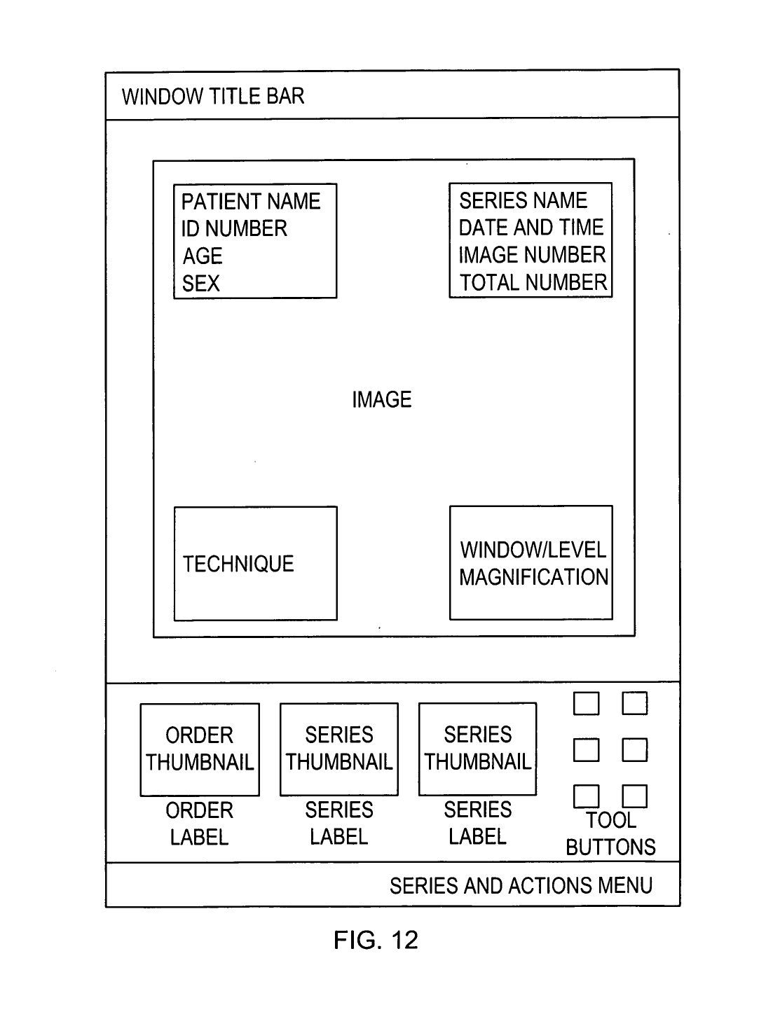

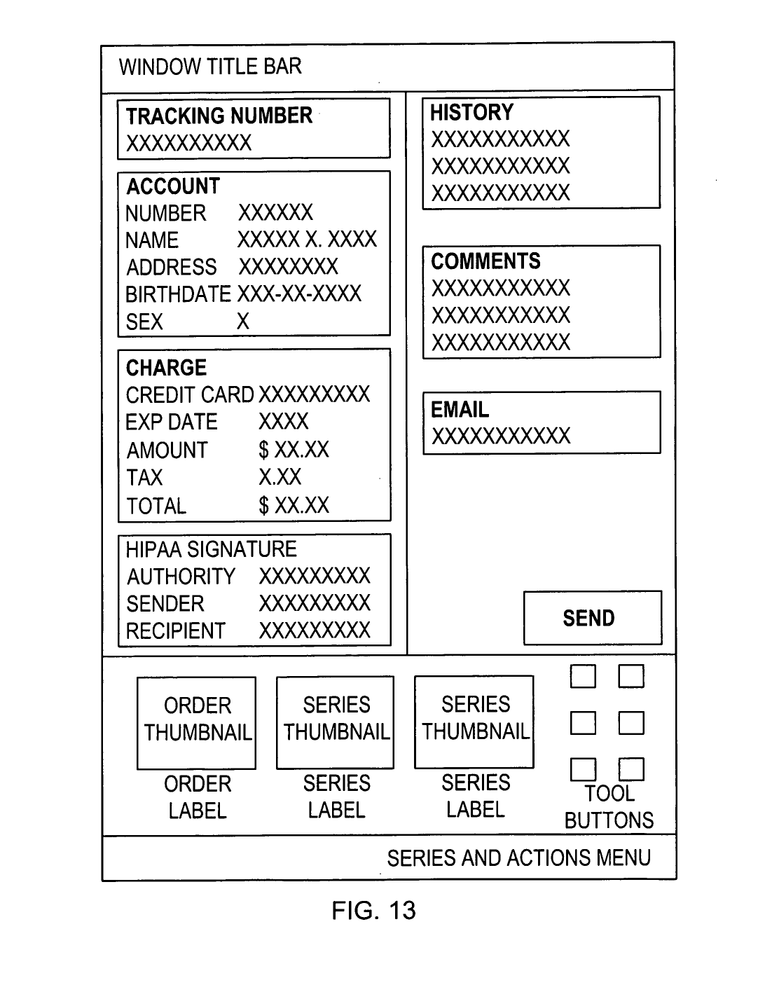

Referring to FIG. 12 and FIG. 13, the study may consist of various DICOM series and the order. A feature of this invention is that the order may be represented utilizing the DICOM standard in the same manner as any image series. For this reason, the order will automatically be displayed by any device or workstation or display that displays DICOM in the same manner that an image series is displayed. In FIG. 12 and FIG. 13, this is seen as a selectable thumbnail at the bottom of the display. In FIG. 12, an image series is selected and the image and image data is displayed in the display area. In FIG. 13, an order is selected and the order and order data are displayed in the display area. The data fields of the order, shown in FIG. 13, can be modified or managed directly on screen using the routine text annotation tools normally available with many DICOM viewers. This allows order management to be preformed within the DICOM viewing environment and therefore the user does not have to resort to the invocation of other information management systems to utilize the present invention outside of routine DICOM image viewing systems.

The order form is depicted as an additional series in a typical medical records viewer. Depending on how the viewer is implemented and configured, this added series might be treated as a component of the diagnostic test rather than as a separate information management system. This approach can selectively bypass and replace institutional controls such as:
1. HIPAA Log—now maintained centrally based on HIPAA Signatures block
2. Patient Medical Record Archive—now collected by Account
3. Technical Support—now accessed by Tracking Number and calls to central facility
4. Intelligent routing and bidding for work based on fields such as History that do not disclose Protected Health Information (PHI).
5. Automatic Routing to destinations outside the institution as shown by the Copy To field.
6. Charge capture independent of the institution including the use of credit cards

Viewers designed or modified according to the present invention can add and present an order to a typical diagnostic study and can manipulate that order to control the parts of the study that contain PHI. In some embodiments, the order may be routed and communicated along with the study using standard protocols such as DICOM. In some embodiments, the destination of a study transfer may be forced to send the order series (alone or with the image series) to a central facility 18 for processing before it can access PHI. This enables routing of the study through insecure intermediate caches while ensuring the accuracy of the centrally maintained HIPAA Log.

The linkage of the order to a study as preserved in the central facility's HIPAA Log is a new enabler for physicians and patients to interact as individuals across institutional boundaries. Examples of typical processing actions that are the point of this interaction are a radiologist's dictated interpretation and a laboratory's computer assisted diagnostic (CAD) measurement of a vascular implant's position. The (CAD) processing protocol and system is typically installed on a workstation or a server. The combination of processing protocol and system and trained user or administrator form the principals of regulatory control for safety and effectiveness (e.g.: FDA 510[k]).

The present invention can be readily used to promote the safety and effectiveness of medical image processing by linking information about the processing actions into the Order and the HIPAA Log along with the privacy-related information.

Examples of the registration of processing actions include preserving (as part of or linked to the HIPAA Log) the model and serial number of a medical device used to process the images in a study. Another example is the actual transport and storage of the information processing system as another series in the Study that is also under the control of the Order and the central facility.

Collections of users and services (e.g.: mutual trust groups, bootstrap trust relationships, trademarked service groups and franchises, database mining of both patient identifiable and anonymous information) can be designed on top of the systems and methods described herein. These groupings, either quasi-static or dynamically determined at the time of use, should not be regarded as a compromise of the potential for voluntary participation and control by individual patients and physicians through the systems and methods described above.

In summary, certain embodiments of the invention address the problem an individual faces when trying to communicate private medical information or healthcare information to virtual strangers. In one embodiment, a healthcare system provides a secure and efficient mechanism for the exchange of electronic referrals (eReferrals) using a data communications network such as the Internet. One advantage to this approach includes the separation of technology from policy. This separation enables a substantially uniform technology to support a multiplicity of affinity domains, each with possibly different policies. The separation also enables individual patients to make decisions about allowing different affinity domains to access personal medical information depending on trust on a case-by-case and/or day-by-day basis.

In one embodiment, a healthcare information system combines a central enterprise that is relatively policy neutral with technology accessible over the Internet that is accessible to enterprises that can agree to participate in a single affinity domain in advance, as well to individuals (and other enterprises and affinity domains) that wish to interact with the established affinity domain. The healthcare information access mechanism may be a gateway information system that is controlled by a host enterprise or user. Alternatively, the functions of this gateway can be managed by use of a secure Web browser.

In one embodiment, an access gateway includes open source software that may be more easily analyzed, trusted, and integrated into an enterprise's information systems and devices. The central system may manage security, activity logs, and encryption keys to provide a policy-neutral infrastructure for implementation of multiple affinity domains and interaction with individuals. For example, the IHE-XDS, ASTM-CCR and HIPAA standards and/or practices may be adopted as the affinity domain neutral foundation for technical interoperability and legal redress.

In certain embodiments, to protect the user's privacy relative to medical information that has been stored on behalf of an individual user, the central system offers users the option of verifying their own point of presence when the information is requested from a central, policy-neutral repository service. In one embodiment, the healthcare information system requires the use of a debit card, smart card or other difficult-to-copy token, to initiate a medical information transaction disclosure and/or to identify the presence of the individual at the point of use.

Another embodiment includes a method to support trusted use of centrally stored information across multiple affinity domains under patient control. The method provides a mechanism and/or means for a patient to set and communicate a unique PIN number to a medical information recipient in a manner that is complementary to the central system. For example, a telephone call directly between the patient and their intended user can enable the communication of a PIN that allows access to information managed by the central system.

In a further embodiment, the central system allows patients to manage their own identity independent of any particular affinity domain to establish patient control while maintaining a policy neutral infrastructure. The central system ensures uniqueness of identifiers (IDs) but does not restrict the patient's choice of an ID and/or when to use the ID. In one embodiment, the central system provides a patient with technology and forms that allow them to request that a particular ID that they control, which is linked and/or associated with their identity, as known and controlled by one or more affinity domains. This innovation moves the problem of identity management and information aggregation away from an affinity domain and into the control of the patient. This then includes another method that allows the central system to provide a policy-neutral technical infrastructure.

In various aspects, the systems and methods of the invention establish a central facility, which is neither a provider nor a payor, in a role of trusted intermediary under the control of the patient. The physician acts as the agent responsible for the transfer of control from the institution to the central facility. The central facility operates under the privacy and security mandates that govern protected health information while also allowing the patient to decide who will have access to their information. Though a one intent is to be patient centric, the systems and methods of the invention are also beneficial in a non-patient centric model where holders and users (e.g., of patient information) use the central facility without direct patient access.

Radiology information is particularly well suited to the innovation because medical images are very large data sets that cannot be readily transferred between institutions with more traditional patient-controlled electronic systems such as the fax machine or xerographic copier. As digital radiology information management systems (PACS) become more prevalent inside provider institutions, it becomes feasible for individual physicians (and other licensed and/or responsible health care workers) to make secure electronic copies of a patient's medical image data and to transfer control of that information to the patient in a manner equivalent to giving the patient a xerographic copy or a fax. An important benefit of the current invention is the method by which it practically and effectively allows the individual physician to use PACS technology already deployed within an institution to enable them to act as the patient's agent in this transaction. In other words, the physician, given the ability to access a PACS imaging study inside the institution for internal use can now make a copy and transfer control of that medical imaging study to the patient without an upgrade to the PACS of the institution and without requiring the institution to reconfigure their security firewall. By avoiding these complex institutional decisions, the present method also avoids the delays and expenses that have been a significant impediment to providing patients with the kind of information that will tend to reduce unwarranted care.

The invention, in one aspect, is directed to a system and related methods for providing a virtual radiology service. This service potentially can bring substantially any radiological digital image data, including other patient medical-related data, to substantially any hand held, laptop, desktop, work station or other suitable computer at any institution. Though data may be accessible throughout an institution, controls may be placed to limit on a “right to see” via implicit or explicit control mechanisms. The service is “virtual” due because the radiological digital image data accessible on the DICOM LAN and PACS of a first institution is made available to a second institution, without either institution having to open their networks to each other, establish legal or other business relationships and understandings or to become administratively involved with each other. That is, institutions do not require direct security-related trust relationships between institutions and may, if preferred, intermediate the business-related relationships through the central facility.

According to another aspect, the system includes one or more intermediary central facilities that isolate each institution from, preferably all, others and maintain centralized records of, preferably all, data transfers and security to comply with applicable regulatory laws (such as HIPAA). According to another feature, the invention includes a method by which an intermediary central facility manages the encryption of data and the encryption/decryption keys between institutions involved in the transfer of radiological digital image data. Preferably, the method of the invention supports the speculative transmission of radiological digital image data to institutions. Although, the described illustrative embodiments are oftentimes based upon radiological digital image data, this intended to be exemplary in nature and not to be limiting.

In one configuration, a system can “virtually” connect the DICOM LAN and PACS of a first institution to the DICOM LAN and PACS of a second institution. The system may include an intermediary server or intermediary central facility that manages the “virtual” connection.

In one feature, an intermediary central facility or enterprise manages cryptographic keys such as for encryption, decryption and authentication of the health information including radiological digital images and other patient medical-related data that is transferred between institutions. In another feature, the intermediary central facility maintains such centralized records of all transfers of radiological digital image data between all institutions as necessary for regulatory compliance of the institutions involved in the transfers of the radiological digital image and other patient medical-related data. The health information such as, for example, radiological image data may be transferred speculatively between institutions.

In one configuration, the invention ensures that a recipient of health information such as radiological image data and other patient medical-related information is authorized to receive data. In one feature, secure separations/walls are provided between various party's data. In another feature, a central facility determines recipients of health information based on several factors including, without limitation, trust models, cost to process data, region (including country), priority (e.g., medical emergency), quality of server, time to deliver, or favored relationships.

In another configuration, multiple central facilities may be part of the information distribution infrastructure for the purposes of redundancy as a fail over mechanism, reliability to provide sufficient throughput and resource allocation, or regional segregation to satisfy, for instance, regional regulatory issues. The multiple central facilities may be hierarchical in nature including a tree-like structure with a root or graph-like structure without a root. The information may be pulled by one or more recipients with rights to receive including but not limited to the first requestor as being the only one, the lowest cost requester, or other form of criteria.

In a further feature, a router and/or central facility may be configured to wrap or embed rights management, including watermarks and digital rights management, into documents prior to transfer. In another feature, the central facility may store patient data in which the patient or owner of data has the capability to push data to other entities or to provide access rights enabling other parties to obtain data at a central facility or other storage facility.

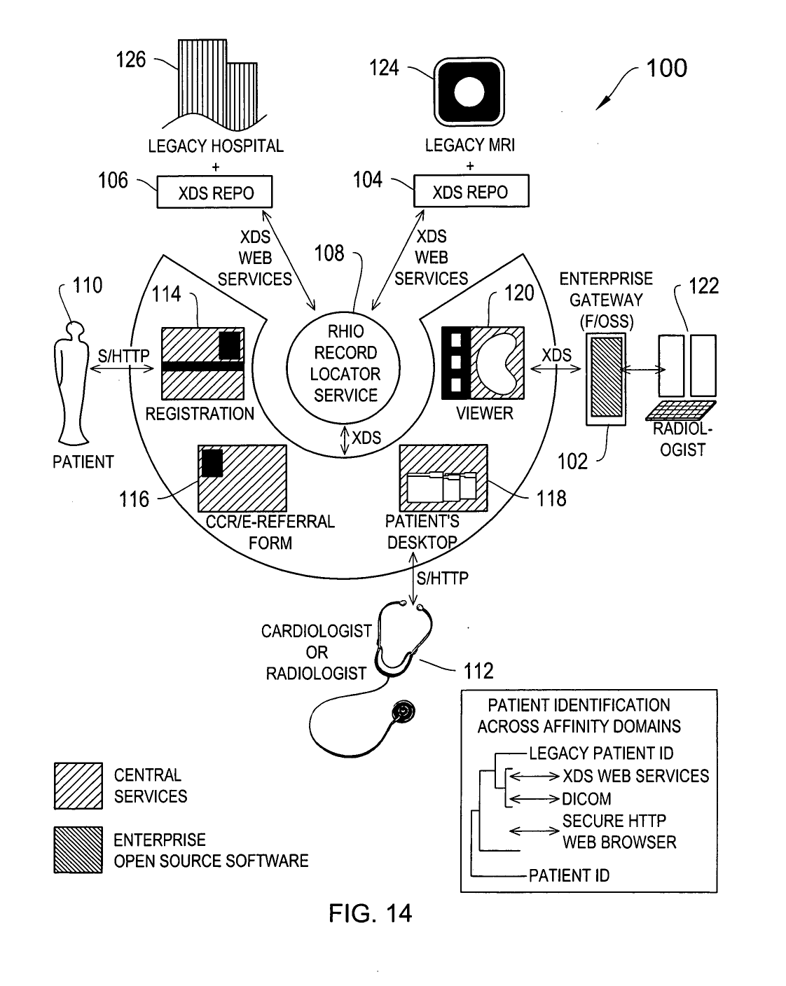

FIG. 14 is a conceptual diagram of a healthcare information system 100 according to an illustrative embodiment of the invention. The information system 100 includes an enterprise gateway 102, legacy data source repository 104, legacy hospital repository 106, an RHIO record locator service 108, a patient 110, and a healthcare professional 112. The enterprise gateway 102 may be part of or include a central facility 18 and allow local access to a healthcare professional 122. The enterprise gateway 102 may include open source software. The legacy data source repository 104 may interface with a legacy data source 124, e.g., an MRI system. The legacy hospital repository 106 may interface with one or more information systems and/or data interfaces of a legacy hospital 126. The system 100 may further include various forms such as, without limitation, a registration form 114, a CCR/eReferral form 116, a patient desktop form 118, a viewer form 120, or other forms. In certain embodiments, the forms are electronic forms such as web pages. Alternatively, other types of graphical or non-graphical electronic forms may be employed. The XDS standard, among other communications standards, may be employed to facilitate the exchange of information such as the various forms 114, 116, 118, and 120 between entities in the system 100. Certain forms such as the registration form 114 and patient desktop form 118 may be updated and/or viewed via a secure communications channel including secure HTTP (S/HTTP). The RHIO record locator service 108 may include a data server capable of interfacing with one or more entities of the system 100 to facilitate the location, delivery, and/or retrieval of healthcare information.

In one embodiment, the viewer form 120 is generated by an XDS document creator that includes a folder viewer. The folder viewer, e.g., WADO viewer, may handle certain documents such as CCR, CDA, PDF, DICOM, and like standard documents and/or forms. In certain embodiments, the enterprise gateway 102 includes a folder viewer capable of creating a CCR form, DICOM information, or other metadata automatically. In another embodiment, the folder viewer is a patient-centric application running on the enterprise gateway 102. In one embodiment, the folder viewer shows healthcare information for no more than one patient at a time. In a further embodiment, the folder viewer shows multiple folders for a patient as a CCR folder stack. Each folder may be arranged and/or cataloged by date. One folder may be shown at a time on top of a stack of folders. A CCR folder stack may be created by an XDS registry query after a patient or healthcare professional logs into the enterprise gateway 102 or central facility 18. An XDS registry may operate independently of the central facility 18.

In certain embodiments, the enterprise gateway 102 or one or more repositories are capable of encrypting and/or decrypting certain healthcare information such as, without limitation, a CCR. The gateway or repositories may include an encryption flag that can be enabled or disabled depending on whether it is desirable to protect certain healthcare information using encryption. Each gateway and/or repository gateway may include a digital certificate, e.g., an SSL certificate, to enable secure and/or private interaction between the repository and another network entity. In certain embodiments, a central facility 18 includes an XDS document creator and/or a CCR folder creator in support of a user such as a patient or healthcare professional.

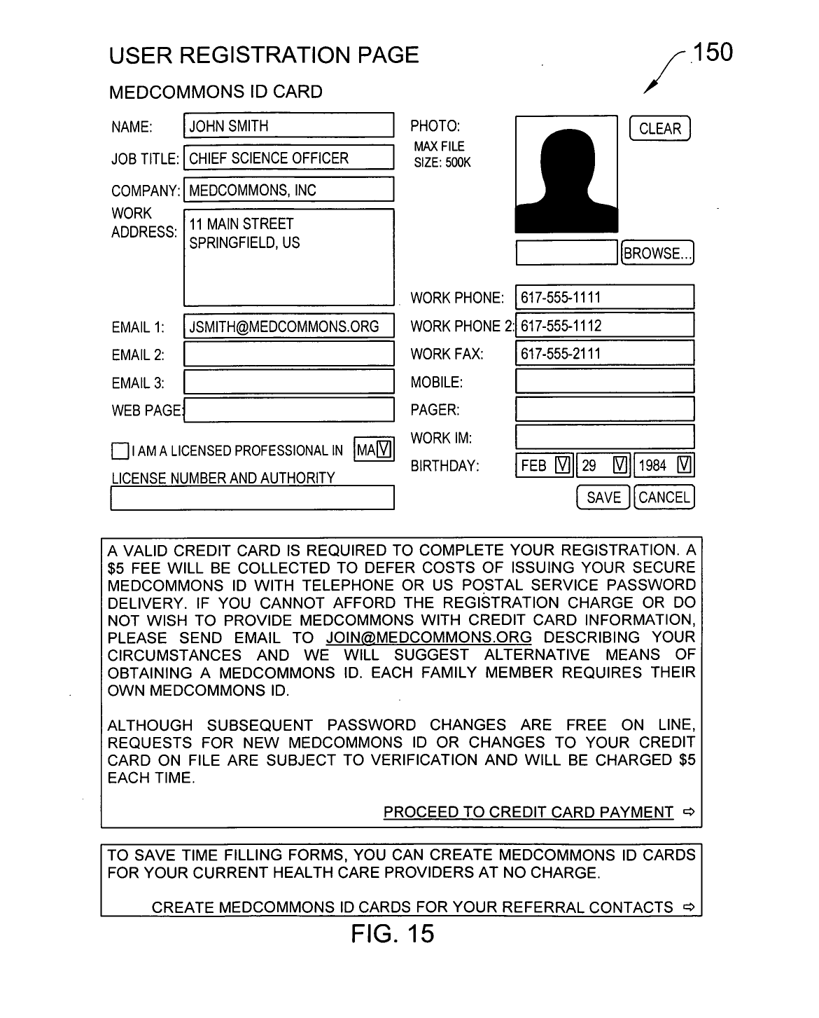

FIG. 15 is an exemplary view of a user registration form 150 according to an illustrative embodiment of the invention. In one embodiment, the enterprise gateway 102 includes a website that requires a user to submit at least one of a credit card, working telephone number, address, email, and like user identifier information as part of a registration and/or information access process. The user registration form 150 may be a web page provided by an enterprise or central facility website that enables a user to submit necessary identifying information during the registration process. The user registration form 150 may include a licensed professional input to enable healthcare professionals to submit license and like qualification information. In one embodiment, the user registration form 150 displays user information in a business card format, allowing the user information to be displayed in other forms or web pages associated with the user. The user registration form 150 may include a photograph input section to enable a user to submit their photograph via, for example, a web camera. The user photograph may subsequently be displayed within user related forms to enable viewers to verify that they are viewing the proper patient records, documents, and/or information. In one embodiment, the initial password and/or PIN assignment is performed via telephone or conventional mail. Subsequent password and/or PIN changes may be performed via access to the enterprise gateway 102. In another embodiment, the registration form 150 enables linkage of user identifier information with a digital certificate issued, for example, by a public CA such as Verisign. The user registration form 150 may enable linkage to other authenticators such as a biometric ID or token. The user registration form 150 may include a link and/or web link that allows a patient to submit insurance, family support, and/or physician information. Alternatively, the family support and/or physician information may be automatically retrieved from another data repository based on the submitted insurance information.

In one embodiment, the user registration form 150 requires a user to submit credit card information which is then authorized before the user is issued a registry ID (or user enterprise ID or patient-controlled account ID). In certain embodiments, the registry ID includes at least one of a user registry ID number, an expiration date, and the user's name. The user's name may be capitalized to reduce a reader's confusion. The expiration date may be, for example, 2 years from the initial registration date.

In one embodiment, the user registry ID is a unique ID, e.g., a 16-digit number. The unique user registry ID may be in the form of a debit or credit card number. A user password may be issued to the user via an in-band or out-of-band channel. For example, an out-of-band channel may include the PSTN, an email, conventional mail, and like communications channels. An in-band communication channel may include a web form or page having and/or displaying the password or PIN. In one embodiment, a patient and/or user can change their password via access to the enterprise gateway 102. A confirmation email may be sent to a user with a valid email address.

In certain embodiments, a user such as a healthcare professional or patient can access healthcare information that resolves to or is associated with a particular patient by entering one or more of a proper tracking number, a user registry ID, an Healthcare Information Management Systems Society (HIMSS) ID, or a password. When a logon (i.e., login) resolves to a particular patient, a CCR folder stack may be displayed by the enterprise gateway 102 via the WADO viewer form 120, e.g., a web page. Alternatively, upon logon by a patient, an account form and/or patient desktop form 118 may be displayed. In one embodiment, the accounts page or form may include a credit card input to enable further verification of certain patient actions. For example, a patient may be required to enter a proper credit and/or debit card number to require healthcare providers to use the patient's registry ID and/or account ID for all subsequent XDS submissions and/or exchanges.

In one embodiment, a legacy patient identifier (ID) is associated with a patient for handling patient healthcare information in legacy repositories 106 and 104. Also, a user registry ID is associated with the same patient for handling patient healthcare information associated with the enterprise gateway 102. Further, the enterprise gateway 102 is capable of binding and/or associating the legacy ID with the user registry ID of a particular patient to enable the distribution and/or sharing a the patient's healthcare information among multiple legacy systems or affinity domains. The user and/or patient registry ID may be used by a patient or other system 100 user to access healthcare information.

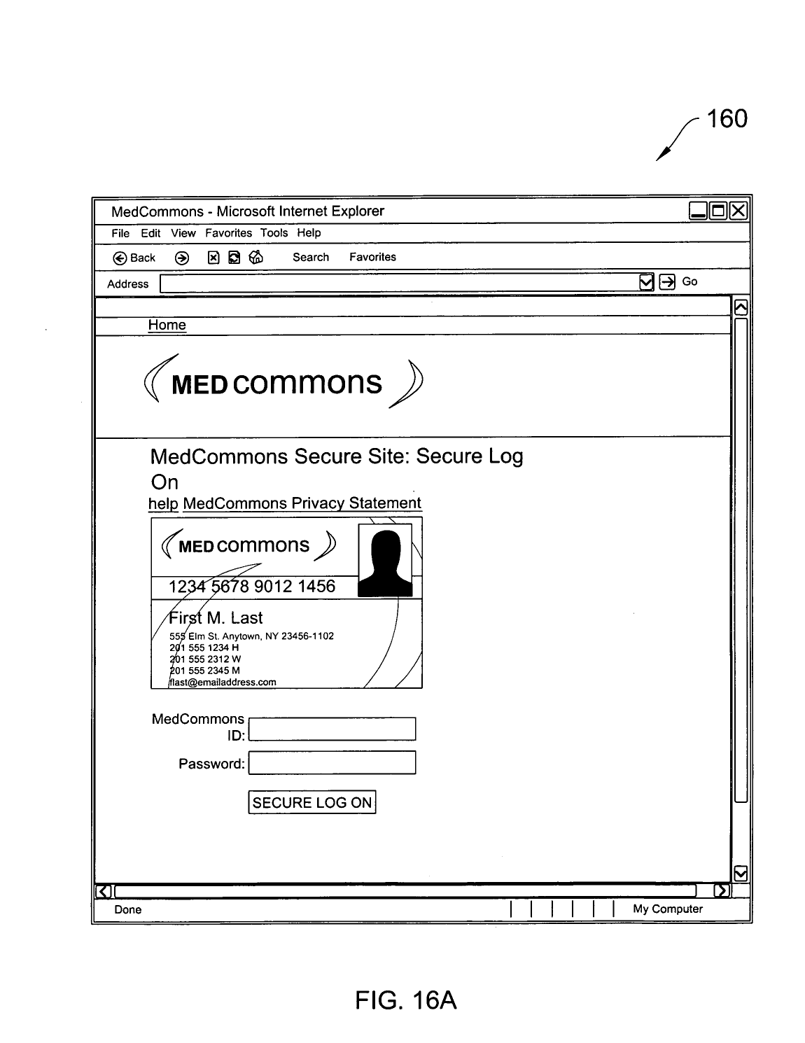

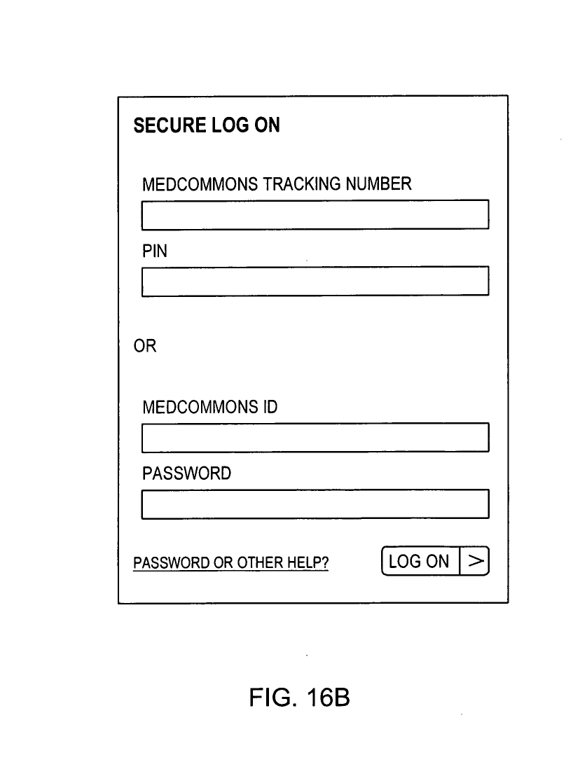

FIG. 16A is an exemplary view of secure site logon form 160 according to an illustrative embodiment of the invention. The exemplary logon form 160 may be a web page as shown in FIG. 16A. In one embodiment, the secure site or web site is included in the enterprise gateway 102, central facility 18, or another intermediate facility or registry. The enterprise gateway 102 may include a web server that provides the secure logon form 160 or any other forms needed to facilitate the exchange of healthcare information. In this instance, the user is required to enter a proper ID and password to enable authenticated (verified) and/or secure access to the enterprise gateway 102.

FIG. 16B is an exemplary view of another secure logon form 162 including a tracking number input according to an illustrative embodiment of the invention. In one embodiment, the tracking number input enables one entity to grant access to select patient healthcare information, e.g., PHI, by providing another party with the tracking number and a PIN associated with a particular document containing the patient healthcare information. For example, a patient may grant access for certain medical information to a physician as part of an electronic referral process by giving the physician a tracking number and PIN to enable the physician to access the patient's healthcare information.

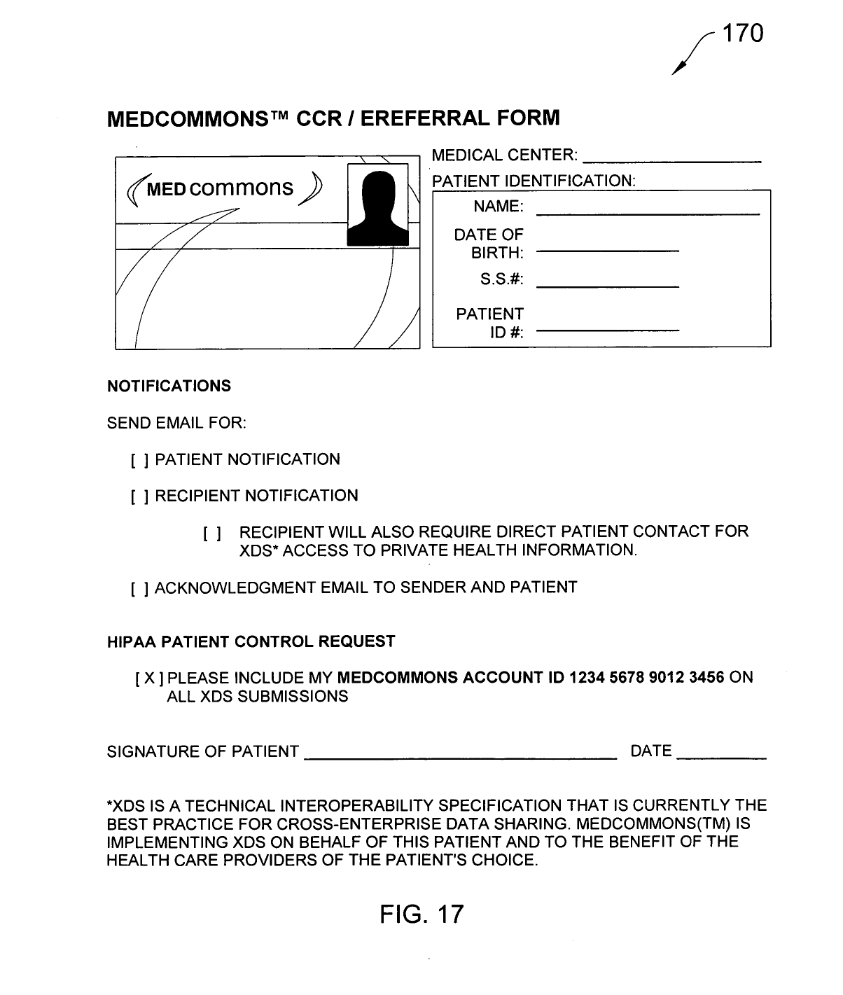

FIG. 17 is an exemplary continuity of care (CCR) and/or electronic referral form 170 according to an illustrative embodiment of the invention. The exemplary form 170 allows a patient to authorize access to certain personal healthcare information contained within, for example, a CCR. The authorization may enable a healthcare professional to access the CCR as part of an eReferral to, for example, enable a specialist to examine the patient's CCR for diagnostic and/or treatment purposes. The exemplary form 170 includes personal information such as a patient's name, date of birth, social security number (SSN), and legacy patient ID number. Also, the exemplary form 170 includes a user registry ID, e.g., MedCommons Account ID 1234 5678 9012 3456, which may be bound and/or associated with the patient legacy ID to facilitate CCR sharing among multiple affinity domains. A notification section enables a patient to specify certain notifications via email including: 1) patient notification when healthcare information is exchanged, 2) recipient notification when healthcare information is exchanged, 3) patient contact upon recipient receipt in which the patient may be required to provide a PIN to the recipient for access, and/or 4) acknowledgement email to a sender and patient. Further details regarding the eReferral process are provided later herein.

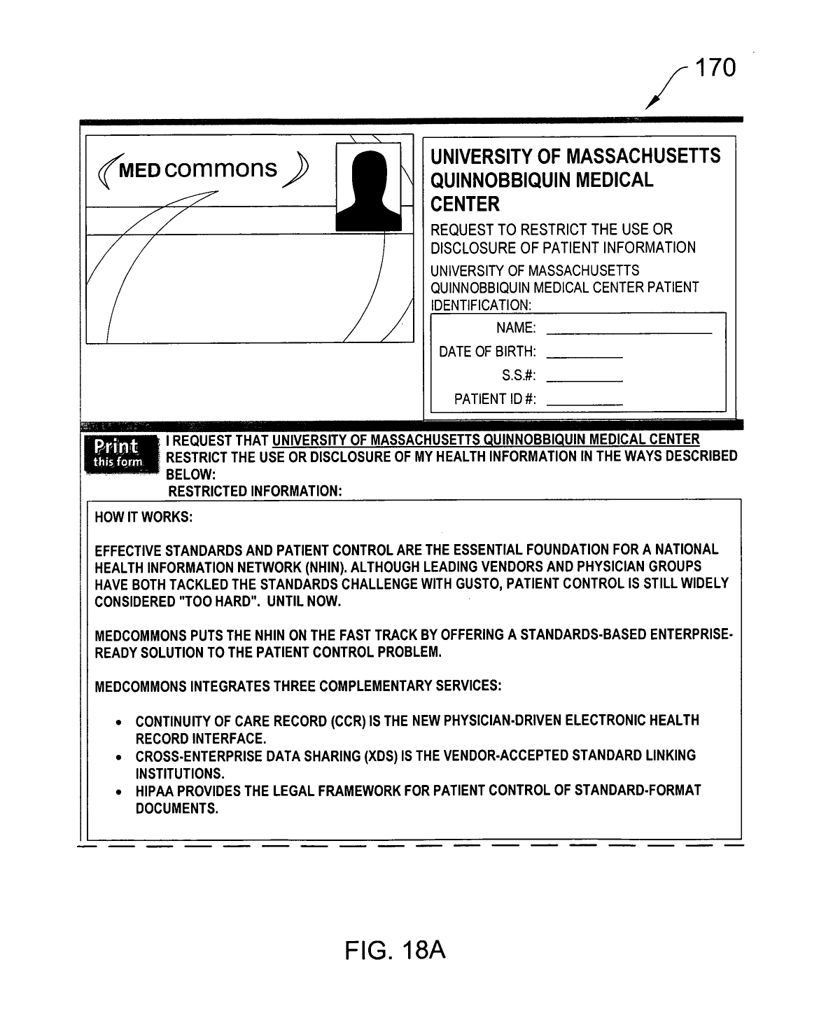

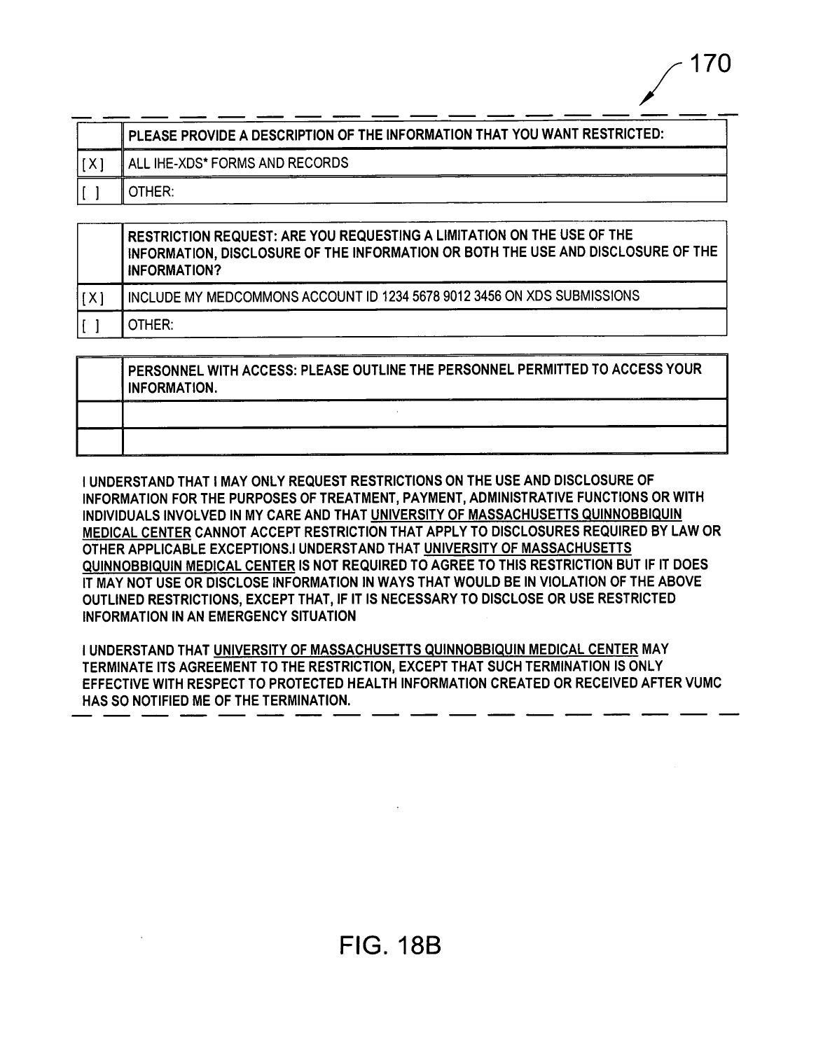

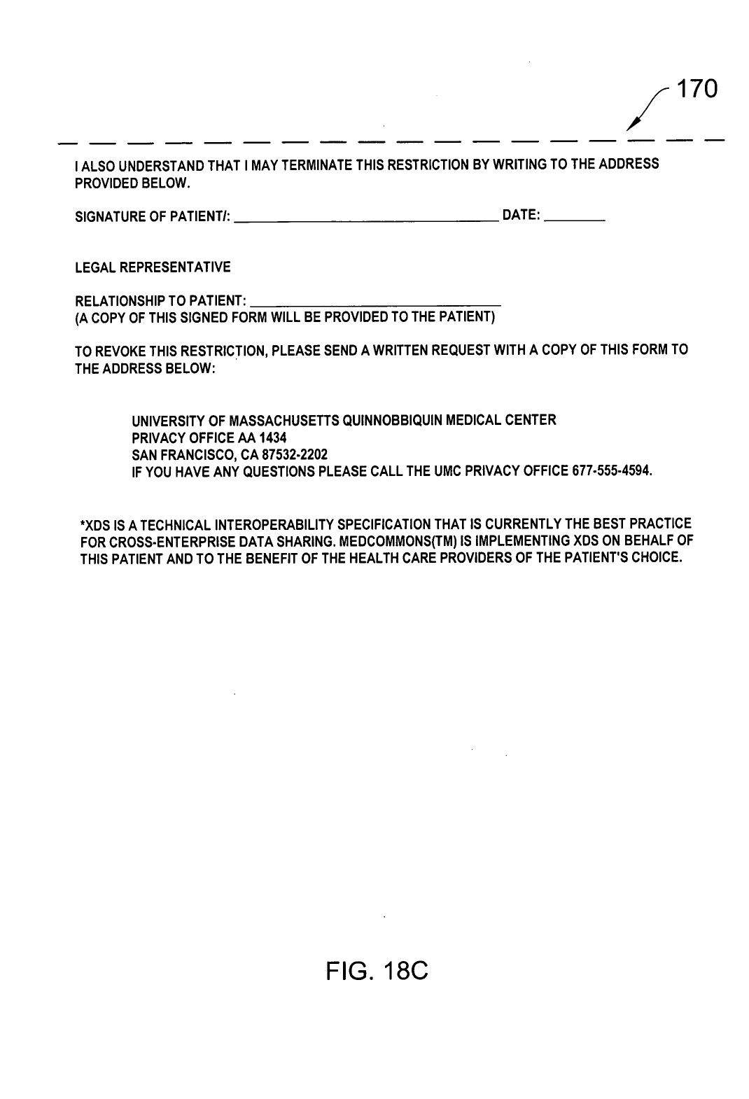

FIGS. 18A-C. include an exemplary request to restrict patient information form 180 according to an illustrative embodiment of the invention. In this instance, the form 180 enables a patient to submit a restriction request to a particular healthcare provider that may include one or more legacy repositories 106. In one embodiment, the request form 180 may facilitate the implementation of principles and/or standards that comply with, for example, the National Health Information Network (NHIN) and/or requirements specified by law such as, without limitation, HIPAA. The exemplary form 180 specifies particular information that is subject to restricted access such as, without limitation, all IHE-XDS forms and records. The exemplary form 180 may require that a patient and/or user registry ID be included on subsequent XDS submissions and/or exchanges. The exemplary form 180 may require a patient or authorized representative signature and acknowledgement of certain legal restrictions and/or requirements. In certain embodiments, the exemplary form 180 is printed and mailed or exchange via facsimile, including electronic scanning, for delivery to a healthcare provider or other healthcare information holder.

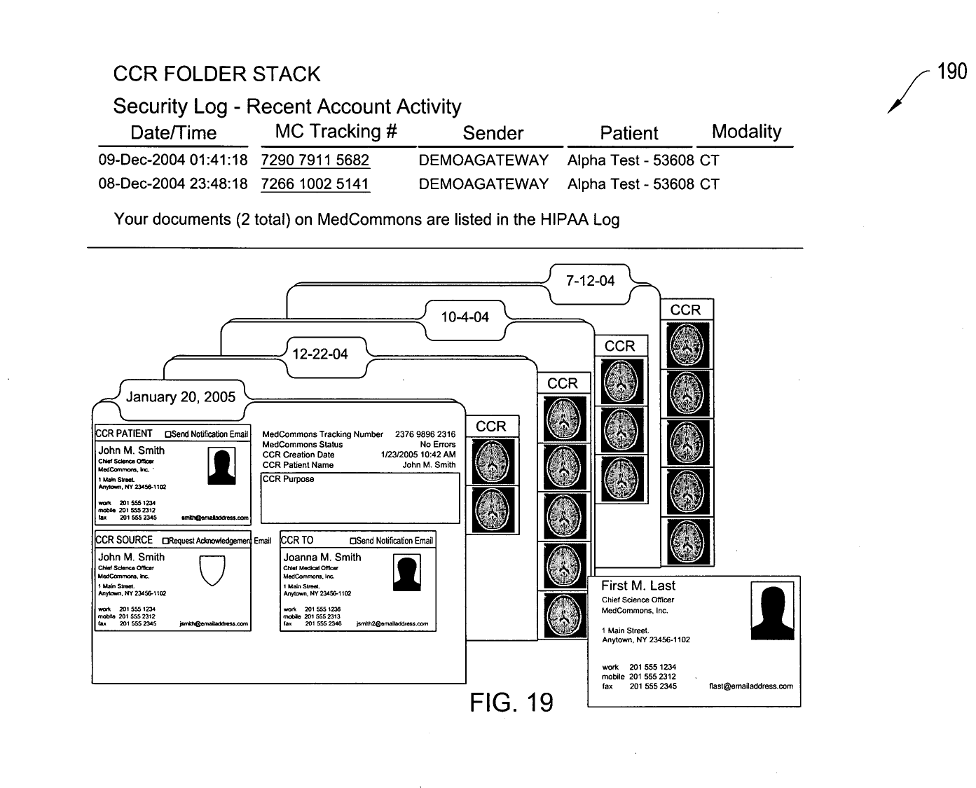

FIG. 19 is an exemplary view of a continuity of care (CCR) electronic folder stack form 190 according to an illustrative embodiment of the invention. The CCR folder stack form 190 includes, for example, multiple CCRs associated with a particular patient. The CCR folder stack form 190 may also include a patient business card, a security log of recent patient account activity, and one or more links to other forms and/or web pages with additional patient information. The CCR folder stack form 190 may allow a user to navigate through multiple CCRs. Each CCR folder may be arranged according to the date of each folder creation. Each CCR folder may be the result of an XDS query. In certain embodiments, the CCR folder stack form 190 is included in or linked to the patient desktop form 118.

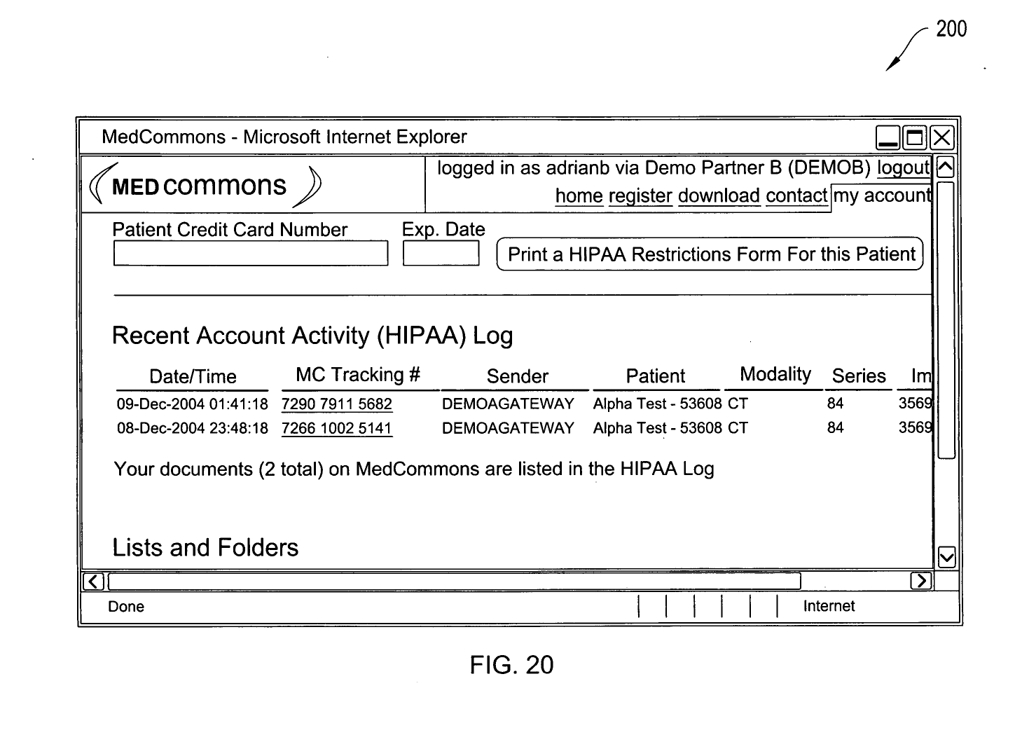

FIG. 20 is an exemplary view of a patient account page form 200 including a HIPAA log link according to an illustrative embodiment of the invention. The form 200 may include a list of recent patient account activity to enable a patient to audit and/or track who may have accessed their healthcare information. The HIPAA form may include a patient's name and user enterprise ID along with a directive request that the user enterprise ID be included in all XDS submissions and/or exchanges. The HIPAA form may be printed to enable the patient to sign and submit the form conventionally. In one embodiment, the HIPAA form may support a digital signature capability to allow a user to digitally sign the form. The HIPAA form may include a “sign and connect” button to enable a patient to sign the form by entering a password or PIN which then enables the form to be delivered to the enterprise gateway 102 as a CCR. A tracking number may also be automatically generated for this transaction. Alternatively, a patient may present a previously generated CCR to a healthcare provider, unless the patient visit to the healthcare provider was preceded by an eReferral invitation which linked to a previously generated CCR.

Registration and verification of patients and other users that access healthcare information using the healthcare information system 100 may be performed as follows. In one embodiment, a user establishes a temporary ID which is, by default, their email address. The user is also assigned a 4-digit temporary password. In one embodiment, the registration process is performed online via access to the enterprise gateway 102. Under certain circumstances, the registration process may be performed by a provider or family member on behalf of a patient. Users may be encouraged to supply a photograph that will appear on their HIPAA restrictions form and/or other patient forms to make it less likely for one person to impersonate another person or for a healthcare professional to access information associated with a wrong patient.

A patient may begin the verification process by acknowledging certain contractual terms of use and agreeing to pay a verification fee. The fee may be charged to the user's credit card account. The credit card check verifies that the user's contact information submitted via a user registration form 150 matches certain credit card information such as, for example, the user's last name and address. Alternatively, a user without a credit card may use a government sponsored verification process, e.g., United States Postal Service (USPS) verification method.

The patient may then submit a preferred method of contact, e.g., by telephone, mail, or email. The user is assigned a unique user registry ID and an associated date. This information allows the user to view and print an enterprise and/or central facility account ID card. Until the user's account information is verified, the user may use either their temporary ID (email) or their user registry ID along with their temporary password to access their account.

When a patient selects the telephone contact method, the patient is contacted by telephone and asked to state their name and input the temporary password via, for example, the telephone keys, e.g., DTMF tones. The credit card authorization may prevent spoofing of the user's identity. Because the temporary password is never, in certain embodiments, sent in the clear or exposed to eavesdropping during the initial registration, the temporary password or PIN enables verification of the user. The user may then be required to change their account password before online access to PHI. If the user PIN entry fails verification, the user may be required to return to the website to trigger another call.

A user who chooses to use conventional mail, e.g., USPS mail, may be sent a new password in the mail. In this instance, a credit card payment may not be required but a verification fee may be paid by check or COD at the Post Office. The user may be required to change their password before they can use the account for online access to PHI. Users who do not link their enterprise account to a credit card may be required to give providers an enterprise tracking number or their user registry ID number. At this point, the user registry ID will be recognized in on-line transactions and will be included on the patient's HIPAA Restrictions Form.

The use of the healthcare information system 100 may include enabling validated patients to access their own healthcare information accounts by entering their user registry ID and their password. A validated patient may submit their legacy healthcare provider and/or affinity domain IDs to one or more XDS registries via the enterprise gateway 102. The XDS registries and/or repositories may determine whether to return information based on the legacy provider IDs, based on their relationship with the enterprise gateway 102, and/or based on other information that the patient chooses to disclose to the enterprise gateway and/or intermediate facility. In certain embodiments, by default, the enterprise gateway 102 make only certain information on the patient's ID card visible to one or more XDS Registries. This amount of disclosure may be explicitly initiated and/or limited by a patient. If the patient is authorized to use their patient and/or user enterprise ID at the XDS Registry, then the enterprise gateway 102 automatically retrieves a copy of the patients healthcare information documents and registers the documents under the patient's user registry ID. The healthcare provider's legacy patient ID may be retained. In certain embodiments, the legacy patient ID is used only for forensic reasons.

Validated patients may provide their user registry IDs to healthcare providers by delivering a HIPAA restrictions form, e.g., form 180, to the healthcare providers. A generic version of this form may automatically be provided by the enterprise gateway 102 provider to each validated user. These forms may be customized and branded by providers when registering with, obtaining an account, associating, or linking the providers network with the enterprise gateway 102. Alternatively, a healthcare provider may implement and/or support its own enterprise gateway 102. The HIPAA restrictions form 180 requires a provider, unless they explicitly decline, to tag all info submitted to any XDS registries with the patient's unique user registry ID. In one embodiment, an email or other notification is sent to the enterprise gateway 102 even if certain patient healthcare information is sent to another XDS Repository.

Healthcare providers that have the patient's user registry ID may not automatically obtain access to a patient's healthcare information and/or data. In many cases, this will not be an issue because the provider will have their own preferred affinity domains and the enterprise gateway 102 may not be a part of that affinity domain. In other cases, the patient may wish to restrict the amount of disclosed information to only, for example, information related to a referral. In this case, there may be no reason to give a provider automatic access to more recent data (e.g., a patient may get three separate second opinions in parallel). In one embodiment, certain patients may choose (or the law may mandate) that healthcare providers, where a life-threatening emergency exists, can “break the glass” and obtain access to certain restricted information without the patient's explicit permission.

The healthcare information system 100 may require the revocation of access to certain healthcare information under certain conditions and at certain times. In one embodiment, users can revoke the submission of information to their healthcare information accounts by changing their user registry ID(s). The enterprise gateway 102 and/or intermediate facility may associate the old and new user healthcare information account IDs, i.e., the old and new user registry IDs. The user registry ID and/or account ID changes may require a notarized affidavit or some other validation process.

Users with compromised or expired credit cards may have to associate another credit card with their user registry ID before they can view newly added information while old information may remain accessible. A healthcare information user and enterprise gateway 102 provider may end the business relationship with each other at any time on short notice. The enterprise gateway 102 provider may send a copy of the user's healthcare information to the user via conventional mail prior to closing the user's account.

The user may define whether the enterprise gateway 102 maintains healthcare information in the clear and mails it to the user in the clear. In certain embodiments, users are capable of protecting documents with a separate password before uploading the documents to the enterprise gateway 102 or another repository. Documents may be returned to the user encrypted, requiring the user to handle the decryption. WinZip, for example, may be used for this purpose without the enterprise gateway 102 involvement or sanction. S/MIME, Pretty-good-privacy (PGP) or like encryption standards and/or mechanisms may be utilized. In certain embodiments, users have the ability to apply a password to a document already in the healthcare information system 100. Users may also have the ability to delete or have the enterprise gateway 102 delete a document. In one embodiment, all links to the document are removed while a log of the deletion is maintained. The GUID, e.g., document ID, of the document may be added to a deletion (revocation) list so that users that have saved the GUID will not be able to access the document directly without risking an alarm or being blocked. In certain circumstances, deletion of a document is not guaranteed because some copies may be off-line or because certain signed legal documents refer to a document and it's destruction may be prohibited by law.

In certain embodiments, the enterprise gateway 102 and/or central facility 18 ensures the privacy of patient healthcare information by performing one or more of the following. The central facility 18 may: use existing privacy laws, e.g., HIPAA, as a factor for patient information controls; create or modify a privacy law restriction form to enable patients to access certain documents from their healthcare providers; enable patients to view, copy, store, add and remove healthcare information documents before sharing them with certain healthcare providers; maintain the integrity of healthcare information documents and limit referral information; limit access to a patient's healthcare information to patients and their authorized healthcare providers; maintain secure logs of all healthcare information account activity; delete documents only with a patient's permission, prevent the distribution and/or diversion of patient healthcare information; allow for additional patient privacy and/or encryption to be applied to select documents and/or healthcare information; enable provider-to-provider communications of patient healthcare information in a controlled manner; enable provider-to-patient and patient-to-provider communication including notification of XDS submissions and/or exchanges; and limit access based on patient authorization and legal. restrictions.

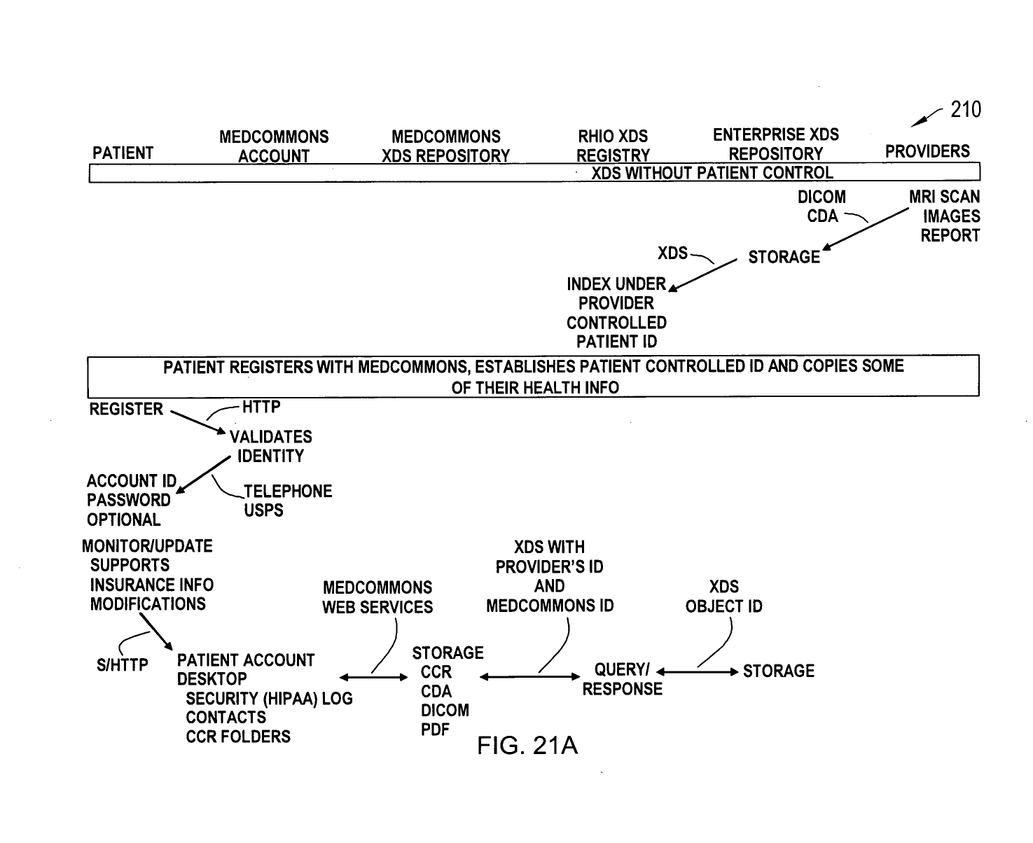

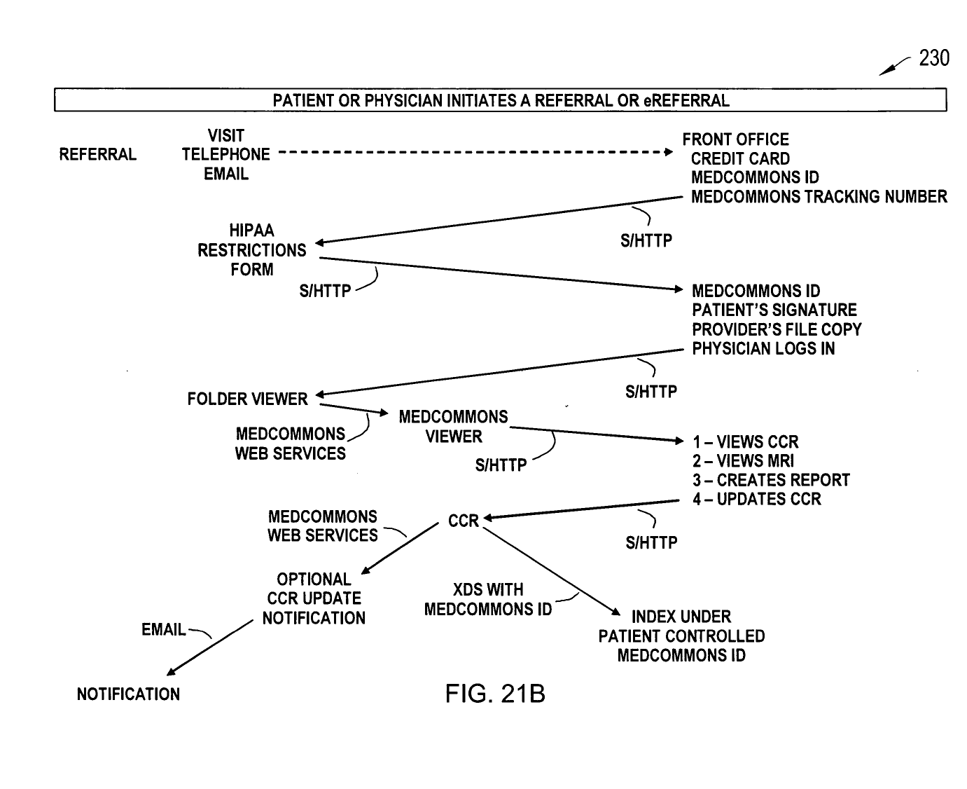

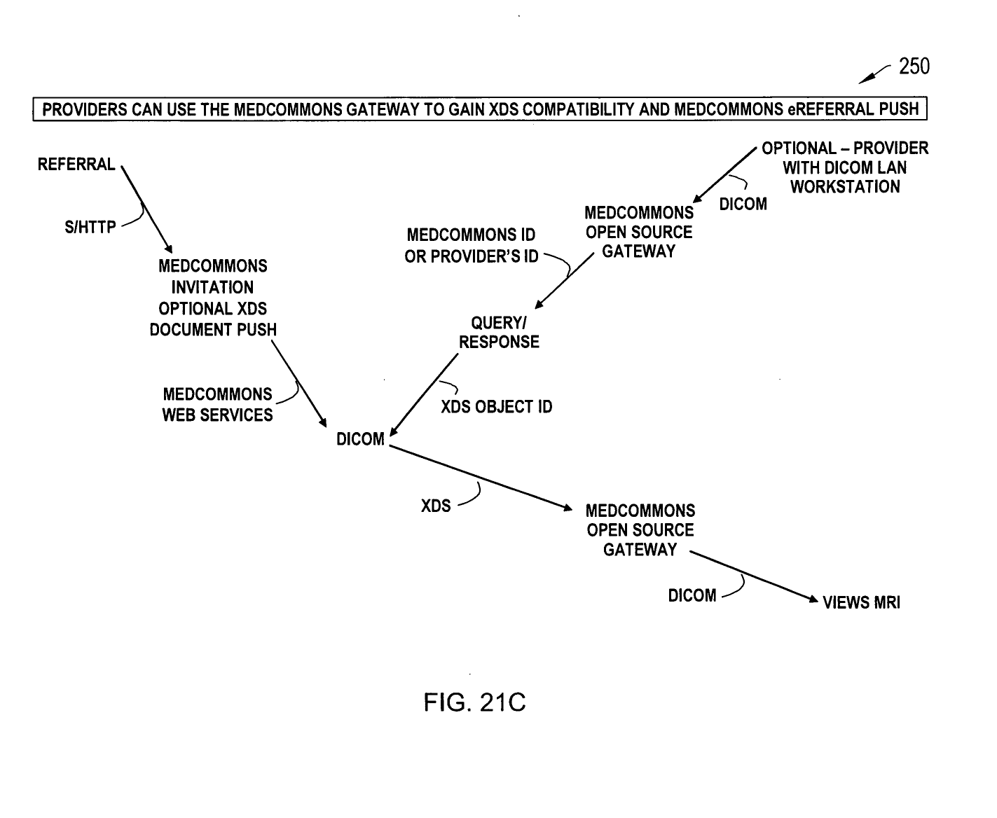

FIG. 21A is a flow diagram 210 of a process for updating patient healthcare information and establishing patient control of access to the information according to an illustrative embodiment of the invention. The flow diagram 210 includes the process of executing an XDS submission and the subsequent process of establishing a patient-controlled ID, e.g., a user registry ID, related to the XDS submission. First, a healthcare provider performs an diagnostic procedures to collect patient information including, for example, an MRI scan. The provider then sends the MRI scan information, images, and/or report using the DICOM clinical data architecture (CDA) to an enterprise XDS repository. The enterprise XDS repository may be the enterprise gateway 102, a central facility 18, or another XDS repository. The XDS repository may then notify a registry, such as an RHIO XDS registry, that the MRI scan information has been stored within its repository. The repository may provide a healthcare provider legacy patient ID to enable the registry to index the information for a particular patient.

The subsequent process of establishing a patient controlled ID, e.g., a user registry ID or account ID, includes having a user register with a enterprise gateway 102 of a central and/or intermediary facility using, for example, a registration form 150. The user registration establishes a user healthcare information account with the central facility 18 based on a validated identity of the user. Once the user identity is validated, the central facility 18 assigns the user an account ID or user registry ID and password to enable user access to healthcare information stored within a healthcare information system 100. Once the user registry ID and password are established, the user may access the central facility 18, registry, and/or enterprise gateway 102, which may include an XDS repository. The user may use a secure communications connection such as S/HTTP to access account information via the central facility 18. The central facility 18 may include an XDS repository that stores healthcare information in the form of a CCR, CDA, DICOM, PDF file, and like standards. The central facility 18 XDS repository may interface with a regional registry, e.g., an RHIO XDS registry, to query for patient healthcare information and obtain a response in documents from a second enterprise XDS repository in a remote location. In one embodiment, the central facility 18 XDS repository includes an enterprise gateway 102. The query to and/or response from the remote XDS repository may include an object ID or legacy patient ID for information associated with a particular patient. The registry and/or one or more repositories may associate a central facility 18 user registry ID with the legacy patient ID during the patient registration process.

FIG. 21B is a flow diagram 230 of a process for providing electronic referrals with patient notification according to an illustrative embodiment of the invention. First, a patient and/or healthcare professional, e.g., a physician, initiates an electronic referral via a visit, telephone conversation, or email. The healthcare provider then sends a consent or HIPAA restrictions form 180 to the patient or requests that the patient submit a standard restrictions form 180 to the healthcare provider. Once the signed restrictions form 180 is received, a healthcare professional of the healthcare provider accesses the patient's healthcare information account via, for example, an S/HTTP connection. In one embodiment, the healthcare professional views a CCR folder stack 190 associated with the patient using a WADO folder viewer. The folder viewer may interface via a web service with a central facility 18 viewer to enable the healthcare professional to view at least one of a CCR or an MRI image, or to create a report and/or CCR. Once the CCR is created, the CCR is delivered to the central facility 18 XDS repository. The central facility 18 XDS repository may then deliver an XDS submission to a regional registry to index an entry regarding the new CCR using, for example, the patient's user enterprise and/or account ID in the registry. Optionally, the central facility 18 XDS repository may send a notification to the patient's account and eventually to the patient 110 via, for example, an email. In one embodiment, the central facility 18 includes a registry. In another embodiment, the registry is remote from the central facility 18. In a further embodiment, multiple registries exist within the healthcare information system 100.

In certain embodiments, an eReferral transaction includes editing a CCR using a folder viewer or EMR client application. The user of a client application may be able to drag and drop a document to create a new folder viewer order. Certain healthcare information documents may be uploaded to an XDS repository and/or enterprise gateway 102 via secure sockets layer (SSL). Certain documents may be encrypted for storage in a repository. Various network elements of the healthcare information system 100 may include cryptographic key exchange mechanisms to support secure document storage and/or exchange. In certain embodiments, an XDS repository automatically registers a document with one or more registries when the document is stored and/or created in the repository.

FIG. 21C is a flow diagram 250 of a process for providing electronic referrals via an information gateway according to an illustrative embodiment of the invention. First, a patient logs in to their healthcare information account using their user registry ID and password. In certain embodiments, the password may include a pass phrase. Once the patient obtains access to their account, the patient initiates a referral invitation. The referral invitation may include and XDS document submission that is delivered to an XDS repository of the central facility 18. The referral invitation may be pushed to one or more repositories to solicit a response from a healthcare professional. The referral invitation may include DICOM information, e.g., an MRI image. Either concurrently or subsequently, a healthcare professional may initiate a query directed to a registry to determine whether a patient has submitted a referral invitation. The registry may be an RHIO registry and/or a registry within a central facility 18. The query may originate from a DICOM LAN workstation as a DICOM transaction to an enterprise gateway 102 which triggers a query to one or more registries. The query may be in the form of a document such as a CCR, PDF, CDA, and like document. In one embodiment, the healthcare professional logs into the enterprise gateway 102 before being authorized to initiate the query. The login process may include providing a temporary/proxy credential and/or pass phrase. The proxy may expire after a select time period, requiring the healthcare professional to re-enter the pass phrase for further access. In certain embodiments, the enterprise gateway 102 attaches a patient public key to the query. The enterprise gateway 102 may automatically accept certain CCR folders across a firewall and decrypt encrypted information as it is received. The user registry ID may be used for maintaining a patient HIPAA log of certain document submissions and/or exchanges. The query may include at least one of a user registry ID and a legacy patient ID. In response to the query, the registry contacts the XDS repository of the central facility 18.

In one embodiment, the central facility 18 tracks XDS repository submissions using patient digital certificates, e.g., X509 certificates. Each patient and/or healthcare professional may have one user registry ID. The user registry ID may be associated with a digital certificate, public key infrastructure (PKI) certificate, and/or public key that is issued by the central facility 18 or a public certificate authority.

Interoperability between the medical documents repositories of unaffiliated enterprises is desirable from the point of view of both the patient and society. Unfortunately, broad sharing of personal information poses the risk of unintended or unlawful disclosure. Until now, registries proposed for broad interoperability and national-scale information access have been uneconomical (relative to their benefit) because of the cost of getting informed consent from the patient/owner of the personal information. Certain embodiments of the invention address the need for a cost-effective means of protecting private information while at the same time avoiding coercive pressure on the patient to grant uninformed or role-based consent.

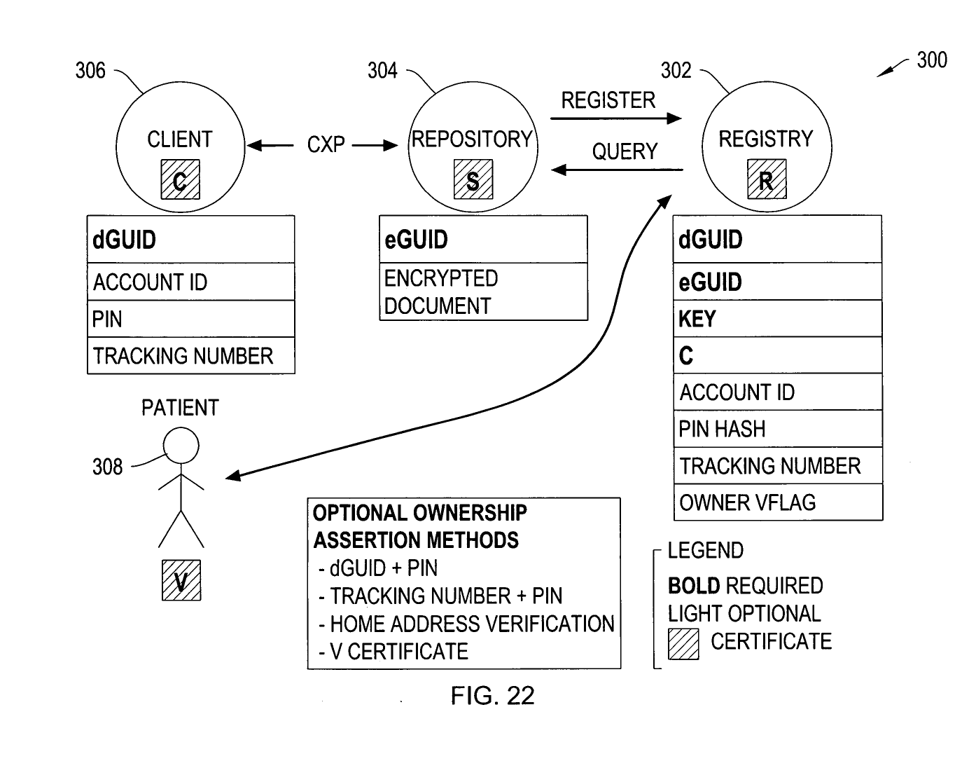

FIG. 22 is a conceptual diagram of a healthcare system 300 including a registry 302 to enable patient control of healthcare information according to an illustrative embodiment of the invention. The healthcare system 300 includes a repository 304 which may be one of a plurality of repositories that interface with the registry 302. The healthcare system 300 also includes at least one client information system 306 that interfaces with at least one repository 304. The healthcare system 300 further includes at least one patient and/or patient interface unit 308 capable of interfacing with at least one of the registry 302, repository 304, and the client information system 306. The patient and/or patient interface unit 308 may include a web browser, telephone, email client, pager, personal digital assistant, and/or a computer with a communications application capable of interfacing the registry 302 or another entity of the healthcare system 300.

The client information system 306 may be capable of storing information associated with one or more patients. For example, the client information system 306 may store one or more healthcare information documents. Each document may be associated with a particular patient. A unique document identifier (dGUID) may be assigned to each document. In one embodiment, the dGUID is a cryptographic hash, MAC, and/or checksum of the document. The dGUID may include a truncated portion of the hash and/or checksum. In another embodiment, the dGUID includes a random number. The client information system may store a healthcare information account ID (e.g., registry ID), legacy account ID, PIN, and/or a tracking number associated with one or more patients and/or system users. The client information system 306 may include a client domain assertion certificate C to enable authentication and encryption related to information exchanges with other entities such as the repository 304. The client information unit 306 may include and/or be referred to as a client interface unit.

The repository 304 may store one or more documents associated with one or more patients. In one embodiment, the repository 304 is capable of encrypting and/or decrypting a document using the encryption/decryption techniques described earlier herein. The repository may also store unique encrypted document identifiers (eGUIDs) with each eGUID being associated with a particular encrypted document. In one embodiment, the eGUID is a cryptographic hash, MAC, and/or checksum associated with of an encrypted document. The repository 304 may include a domain certificate S to enable authentication and encryption related to information exchanges with other entities such as the client system 306 or registry 302. Information may be exchanged between the repository 304 and client information system 306 using a common exchange protocol (CXP) that may represent any standard or proprietary data protocol by which a document source or document consumer can accesses a repository 304.

The registry 302 may store index information related to one or more documents stored within a repository such as repository 304. The registry 302 may include one or more of a dGUID, eGUID, an encryption and/or decryption key associated with an encrypted document, a client system certificate C, an account ID and/or registry ID, a legacy account ID, a PIN hash associated with a particular transaction, tracking number, and ownership assertion flag (VFlag). In one embodiment, the registry 302 includes a PIN associated one or more documents. The PIN associated with the one or more documents may be different than or the same as a PIN associated with a particular registry 302 user account. The registry 302 may further include a certificate to enable authentication and encryption related to information exchanges with other entities such as the repository 304. In one embodiment, the registry 302 is co-located with and/or incorporated into the repository 304. In another embodiment, the registry 302 is remotely located and/or operated from the repository 304. In certain embodiments, the registry 302 does not itself contain private information and can avoid the risk of unintentional disclosure by providing a convenient and cost-effective means of obtaining consent for disclosure from the owner of a registered document (e.g., a patient 308). Thus, a registry 302 can pass control of a document from the document source policy domain (e.g., client information system 306) to an owner-controlled policy domain at a time after the document is registered by the document source (with the registry 302) and before the disclosure of private information beyond the document source policy domain. The registry 302 advantageously enables cost-effective banking of private healthcare information using an independent registry that protects a person's right to privacy while preserving their right to voluntarily associate with the enterprises and secondary registries of their own choosing. A policy domain may include a branded Internet domain name backed by a SSL/TLS certificate that includes the trademark representing the certificate owner's policy. For example, the client information system 306 certificate C may be for the website “records.client.org” and would represent the privacy policies of client information system 306, e.g., Client General Hospital. In certain embodiments, the registry 302 includes the functionality of and operates as a record locator service 108 of FIG. 14.

The patient and/or patient interface unit 308 may posses certain information to control the distribution of their healthcare information from the client information system 306 to one or more repositories such as repository 304. The patient 308 may have a dGUID and associated PIN for a particular healthcare information document or documents. The patient may also have a tracking number and/or PIN associated with a particular healthcare information document. The patient 308 may posses a digital certificate V to enable authentication and encryption related to information exchanges with other entities such as the repository 304 and/or the registry 302.

The healthcare information system 300 advantageously provides, in certain embodiments, the following benefits: no added ownership assertion risk or cost for the client enterprise, the protocol between a document source or consumer and a repository 304 can be open and standards-based including compatibility with cross-enterprise federated or shared repositories and diverse standards-based federated or shared secondary registries, all healthcare information and/or PHI in the repository 304 may be encrypted, no PHI is stored in the primary registry 302, the storage of PHI in any secondary registries (each representing a different privacy risk vs. health benefit tradeoff) can be controlled by explicit owner opt-in if and when the primary registry establishes ownership of the document, the primary registry policy can be independent of any secondary registry policies which makes the participation of the owner (e.g., patient) in one or more secondary registries voluntary and non-coercive.

There are various exemplary processes that may be employed with regard to the distribution, management, and/or control of healthcare information documents.

In one embodiment, a user of a client information system 306 archives a personal document using the following exemplary process. First, the user of the client information system 306 creates a document about the patient 308. The client information system 306 prepares to archive the document to the repository 304 by asserting domain certificate S. The assertion of the domain certificate S may include signing and/or encrypting all or a portion of the document and associated information using, for example, the public key related to the client information system 306. The client information system 306 may also process the document to generate and/or calculate a standard digest (e.g., dGUID) of the document. The digest, hash, or checksum of the document may be calculated using a cryptographic function such as SHA-1, MD5, or any other like function. The client information system 306 may also calculate a PIN Hash which may be derived, at least in part, from a secret transaction PIN and the dGUID. For example, the PIN and dGUID may be used as inputs into a function that generates the PIN Hash. The function F may be a cryptographic function or another algorithm or function. The transaction PIN or PIN Hash may be considered an authenticator that enables a document user to subsequently obtain access to a document by presenting the proper authenticator associated with that particular document.

Once the client information system 306 has processed and prepared a document for distribution, the client information system 306 sends the document, along with various associated information to the repository 304 for storage. The associated information may include, without limitation, the dGUID, the client domain certificate C, a patient account ID (e.g., user registry ID), a registry domain request RD, and the PIN Hash. Upon receipt of the document and associated information, the repository 304 calculates the dGUID using the same function employed by the client information system 302. The repository 304 may compare its calculated dGUID with the dGUID received from the client information system 306 to confirm that the document has not been modified. Alternatively, the dGUID may flow from the repository 304 to the client and the client can calculate the dGUID locally as a check of document integrity. If privacy for the document is desired, the repository 304 generates an encryption key and then encrypts the document prior to storage. In an alternate embodiment, the repository 304 uses an encryption key assigned and strictly controlled by the registry 302 which has the benefit of reducing overall repository storage costs. Once the document is encrypted, the repository 304 processes the encrypted document to calculate and/or generate a digest of the encrypted document (e.g., an eGUID). The digest, hash, and/or checksum may be calculated using the same functions used to generate the dGUID.

The repository 304 then registers the document with the registry 302. The repository 304 may assert a registry domain certificate R on information associated with the document. The assertion of the certificate R may include signing and/or encrypting all or a portion of the information associated with the document that is sent to the registry 302. The information associated with the document may include, without limitation, the dGUID, eGUID, encryption key, the client domain certificate C, an account ID (as received from the client information system 306 or as extracted from the document), and the PIN Hash associated with the document and received from the client information system 306.

The registry 302 then confirms the registration transaction by returning a tracking number to the repository 304 which may serve as a registration confirmation code. Upon receipt of the tracking number, the repository 304 returns the dGUID, the tracking number, and a registry domain RD identifier to the client information system 306. The repository 304 may also delete any temporary transaction parameters and/or information related to the document that is not necessary for subsequent tracking and/or retrieval. In one embodiment, the repository 304 deletes the document, dGUID, encryption key, the client domain certificate C, the user account ID, and the PIN hash while retaining and/or archiving the encrypted document and its associated eGUID.

The client information system 306 then completes the archiving transaction process by verifying that its local dGUID matches the dGUID received from the repository 304. The client information system 306 may save the dGUID as a local document label for subsequent retrieval and/or restoration of the document from the repository 304. The client information system 306 may display and/or print a receipt including the PIN, tracking number, registry domain RD information, and/or other document and/or transaction related information.

In another embodiment, a user of the client information system 306 retrieves a document before an optional ownership verification by the registry 302. Upon a user request, the client information system 306 requests the document from the repository 304 using a CXP transfer of the dGUID for the archived document, the domain certificate C, and the registry domain information. The repository 304 then queries the registry 302 using the parameters dGUID and the domain certificate C. In response to the query, the repository 302 processes and/or evaluates the saved information associated with the dGUID provided in the query. The evaluation may include determining that ownership of the document has not been asserted by the document owner (e.g., a patient). The determination may include verifying that an ownership parameter V has not been asserted by confirming that a VFlag has not been set in the registry 302 associated with the document subject to the query. The ownership assertion may be validated by the registry 302 using a registry 302 validation process. Once the information associated with the document is evaluated, the repository 302 confirms that the domain certificate C in the query matches the domain certificate C stored in the registry 302. Once confirmed, the registry 302 returns the eGUID and associated encryption and/or decryption key associated with the document to the repository 304.

The repository 304 then uses the eGUID to retrieve the encrypted document from its archive. Once the encrypted document is retrieved, the repository 304 decrypts the encrypted document using the encryption/decryption key provided by the registry 302. The repository 304 then returns the decrypted and/or restored document to the client information system 306. Upon receipt, the client information system 306 calculates the dGUID of the received document which is compared with the stored dGUID to confirm that the proper document is received. The client information system 306 may then display the document to a user.

The registry 302 may include a policy that allows a client information system 306 to delete an encrypted document and its associated eGUID as long as the document owner has not asserted ownership of the document and/or the owner assertion has not been verified. The registry 302 may determine the types of log information stored regarding a document transaction including user registrations, document queries, and delete transactions.

In another embodiment, a document owner (e.g., a patient) interfaces with the registry 302 to establish ownership of a particular healthcare information document. In this embodiment, the ownership is verified according to the registry 302 policy. The registry 302 policy may include granting partial or full privileges to a document depending on what information the registry 302 receives as part of an ownership assertion. A partial privilege may include, for example, using the document's tracking number and PIN to read or copy the document, using the document's tracking number and PIN to associate a user account ID to a dGUID that doesn't already have one, and using a tracking number and PIN to request full ownership privileges. Another embodiment may include a method to support trusted use of centrally stored information across multiple affinity domains under patient control by providing a mechanism and/or communications interface for the patient to set and communicate a unique PIN number to the recipient in a manner that is complementary to the central system. For example, a telephone call directly between the patient and their intended user can communicate a PIN that allows access to information managed by the central system, central facility, and/or registry.

The registry 302 may contact the presumed document owner based on information supplied by the repository 304 as part of the registration process and/or based on information linked to the document's dGUID at some subsequent time. The registry 302 validation for full ownership privilege may require a home address verification process. The home verification process may include sending a PIN in the US Mail to the owner. The registry 302 validation process may require that the owner demonstrate control of a supported smart card or security token prior to full access privileges online.

Once ownership is validated, the registry 302 modifies the VFlag to indicated that patient ownership is established for a particular document. The registry may modify the V parameter (e.g., a VFlag) associated with the dGUIDs for multiple documents. Upon full privilege validation, the registry 302 may confirm the account ID associated with a particular dGUID. The registry 302 may modify or completely erase and revoke any privileges associated with parameters such as the domain certificate C, the PIN Hash, and the tracking number for a particular document. The registry 302 may link the dGUID policy to an account ID policy enabling the registry 302 to optionally: log transaction behavior, provide technical support access consent, provide emergency access consent, provide client information system 306 access without explicit owner opt-in consent, provide indexing of private healthcare information associated with or extracted from a document, and enable the transfer of private information associated with or extracted from a document to secondary registries. The registry 302 may also support the deletion of an encrypted document and its associated eGUID from the repository 304 once patient ownership is established.

In a further embodiment, a repository 304 is located on a client's premises. The client information system 306 therefore has physical (and logical) control of documents prior to any ownership assertion. In this instance, the client information system 306 uses CXP to store a document in the repository 304, which may be acting as an enterprise repository. The enterprise repository 304 then contacts registry 302 as previously described. The registry 302, periodically and/or on-demand of the client information system 306, provides to the client information system 306 a copy of the dGUID, eGUID and encryption/decryption key records for documents in the enterprise repository 304 as a means of disaster recovery and client control. Once the ownership assertion proceeds, the registry 302 creates a new copy of the document (with a new eGUID) in another repository under independent control. In certain embodiments, the new eGUID is not copied back to the client information system 306. The dGUID may be the same for the same document in both registries and/or repositories. The deletion of the document in the enterprise repository 304 may require the consent of the client information system 306. Thus, the registry 302 may delete its copy of the original eGUID to make sure no accidental deletion occurs.

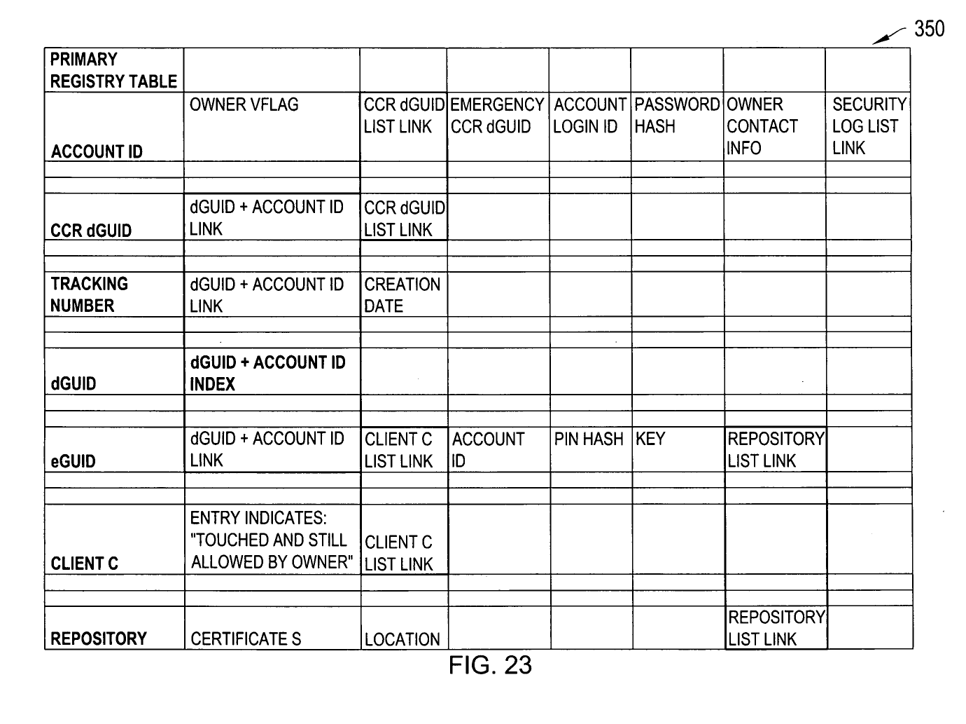

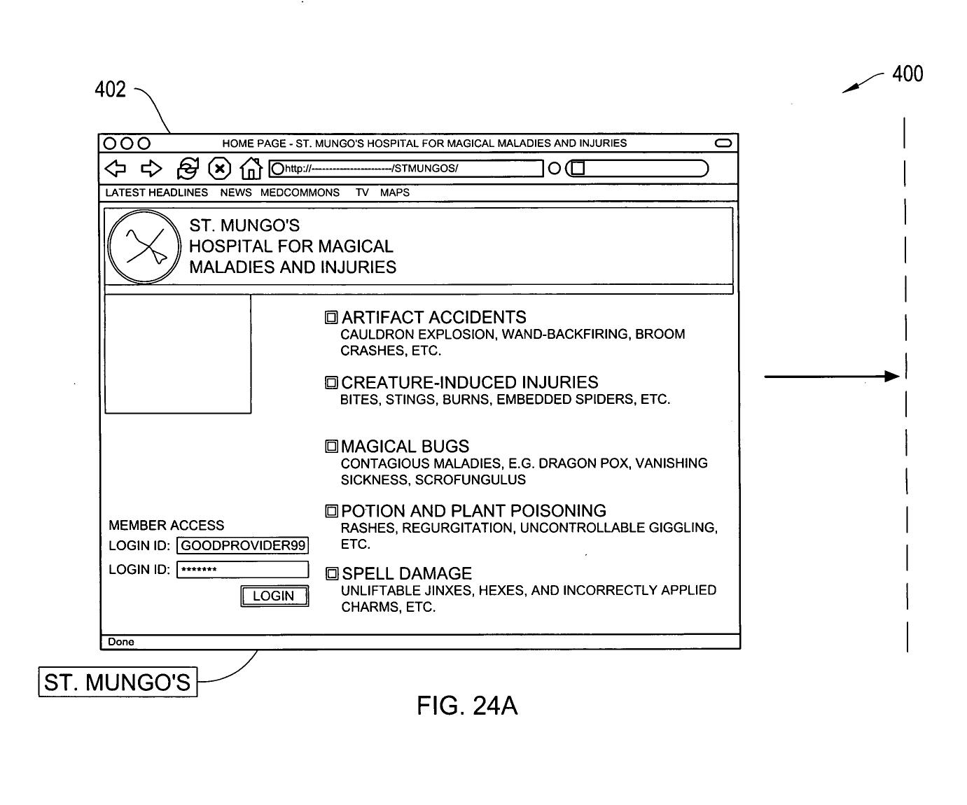

FIG. 23 is an exemplary table 350 of a primary registry 302 according to an illustrative embodiment of the invention. In certain embodiments, the primary registry 302 is defined as a registry having no PHI other than some optional contact information for a presumed owner. The primary registry 302 may include various parameters and/or information associated with one or more documents. The parameters may include, without limitation, a user account ID, a dGUID, a CCR dGUID, an emergency CCR dGUID, a tracking number, a eGUID, a client domain certificate C, a repository domain certificate S, a password hash, an owner VFlag, a PIN, a PIN Hash, encryption/decryption key, security logs, owner contact information. The table 350 may also include repository list links for repositories associated with the primary registry 302. The table 350 enables various parameters to be associated with other parameters, allowing healthcare information documents to be indexed, searched, and/or retrieved based a different parameters.

Under certain conditions, a dGUID may be received at the primary registry 302 where the table 350 already has an entry having the same dGUID value. Effective storage utilization may requires the registry 302 to avoid making a separate copy of the associated eGUID. However, author control prior to owner verification may require each user account to have a separate copy with a separate eGUID in order to avoid a complex “rights management” table in the primary registry 302. One solution to this problem includes requiring unique user accounts. For example, every time a dGUID arrives at the primary registry 302 for a “new” repository storage document, the registry 302 checks if the document has an associated account ID that's already exists in the registry 302 for this dGUID and deletes the duplicate encrypted document file and its associated new eGUID. If the dGUID does not have a matching account ID, the registry 302 may keep the eGUID in a table associated with the new account ID.

If the primary registry 302 is requested to delete a dGUID, several optional actions may be implemented. For example, if CXP has supplied an account ID and the dGUID is referenced more than once in this account, the user may be alerted that the document is still referenced in N other documents. If the user and/or owner insists, a repository may delete the encrypted document and discard the associated eGUID. If CXP has not supplied an account ID but a tracking number is provided and still valid, the registry 302 may use the tracking number to find the account ID of the author or owner and then proceed as described above. In certain embodiments, once a document owner (e.g., a patient) takes control, the author (e.g., client information system 306) can no longer prevent total deletion and may not be notified of the deletion. If only a dGUID is presented and there's only one account ID associated with the dGUID, then the encrypted document and eGUID are deleted as above. If there are multiple accounts associated with the dGUID, then the PIN Hash may be supplied in order to determine which account is being accessed for query and/or delete transactions.

In certain embodiments, the parameters associated with the table 350 are defined as follows.

CCR—CCRs may not have a particular role in the primary table 350. The linkage between a CCR and its attachments may only be carried in the CCR itself. The table 350 may be concerned with documents, which can be CCRs, PDFs, or any other like healthcare information document. An additional table, the CCRLog table may be employed that distinguishes CCRs as special documents which are designated for the top level of an account (e.g., a desktop).

External Document—documents that may be sent to the registry 302 and/or repository 304 via CXP. In one embodiment, external documents are never stored in a repository 304 without first being encrypted. The same document may be sent multiple times and encrypted with different keys.

eGUID—includes an identifier for a one or more encrypted documents in a repository 304 or multiple repositories. In certain embodiments, the eGUID is associated with a set of documents. When each document in the set is identical, each encrypted document includes, for example, the same SHA-1 hash which is being used as the eGUID.

Encrypted document set—set of document store in one or more repositories 304. In one embodiment, several different encrypted documents can be stored, even in the same repository, with different encryption keys.

dGUID—may be an arbitrary string of bits used to identify an external document or any document. A dGUID may be stored with its corresponding eGUID in the registry 302. Also, the table 350 may include multiple tables that are all interlinked by eGUIDs. In certain embodiments, the dGUID includes at least a portion of a cryptographic hash, checksum, and/or digest of a document. In one embodiments, a repository 304 stores documents without encryption under their respective dGUIDs.

Keys—includes a cryptographic encryption and/or decryption key. In one embodiment, the keys are never stored in any repository 304. In another embodiment, the keys exist in only a table with their associated eGUIDs of the encrypted documents.

OwnerVFlag—includes a state variable associated with a user account. In one embodiment, the VFlag and/or ownership indicator is binary to indicate if ownership is asserted or not. In another embodiment, the VFlag and/or ownership indicator may indicate multiple categories of ownership state. For example, the VFlag may indicate “owner unverified”, “owner controlled”, and “in the process of closing due to nonpayment”, among other states. The OwnerVflag may be used to drive the actual behavior of different CXP and website operations such as a delete transaction and/or operation.

POPS Account—a temporary account that terminates after 30 days. In one embodiment, the POPS account is named after the tracking number assigned to the primary (CCR) document inserted into a POPS system. In another embodiment, a POPS account does not have any user identity associated with it, with a registry requiring only a tracking number or document ID and a PIN or PIN Hash to provide access.

Client C—may be a token representing a Client and/or client information system 306. In one embodiment, the token includes an client domain X.509 Certificate. In another embodiment, the client C includes a generated string or a SAML identifier.

Tracking Number—a unique or substantially unique number and/or identifier. In one embodiment, the tracking number includes a portion of an eGUID. In another embodiment, the portion is limited to prevent disclosure of the eGUID to would-be impostors of the document owner. For example, a 160-bit eGUID may be truncated such that the least significant 64 bits are used to derive a tracking number. Tracking numbers may be recycled once the numbers expire. In one embodiment, the tracking numbers are managed by a different service and/or stored in a database other than the registry 302 and/or repository 304. In one embodiment, a POPS transaction sets up a temporary account with a thirty day lifetime where the ID on the account is directly related and/or derived from a tracking number.

Expiration Date—may be added to a user account in order to facilitate POPS document expiration.

Unencrypted Documents—In certain embodiments, no unencrypted CCR or attachment type documents are stored in a repository 304. If a client information system 304 delivers an encrypted document via CXP to a repository 304, the document will be doubly encrypted by the repository 304.

In one embodiment, the primary registry 302 table 350 includes and/or interfaces with multiple additional tables including a Tracking table, eGUID table, eGUID location table, Accounts table, and a CCR log/Security log table.

The Tracking Table maps tracking Numbers to eGUIDs. In one embodiment, tracking numbers are similar to confirmation codes with no mechanism for expiring. In another embodiment, each CCR and it's attachments expire if the CCR is associated with an account that is labeled temporary. In this instance, the CCR may be created when implementing POPS. In another embodiment, the tracking numbers that point to a dGUID associated with a document in permanent accounts may also expire. However, a client information system 306 may retain the dGUIDs of CCRs in order to enable archival retrieval.

In certain embodiments, the tracking numbers are mapped optionally to either dGUIDs or eGUIDs. However, under certain conditions, there can be multiple eGUIDs associated with a single dGUID, requiring the tracking number to map to the eGUID to enable tracking of a particular document because one eGUID distinguishes from another eGUID depending on their associated accounts. In another embodiment, the hashed PIN value is associated with the eGUID, and may be required to be produced by a user to gain access to a document by tracking number. Thus, a mapping of a hashed PIN to an eGUID may be implemented. The association of PIN Hash with eGUID may be incidental where the PIN Hash is formed based on the dGUID of the CCR and PIN, and is the same for any documents attached to that CCR. The PIN Hash may be set when a PIN is assigned in a user interface or CXP. If the same document is sent in twice to a repository 304, with the same dGUID from an outside document source, the document may be associated with a different PIN each time. In one embodiment, the PIN may be assigned separately to enable a different PIN to protect each separate attachment that was uploaded as part of a particular batch. Thus, only one PIN is required for the transaction of one attachment requested over CXP.

The tracking number may include the following exemplary format:
TrackingNumber: string (12) index
CreationTime: datetime;
eGUID: bitstring(160) pointer into eGUID Table—to a CCR instance in the particular account.

The eGUID Table (or encrypted documents Table) includes a user account ID, Client C, and Key for every set of encrypted documents. In one embodiment the eGUID table includes and/or archives the eGUID to enable mapping from the tracking number back to an external document ID. In another embodiment, the eGUID Table includes and/or archives the PIN Hash associated with one or more documents. The PIN Hash may enable verification prior to access of a document that has been stored with an associated PIN. In another embodiment, the eGUID table enables the association of multiple eGUIDs derived from a single dGUID. In certain embodiments, PINs are associated with documents whether the documents are in POPS or not.

The eGUID table may include the following exemplary format:
eGUID: bitstring(160) index pointer to encrypted document
dGUID: bitstring(160) index
AccountID: string (12) of owner of this document
Client C: bitstring(1000)—records client ID when the document is PUT up by the Client using CXP. The Account owner, once verified to the registry's 302 and/or repository's 304 satisfaction can trump this author identifier and delete it or add another identifier to allow PIN-free CXP GET, or on-line access by a different client information system 306 such as to their personal health record (PHR).
PinHash: bitstring(80)—optional—may be truncated SHA-1 hash
Key: bitstring(160)—encryption key—may include 128 bit AES.

The eGUID Locations Table may include an auxiliary table that points to each individual separate member of an encrypted document set scattered across different repositories 304. The form of pointer may include a repository 304 identifier that can be translated into a URL for direct document access from a repository 304 gateway.

The eGUID Locations table may include the following exemplary format:
eGUID: bitstring(160) index
NodeID: string(12) Repository Identifier
UID: Unique identifier of a document.

The Accounts Table may include a user account and/or registry ID for every account assigned by an account service at the time of account creation. In one embodiment, there is no cross reference from external IDs (e.g., legacy IDs) with account IDs maintained by a central facility 18 and/or service provider. In one embodiment, each non-POPS account has a username and password associated with it, but only a hashed version of the password is stored. The username may be the user's email address. Contact information for the owner of an account may be stored in a remote location and/or repository. A URI to the username may be posted at the remote location for interacting with external Master Patient Index (MPI) systems. Entries into the Accounts Table may be written by both enterprise gateways, repository gateways, central facilities, and/or central services using one or more web service interfaces.

In one embodiment, each user account has one or more special documents associated with the owner. For example, an emergency CCR, located at the Home Page of the enterprise provider (bypassing the Tracking Number) may provide instant access to a patient-selected subset and/or subsets of their healthcare records and/or documents with or without a PIN, depending on the account owners preference. Each account may have certain special logs associated with it that may be implemented as separate tables or as a single table with some form of type discriminator. For example, the special logs may include a CCR log that records each CCR owned by a particular account. The special logs may also include a Security log that records each interaction with any document by a particular account.

The Accounts Table may include the following exemplary format:
AccountID : string(12) index
UserName: string(255)
PasswordHash: bitstring(160)
ExpirationDate: datetime
OwnerVflag: enumeration (, e.g., “CLOSED”,“OWESMONEY”, and so on)
ContactInfo: URI
Emergency CCR: eGUID

The CCRLog/SecurityLog may include the eGUID of each CCR owned by a particular user account and the time it entered the CCRLog as follows:
AccountID: string(12) index
CCR: eGuid
DateTime: timestamp

In one embodiment, the central facility 18, enterprise gateway, repository gateway, and/or the registry 302 may provide certain information to a user to enable disaster recovery of encrypted documents. For example, the user may receive an XML file that contains the encryption/decryption keys for each document that the user has stored in one or more repositories 304. The following exemplary file structure illustrates the information provided to a user in a disaster recovery file:

<keyfile>
<accountid>
2938392938392983
</accountid>
<document>
<dguid>aflkjsjf</dguid>
<eguid>aslfkdjalsf</eguid>
<encryptionkey>slfdjsfkjdlksdf</encryptionkey>
<repository>gateway001.serviceprovider.net:9080/router/</repository>
</document>
.....
</keyfile>

In one embodiment, the dGUID for a healthcare information document is created in the repository 304 via a web interface which may not be known to the client information system 306 (e.g., the author or owner). However, the dGULID may be obtained and/or viewed indirectly by the document's tracking number and a hyperlink under the tracking number when a user and/or patient 308 views their CCRLog as displayed on their account page and/or web form. Access to the CCRLog may be password protected.

In another embodiment, eGUIDs are never used for this purpose because the integrity of the entire system depends on eGUIDs not being visible to anyone other than the “verified” account owner, e.g., a patient. In a further embodiment, no interfaces are provided that allow an eGUID to be entered, except in the case where the account owner is verified. An account owners may be a patient but can also be a healthcare provider or user of a healthcare provider where the provider wants to operate an enterprise gateway within their information domain. In certain embodiments when an enterprise gateway is utilized, a document dGUID has two owners with two separate accounts: 1) one owner is the patient and their eGUIDs are stored in domain repositories, and 2) the other owner is a provider enterprise (e.g., healthcare information system 306) and their eGUIDs are stored in an intermediate (remote) repository or in their enterprise domain repositories. The eGUID copies are separate and completely unrelated in terms of subsequent security log entries or other administrative auditing.

If a patient as a document owner and/or the enterprise as a document owner want to have the actual eGUID sent to their “home” address so that they can bypass the primary registry in case of a disaster, then the registry 302 and/or repository 304 may include the capability to send the eGUID and any other healthcare information to the patient and/or enterprise. In another embodiment, the eGUID functions only as a difficult-to-guess identifier that is sent from the outside via CXP. Entries may be made in the eGUIDs documents table, the logs part of the accounts table, and/or the tracking number table. The eGUIDs Locations Table may be filled based on where a particular document has been physically placed and/or stored.

In certain embodiments, the registry 302 allows a patient to assert control over their documents to deny access to anyone including the author or even to delete the document entirely. The registry 302 may subsidize temporary accounts while it tries to sell each patient on a permanent account upgrade. This can potentially reduce or eliminate the storage and security costs of the document author (e.g., client information system 306) by transferring the documents to the patient or their sponsor. In one embodiment, a primary and/or intermediate registry 302 is policy neutral and can support a wide variety of secondary registries with different and possibly conflicting policies. Each secondary registry has their own patient accounts that reflect their policies. From the point-of-view of the patient, their primary registry 302 account enables them to exercise informed consent (aka. opt-in) for participation in secondary registries at any time before or after a document is created. This enables secondary registries, such as those that perform data mining for fun and profit, to operate even though they are not covered by relevant business associate laws and/or regulations (e.g., HIPAA).

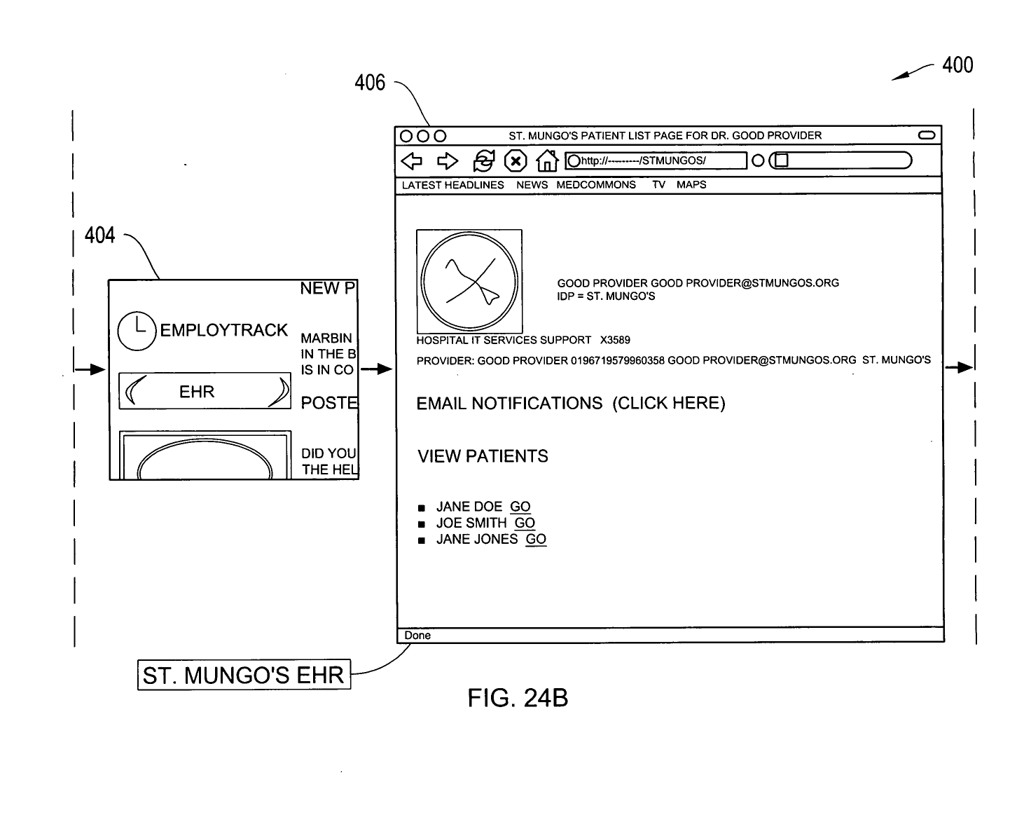

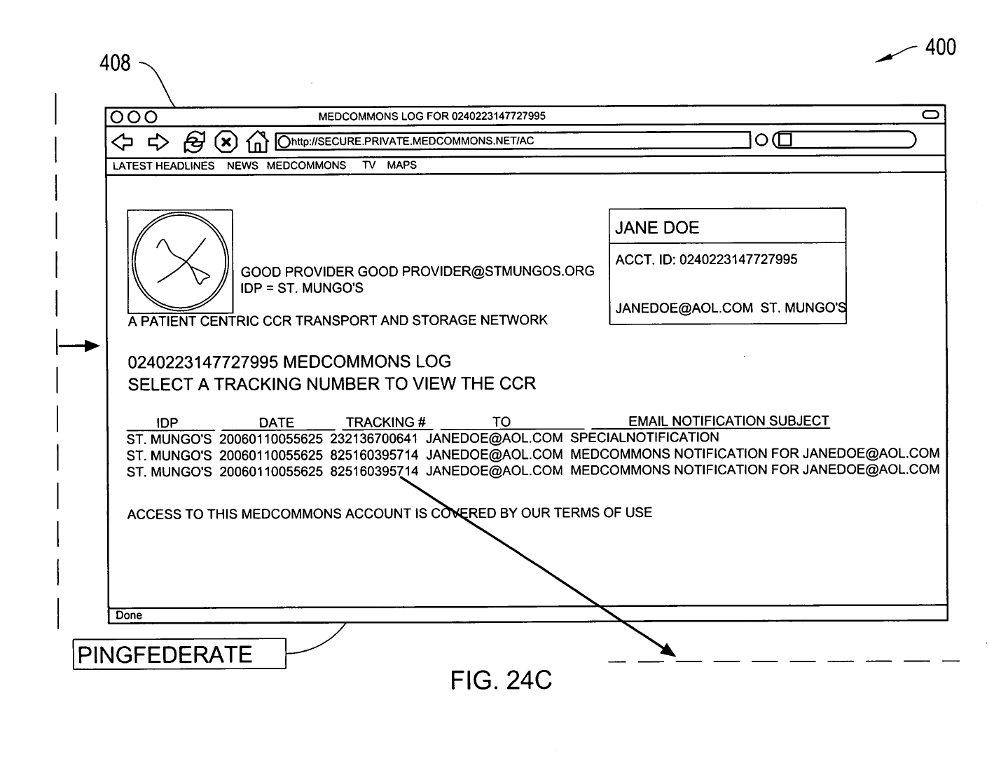

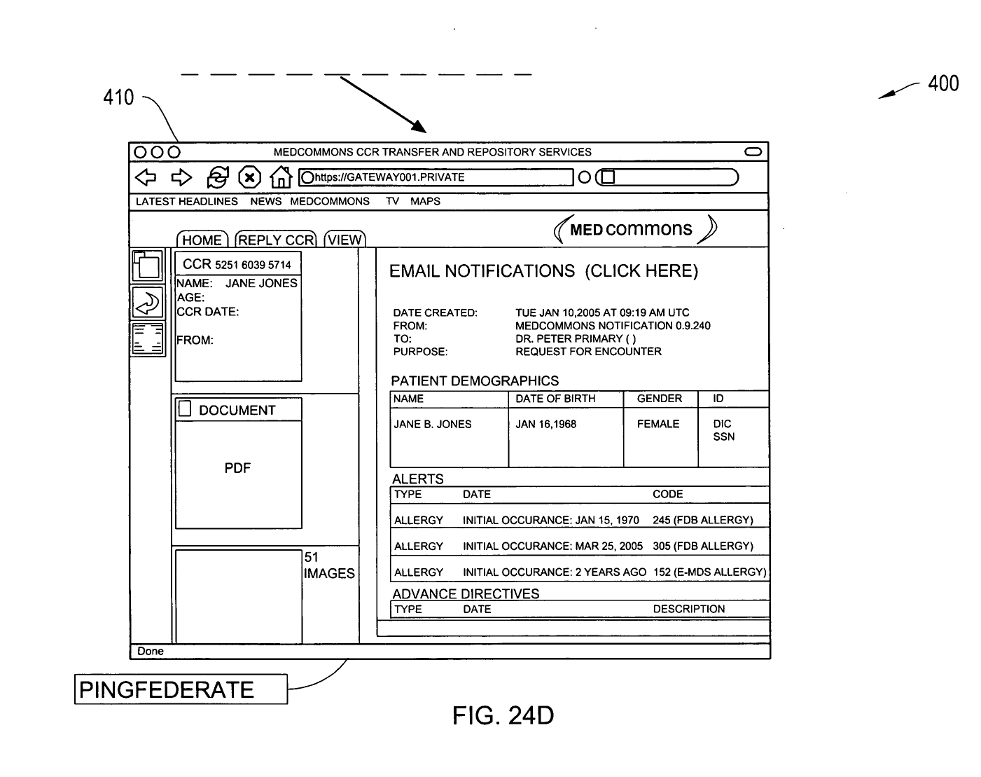

FIGS. 24A-D include exemplary views 400 of a process of a physician sign on to obtain access to a patient CCR indirectly via a client information system according to an illustrative embodiment of the invention. First, the physician or other healthcare professional uses a client software application such as web browser to connect to a client information system 306. In this case, the system 306 includes a web server for a hospital, St. Mungo's. The web form 402 provides an illustrative view of an exemplary log on page for a physician to access the electronic health record (EHR) of their patients. The EHR may contact a regional registry as shown in form 404. During the EHR display process, the hospital EHR system checks the regional registry for a particular patient's CCR by executing a secondary single-sign-on to the registry. The secondary single sign on may include using, for example, well known federation systems such as Liberty Alliance/SAML as illustrated in web form 406. The physician may be prompted to assign and/or view email notifications for the patient and/or other entities as part of the EHR access process as illustrated in web form 406. The liberty alliance federation may include an association between the hospital and a regional registry or other hospitals. The federation process may be based on the federated single sign on process that enables a service provider, e.g., the hospital, to interact with an identity provider (IDP), e.g., a registry, to enable access to a service, e.g., indexing and access to remote healthcare information documents. Alternatively, the hospital may perform the access service and/or authorization of the user while the registry provides access to remote patient CCRs and/or other records by relying on the user (e.g., physician) single sign on to the EHR system. Once logged in to the regional registry, the physician is presented with web form 408 that provides a listing including the CCR associated with a particular patient. The physician clicks on the particular tracking number link associated with the desired CCR to then view the CCR as illustrated in web form 410. The physician may then import the CCR and/or send the CCR to another repository.

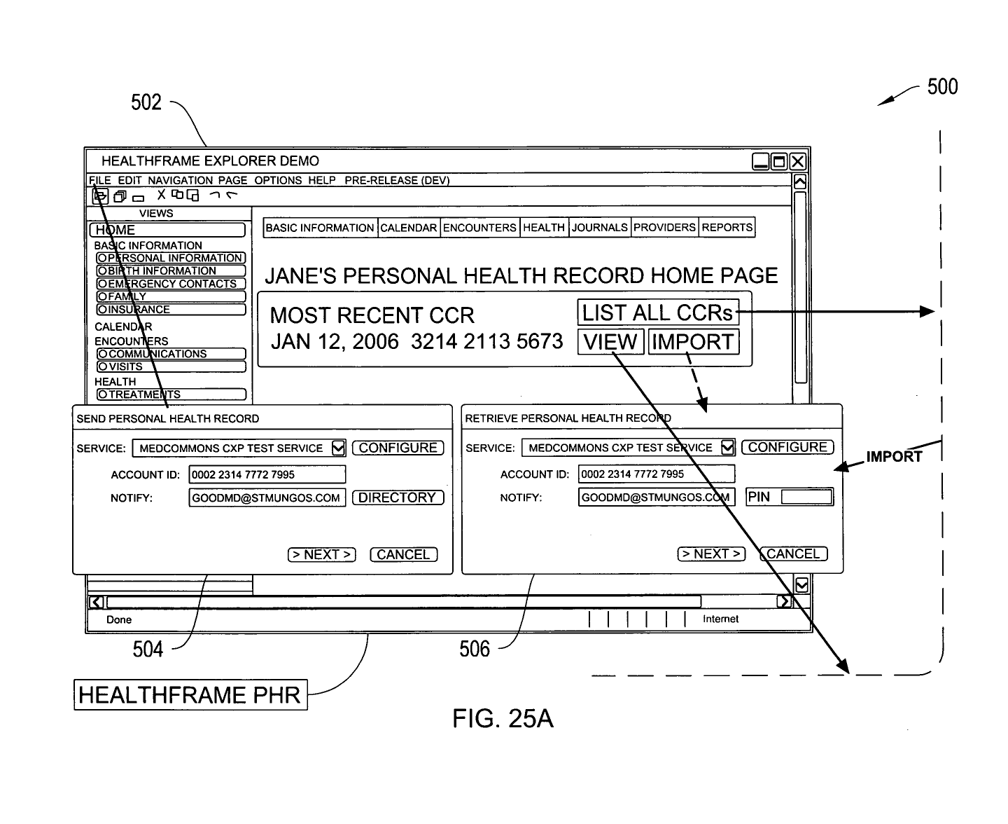

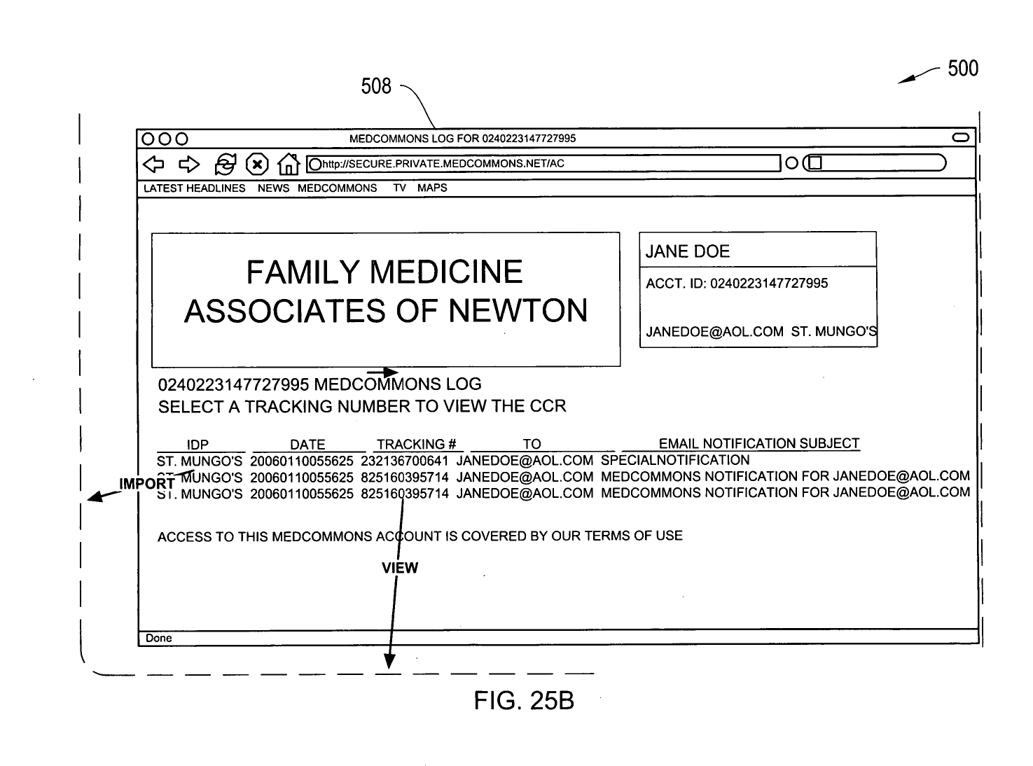

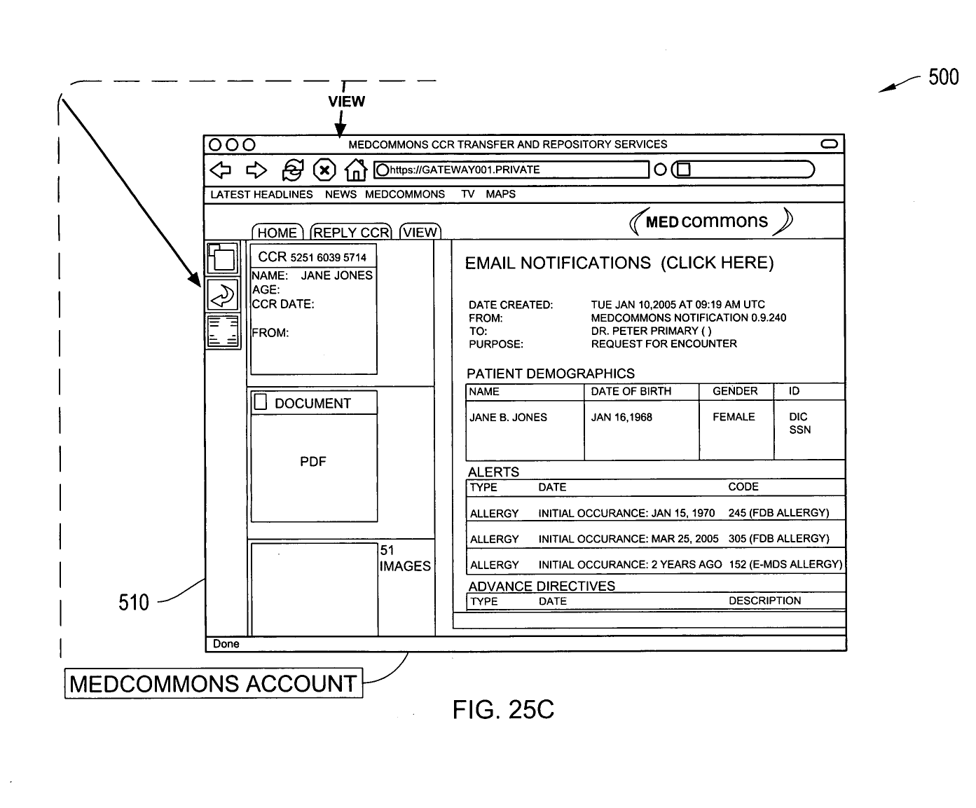

FIGS. 25A-C include exemplary views 500 of the process of sending a patient CCR to a health organization according to an illustrative embodiment of the invention. First, a patient accessing her personal health record sends a notification to a healthcare professional, e.g., goodmd@stmungos.com who may have a single-sign-on federation agreement as in the previous paragraph or might require separate authorization with a PIN. Then, a patient uses personal health record software to access the registry record for a particular patient, e.g., Jane Doe as illustrated in web form 502. The healthcare professional may send a particular document and/or PHR to a regional repository and/or registry using CXP as illustrated by web form 504. The patient and/or healthcare professional may click on the tracking number associated with a particular document and/or CCR (shown in form 508) to obtain single sign access to a CCR as illustrated by web form 510. In some single sign on instances, the user's identity is pseudonymous to the regional registry because access, in one embodiment, is based on well known Liberty Alliance protocols where the ID provider IDP is separate from the accessing personal or electronic health record.

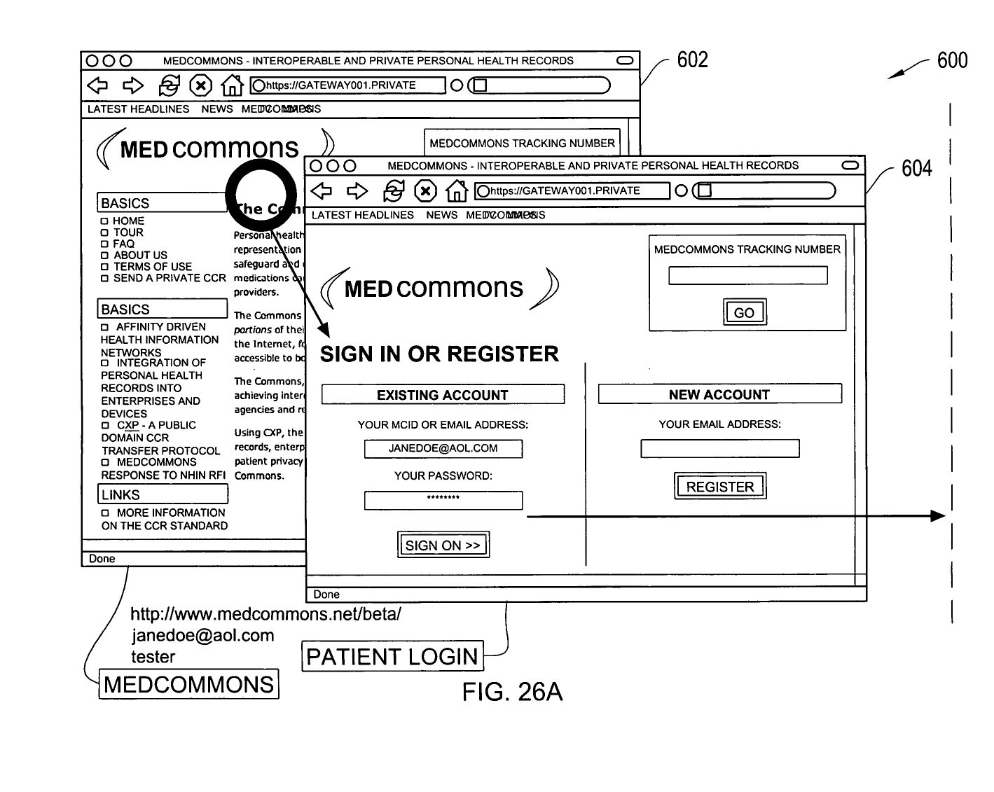

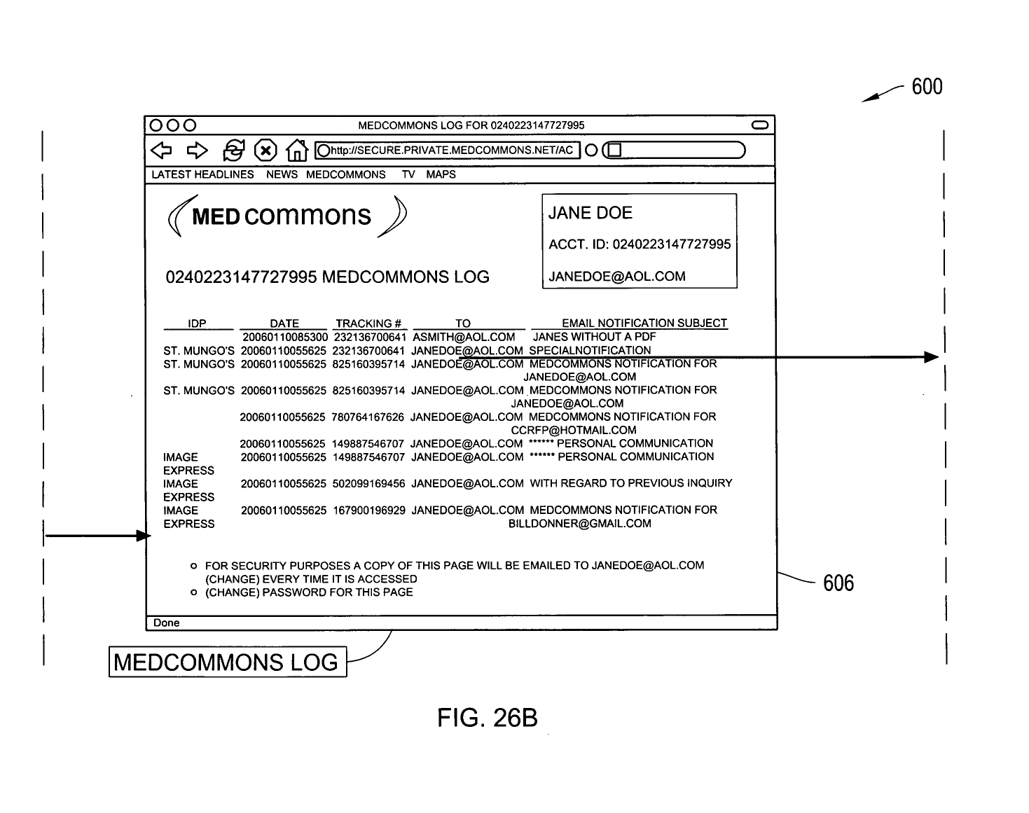

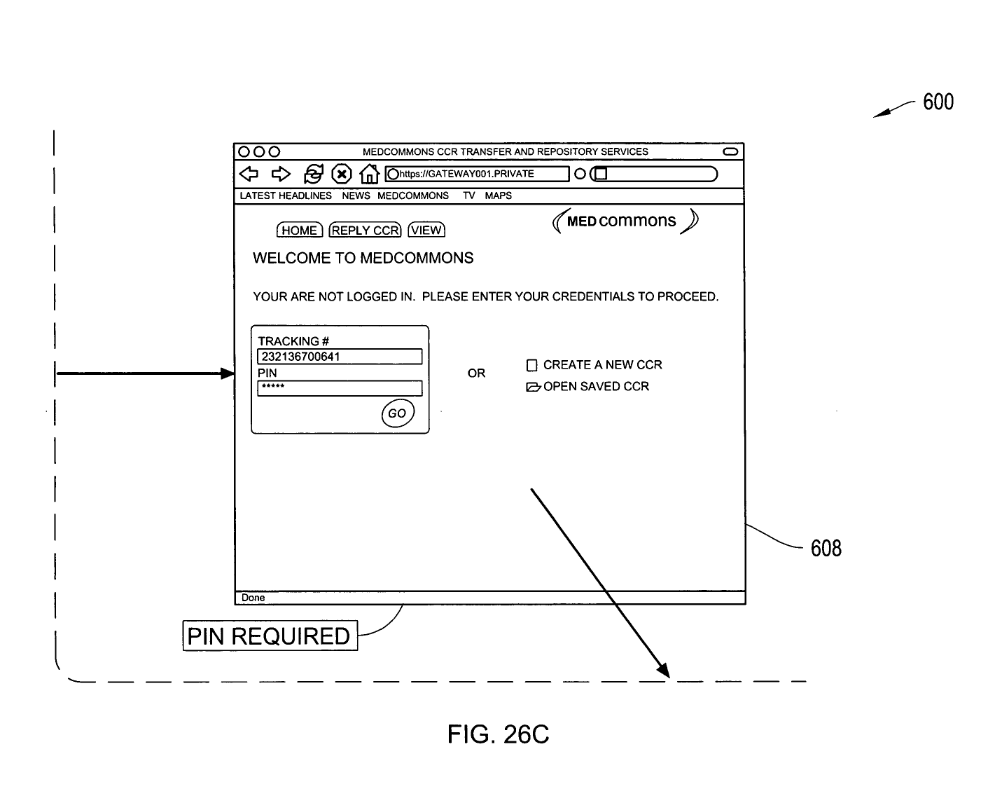

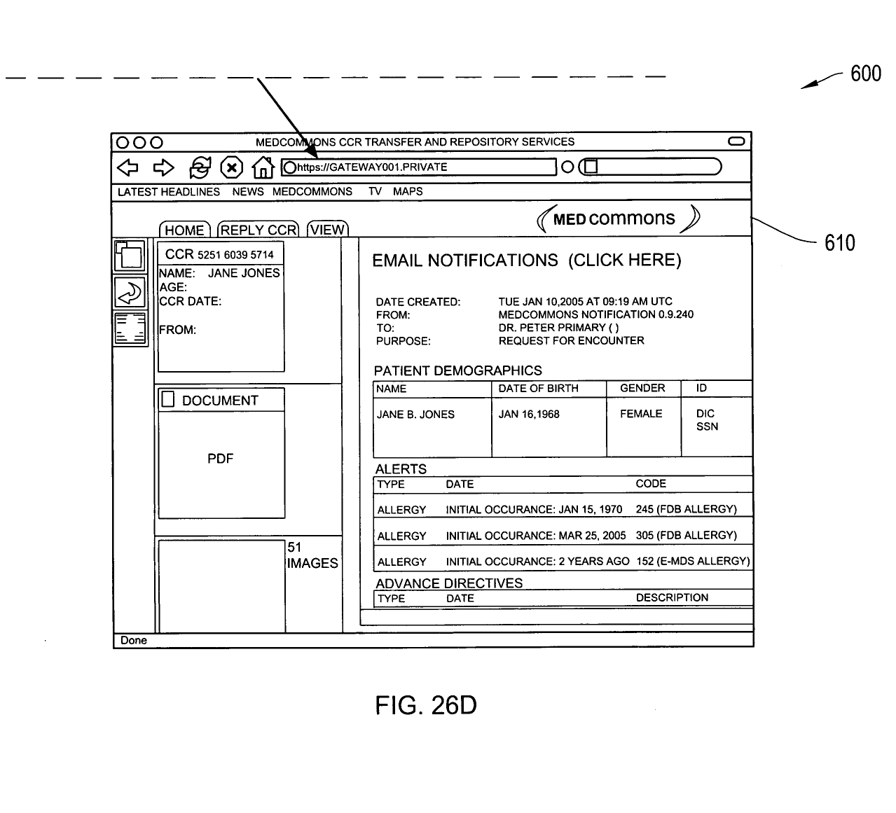

FIGS. 26A-D include exemplary views 600 of the process of a patient single sign on to access their healthcare information according to an illustrative embodiment of the invention. First, a patient uses a web browser to access a web server page associated with a regional register capable of indexing the patient healthcare information as illustrated by web form 602. The patient then signs on to the registry and/or repository using identity information, e.g., an email address, and a password as illustrated by web form 604. In a single-sign-on scenario, form 604 represents contact with a federated identity provider such as AOL that is separate from the registry. Once logged on to the registry, the patient is able to review the index of their healthcare information as shown by web form 606. To preview a particular document, the patient clicks on the tracking number of the particular document. The patient may then be prompted to provide the PIN associated with the tracking number to enable access to the document as shown by web form 608. The PIN may be provided to the patient by a healthcare professional such as the physician that created and/or submitted the particular healthcare document or it might be waived on the basis of the federation agreement and consent/restrictions established between the healthcare provider's enterprise (e.g., St. Mungo's), the patient's identity provider (e.g., AOL) and the patient's registry services provider (e.g., MedCommons). Once logged into the document and/or CCR, the patient is able to view and/or modify certain control information associated with the document.

In certain embodiments, at least one of the registry 302, repository 304, client information system 306, and other elements of the central facility 18 are implemented and/or operate within one or more computer servers, as hardware, software, and/or firmware applications. The registry 302, repository 304, client information system 306, and other central facility 18 elements may include multiple processors and/or multiple computer servers. Each computer information server may include a web server, or other communications server, capable of interfacing with other information servers or with web browsers remotely via a data communications network such as the Internet. The web servers may perform functions using one or more script and/or markup languages such as, without limitation, HTML, SGML, XML, JavaScript, AJAX and WML. The registry, repository, and client information system applications may include software applications based on C, C++, COBOL, BASIC, Java®, assembly language, and like computer program languages. Each of the servers may include one or more transceivers that enable communications via a data network with other entities. The transceivers may support Ethernet, wireless Ethernet, 802.11, WiFi, cellular telephone, wireless local area network (WLAN), satellite, PSTN, and like communication standards. In certain embodiments, a method, system, and/or device is provides for private and secure digital communications among health care providers and patients using standard protocols and the Internet where at least two of the principals to a transfer of protected health information (PHI) (e.g.: sender, recipient, patient) is assigned and controls a private repository. Repositories are accessed using standard protocols such as the ASTM Continuity of Care Record (CCR) and Secure HTTP (SSL). Transfers between repositories are managed by a service (MedCommons) according to consent agreements that are executed between the sender and the patient. The service also provides editing and display technology for the contents of each user's repository and their associated security (e.g.: HIPAA) logs.

With appropriate configuration and management policies, a patient-centric network of repositories can provide private communications between any consenting parties, regardless of institutional affiliation, at very low actual cost while avoiding the hidden costs of vendor lock-in to proprietary formats and methods and without the usual risk to privacy that results from collecting and indexing massive amounts of private information in readily “mined” and very tempting registries.

In one embodiment, a new method for information management based on patient control is implemented that enables a patient to voluntarily control their own identity and to associate their PHI with users they trust independent of their enterprise affiliation. Patient control facilitates interoperability across all potential recipients without artificial enterprise boundaries while providing privacy protections that meet and exceed current HIPAA mandates.

In another embodiment, a service, e.g., MedCommons, enables the digital transfer of PHI documents among repositories and medical devices. Patients may opt-in to PHI transfers by signing a consent document which links the sender, the recipient and the patient. In certain embodiments, consents preserve the patient's privacy because they do not themselves expose PHI to the service—in the role of registrar and transfer agent—and offer control because the clinical documents themselves as delivered to clinicians and other participants in a national information infrastructure are unmodified and provably authentic.

In a further embodiment, an innovation provides for the separation of user identity (as provided by a diversity of independent authorities) from the transfer agent or service (e.g., MedCommons) under the patient's authority (as evidenced in the consent document) using consent documents that do not contain PHI. The use of PHI-free consents enables a PHI service to administer the patient's privacy mandates as well as the more basic HIPAA legal mandates, or other legal mandates, while keeping the privacy risk (and cost) of using a PHI service and/or central repository as transfer agent to a minimum.

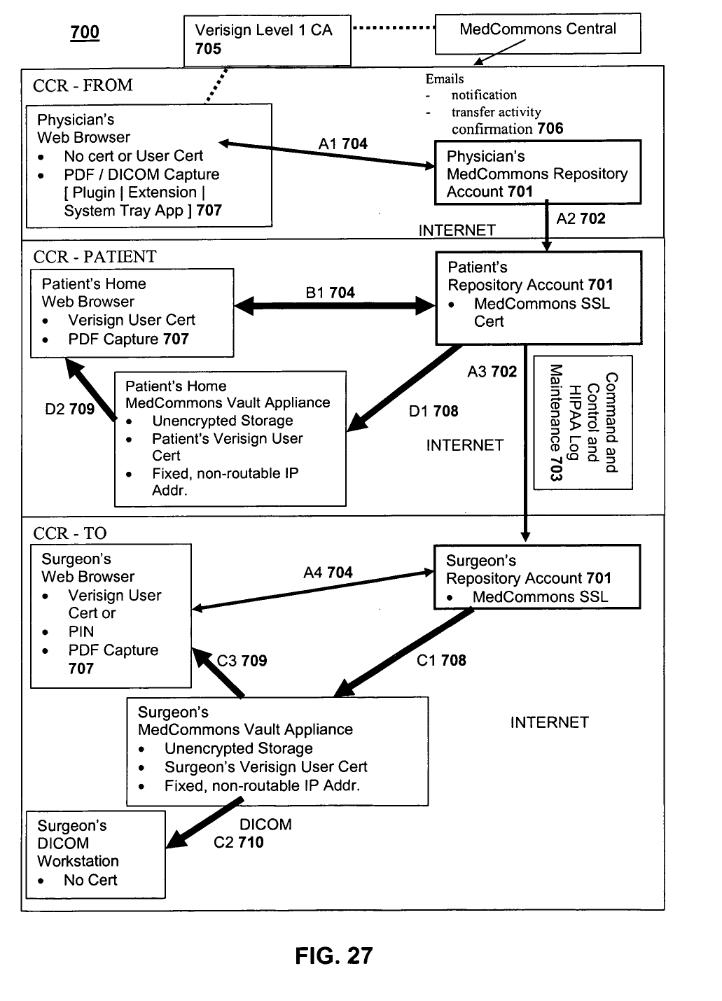

FIG. 27 is a conceptual flow diagram 700 of the interaction of various system users and elements that enable the interchange of PHI according to an illustrative embodiment of the invention. In one embodiment, all Repository Accounts 701 are accessed by Registry ID (e.g., MedCommons ID)—provisional or voluntary. Each Repository Account 701 is encrypted with its own separate key linked to the Registry ID. Provisional accounts are periodically purged per a Terms of Use agreement.

In another embodiment, CCR-driven Transactions 702 create copies of the CCR objects and referenced attachments objects. Some repository server architectures may natively manage redundant objects on the same server or server cluster for reliability and storage efficiency. All Command and Control and HIPAA Log Maintenance may be accessed by Tracking Number and Registry ID.

In a further embodiment, Web browser clients are primarily connected to their user's repository via communication links 704 that operate SSL (PIN privacy) or TLS (Verisign Certificate and Consent privacy). All user certificates are issued by Verisign, or a like Certificate Authority 705, and linked to the user's Registry ID. Providers that choose to link their certificate to their HIPAA National Provider Identifier (NPI) will have the option of a logo on their Consents to allow others to know that they are voluntarily linking their reputation to their professional identity. Other than this voluntary linkage, a provider's certificates and privileges are no different from a patient's.

In certain embodiment, in lieu of transaction logs, all parties to a consent will be notified by Email confirmation 706 whenever a CCR/Transaction (new Tracking Number) is executed based on that Consent. Once in a user's repository account (or vault appliance) repeated viewing/download of that CCR does not trigger repeated Emails or changes in the HIPAA Log entry status.

All users may install native code that performs an automatic upload of PDF capture 707 or DICOM Series objects to a quarantine folder on their Repository Account. The browser Attach New Document command may be used to provisionally add the contents of the quarantine folder to a new CCR pending user validation. For safety, only one object is allowed in the quarantine folder at a time—the most recent upload wins.

In one embodiment, service Vault Appliances are employed that use open source code which maintains an unencrypted local copy of a user's Repository Account (e.g., their Desktop). The vault appliances may never respond to Web-based queries of any sort—not even Ping or status. LAN access by a user of objects in their vault is handled as a feature of their upload plugin via communications link 709. Users that do not have proper certificates to match their vault or have not installed the upload plugin into their browser may only access their vault by direct read of the vault's disk or USB fob.

In certain embodiments, a DICOM workstation or PACS can be the destination of automated or user-initiated transfers from a vault appliance via communications link 710. As with other transfers from a vault, these transfers may invisible to the registrar or service and related HIPAA Logs. In one embodiment, the DICOM workstation or PACS hosts absolutely no service and/or registrar code unless the user chooses to install their vault directly on their workstation or PACS. In another embodiment, the service and/or registrar does not know or care about this election.

In certain embodiment, at least four use-cases are supported such as Bi-directional DICOM gateways, DICOM query proxies, enterprise portals, enterprise federation and transitive trust will be addressed in the future. In other embodiments, the repository accounts 701 are under the command and control of a service central repository and/or registrar, e.g., MedCommons central repository. The central repository may support HIPAA log maintenance 703.

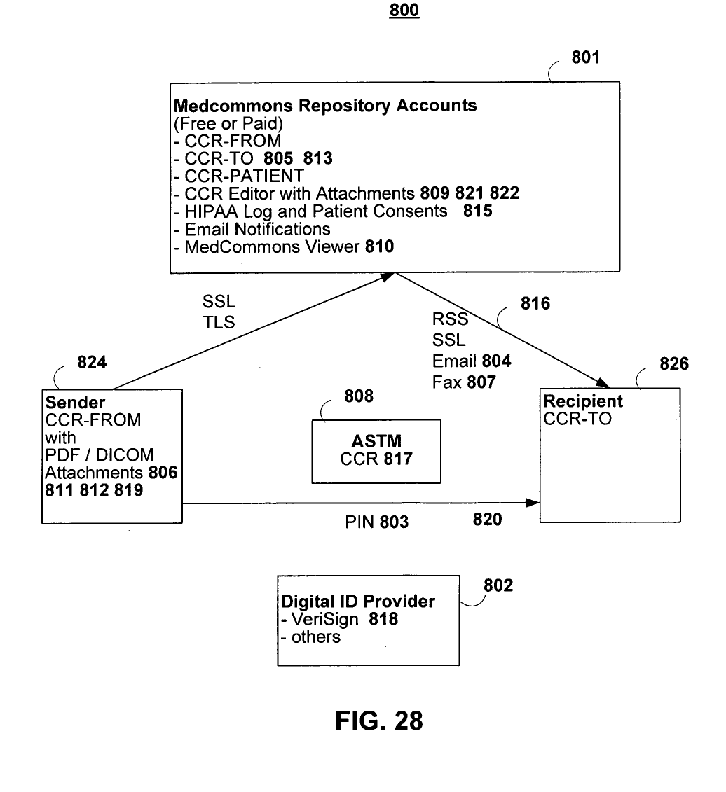

FIG. 28 is a conceptual block diagram showing a system 800 that enables the interchange of PHI via a central repository 801 while using an ID provider 802 to provide PHI security according to an illustrative embodiment of the invention. In one embodiment, the system 800 provides secured transport of standards-controlled XML (CCR) using a Registry/Repository 801. The transport may be secured by a independent ID service and/or provider 802. The transport may be secured by independent Authentication and Authorization via a PIN 803. The system 800 may utilize open notification via email 804 and/or a Registry pointer of all participants to consent 805 for Audit.

In one embodiment, a sender 824 may include attachments 806 to a CCR. The CCR Transfer may be via a legacy Fax 807 with the option of Web access to Attachments. In certain embodiments, a Drop box Interface is employed with a trademarked Registry Logo Button 808. In other embodiments, a Repository Side-effect funds (free) temporary Registry Transport 809. The Repository Viewer and Interface 810 may or may not be proprietary.

In one embodiment, the client systems 811 may be F/OSS. A Prefetch to the Repository 801 may be supported by PKI Certificates. In another embodiment, separate User Repositories with Shared Object Storage are employed instead of access control (SHA-1 Hash GUIDs) to avoid unnecessary duplication. Synchronized On-site Repositories may including (USB) Token and CD /DVD-R.

In another embodiment, Opt-in consents 815 are indexed by the Registry 801. An RSS feed 816 support based on consents may be employed as an alternative to proprietary lists. The Registry 801 may support a Health Care Proxy 817, Break the Glass, and/or Federation. A voluntary ID 818 may be linked by a user as opposed to a database—Federal NPI linkage example for Providers. The sender 824 and/or recipient 826 may employ coded printed fax 819 for scan and upload and/or download and read. The recipient may incur negligible call center costs 20 for the free option. In certain embodiments, the system may perform conversion of (VAN) portal to fixed content (CCR) via a CCR editor 21. The conversion 22 may include, without limitation, PDF and/or XML conversions.

In certain embodiments, the system 800 may employ objects that can be readily secured because metadata Registries are Separate. There may be no restrictions on use (like F/OSS) for extensibility as a platform on behalf of patients. Further, the system 800 may employ open standards protocols (WADO) for extensibility and/or provide for open decisions on protocols in the patient interest.

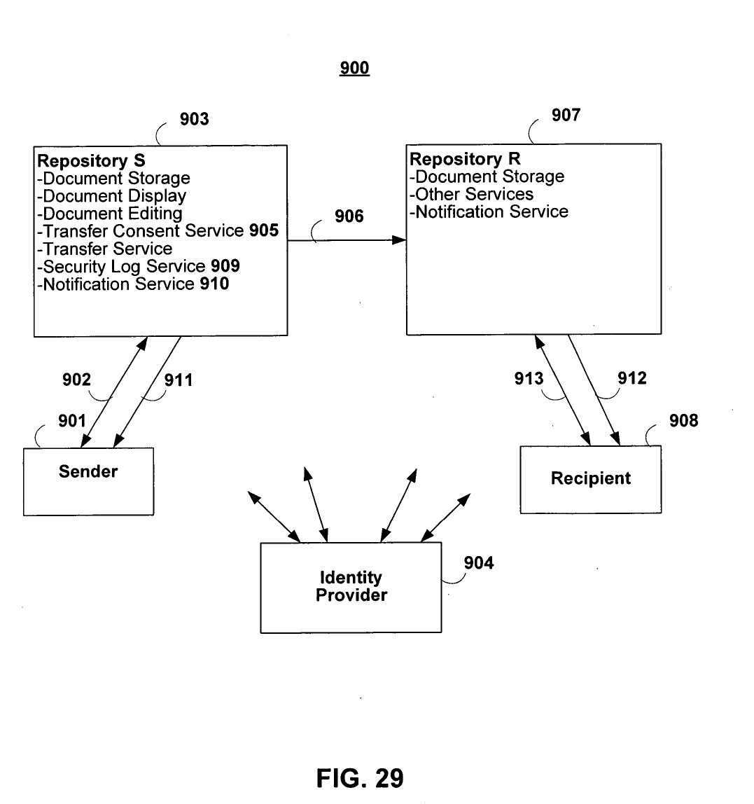

FIG. 29 is a conceptual block diagram of a system 900 including sending and receiving repositories 903 and 907 of PHI according to an illustrative embodiment of the invention. In one embodiment, a Sender party 901 uses standards-based document formats and communications protocols 902 to place private information in Repository S 903 that they control based on information and services managed by Identity Provider 904 along with disclosure and consent authority 905 under the control of the (patient or the sender) Repository S 903 account owner. The account owner's identity provider may be Repository S itself, Identity Provider 904 or another federated identity provider. The Sender 901 executes a notification or disclosure request 910 with the service provider for Repository S 903 that allows the service provider to Transfer, using mutually agreed and typically standard protocol 906, a copy of private information in Repository S 903 to Repository R 907 that is controlled by and accessible to Recipient 908.

The Repository S 903 supports a Security Log service 909 as well as a Notification Service 910 that serves alert and/or security audit functions by optionally sending messages 911 to various parties according to the consent Agreement 905 and/or the contents of private information Transfer 906. Notifications 911 need not be private and secure as long as they use opaque (e.g.: random) pointers into their respective repository and therefore do not contain or divulge private information.

In one embodiment, the service provider for Repository R 907 operates a Notification Service associated with their repository and can send out a Notification 912 to their account holder Recipient 908 which will typically be followed by the Recipient 908 accessing the private information in the Repository R 907 that they control using protocols 913. A key benefit of the system 900 arises when the Recipient 908 is responsible for their own private Repository 907 because this enables the service provider for Repository 903 to automatically and cost-effectively fulfill their security obligations to the parties to the consent 905, as long as either Repository S 903 trusts Repository R 907 or Repository S 903 encrypts the Transfer 906 using a key accessible only to Recipient 908 such as might be provided and published by Identity Provider 904.

In one embodiment, the Consent 905 to transfer of information 906 requires separate recipient notification and transfer phases. For example, Repository S may trust Repository R with account notification information such as the patient's name or account ID but requires the actual identity of Recipient 908 for the second phase of PHR transfer. This transfer condition could be satisfied automatically if Repository S 903 trusts Repository R 907 unconditionally or it could require that Recipient 908 or Repository R 907 assert specific credentials such as might be provided and published by Identity Provider 904.

Although the Repository S 903 can communicate with Repository R 907 using standard documents and protocols between unaffiliated parties, a further key benefit arises when Repository S 903 and Repository R 907 are operated by the same service provider or trust each other. In this embodiment, it may be possible to avoid unnecessary duplication of some or all of the private information objects referenced in Transfer 906. This sharing of stored objects is particularly important for diagnostic imaging studies and high resolution genetic profiles.

Further, the system 900 enables each party to communicate and interoperate with each other whether they trust each other's service provider or not because formats and protocols 902 and 906 (and in the preferred embodiments 912 and 913) are standard (e.g.: ASTM-CCR documents with PDF and DICOM objects attached over secure HTTP). Also, one or more standards-compliant and typically independent Identity Provider 904 support standard attestation protocols such as SAML and federation mechanisms such as Liberty Alliance along with standard public key encryption (PKI) certificates.

Using system 900, a patient can control and protect their identity even when the Sender 901 and Recipient 908 are communicating about them. Using well known federation and single sign-on protocols such as SAML 2.0 and Liberty Alliance, the patient presents pseudonym A to the Sender 901 and pseudonym B to the Repository 907 under control of Recipient 908. Document transfer 902 is anonymized and re-identified by Repository S prior to transfer and notification 906 according to patient-controlled consent 905. Through the use of well known federation protocols in conjunction with the patient controlled intermediary Repository 903, the user's identity is protected as Repository 903 maintains Security Log 909 based on separate institutional trust agreements and pseudonyms between Sender 901 and Repository S on one side of the patient controlled intermediary and Repository S and Repository R on the other side of the patient controlled intermediary. HIPAA privacy mandates are therefore fulfilled by the disclosing Sender 901 even if they themselves do not have a trust agreement with Repository R or the Recipient 908.

Using system 900 in the federated trust intermediary mode described above is particularly beneficial when Repository R 907 is a regional or national record locator service operated by a regional health information organization (RHIO). In this embodiment, Sender 901 discharges her responsibility to list the document associated with protocol 902 in the record locator service Repository 907 even as Repository 903 enforces the patient's Consent 905 as to what information should be available to potential recipients 908 who query record locator service repository 907.

Using system 900, the Sender 901, be they a clinician or a patient, is able to communicate and interoperate with any individual or enterprise they trust by executing a consent document with their own service provider that identifies the Recipient 908 in a mutually acceptable way including the use of a third party Identity Provider 904 or by simply communicating a shared secret (PIN) that enables access protocols 913 into Repository R 907 which in some cases will be temporarily set up as a service of the Sender's Repository services provider. This combination of standards and a bank-like repository services provider that answers only to the Sender 901 (who may be the patient themselves) protects the sender's privacy because their association with their repository services provider is effectively voluntary and independent of hospitals, insurers, employers and other enterprises that may be subject to conflict-of-interest with respect to the patient's privacy. As a result, Privacy and Interoperability are advantageously no longer in conflict.

In another embodiment, the system 900 enables the adaptation of Federated Identity Based Services to Person-Centered Medical Communications. Medical Communications (e.g.: CCR) are often private to the two practitioners (CCR-FROM and CCR-TO) even as they center on a person as the third party (CCR-PATIENT). The person (patient), by linking informed consent (granted to the Sender, CCR-FROM, for information practices) to use of an intermediary controlled by the person can ensure that they have a timely copy and a comprehensive personal health record. The mechanism for implementing the intermediary (e.g.,CXP) includes provision for specifying the consent intermediary (CXP Primary Registry) as well as the destination to be notified (CXP Secondary Registry) is obvious and in the public domain. Federated identity-based services (e.g.: Liberty Alliance Project) are a well known mechanism for control by a person of disclosure of their private information. The innovation of a Federated primary registry as the trusted intermediary between the Sender (CCR-FROM) and the Receiver (CCR-TO or CXP Secondary Registry) where the Sender trusts (and is Federated) with the primary registry and the Receiver is trusted (and may be Federated) by the primary registry even though there is no direct trust agreement between Sender and Receiver.

The combination of CXP and Liberty Alliance protocols allows the Sender to fulfill their HIPAA obligation to the patient without the risk and cost of establishing a trust relationship directly with the Recipient. The effectiveness of the primary registry, as the patient's agent, in automatically interpreting the consent to information disclosure is facilitated when the communication is compliant with a standard schema such as CCR.

In one exemplary scenario, a test is performed at an independent lab. First, a Patient shows up the lab. The patient points to his PHR Service by clicking an icon on lab's registration page. This step may include Discovery (ID-WSF) of Federated services that identify and describe a person as a patient. Discoverable items are defined by the (Emergency) CCR PATIENT ACTOR and more. The patient then logs-in to PHR Service directly or via independent IDP such as a cellular carrier. This step may include a patient log-in (SAML 2.0) which provides consent to transfer (ID-WSF) some or all of the discoverable items.

The lab retrieves patient account information from the PHR Service. This step may include a transfer (ID-WSF) of some or all of the discoverable items from the patient information service to the federated laboratory service. The lab then performs tests and generates a report. The lab creates (or updates) a CCR with the patients account information. For example, the report includes test results, TO: Doctor, and FROM: Lab information. The lab sends a CCR using CXP to PHR Service. This step may include a CXP transfer based on information retrieved in the patient account information and the Doctor or Doctor's secondary registry that would be set as part of the test Order which could have been a separate CCR on this patient account or was based on a separate doctor-lab workflow connection.

The PHR Service saves the CCR in the account and primary registry. The PHR Service then notifies the Doctor and/or secondary registry. This may include using CXP as implemented by the primary registry which adds a reference to the CCR to the secondary registry. The Doctor logs into hospital or secondary registry. The Doctor sees the notification. The Doctor selects the CCR. In response, the PHR Service makes a security Log entry. The Patient information (primary) registry may accept assertion (SAML-2.0) based on the federated identity of the Doctor and displays or allows a CXP GET. The assertion is waived if the CCR request is accompanied by the PIN. The Doctor views CCR or uses CXP GET.

In another embodiment, the system 900 enhances Point-to-Point transport and privacy protocols to participate in Federated Multi-Point Networks. In an exemplary scenario, a Patient P presents to a Lab L for a test. The Patient P chooses his Identity Provider IDP 904 which already has a trust agreement with Lab L (Step 1). The Patient P identifies himself by presenting his credentials to ID provider IDP 904 (Step 2). Per Patient P's consent for treatment by Lab L, IDP 904 returns to Lab L an opaque (pseudorandom) pseudonym A for Patient P and information about P's preferred primary registry and PHR service provider S (Step 3). Information pertaining to patient registration, durable account linkage consent, insurance coverage and the test order itself may also be returned by IDP 904 directly or indirectly through PHR Service S. Per Patient P's consent, Lab L returns the test result to Service S 903 along with information for routing the result to the (ordering) Recipient R. (this is CXP) (Step 4).

Per Patient P's consent, the assertion by S, under the trust agreement between L and S and including patient P's pseudonym A is sufficient to fulfill Lab L's privacy (HIPAA) Log mandate (Step 5). Service S notifies test result Recipient R, (subject to optional consent restrictions by Patient P) and identifies the patient using pseudonym B or however the patient wants to be identified (Step 6). Service S may have a trust agreement with Recipient R (Step 7). If pseudonym B was used by Recipient R in placing the order or if the information (e.g.: Patient P's ID number with Recipient R) included in the notification by S is otherwise deemed sufficient, the Recipient R requests the result (Step 8). Per patient P's consent with Service S, Service S accepts the assertion by Recipient R under the trust agreement between S and R and uses it to fulfill their privacy Log mandate (Step 9). The test result is transported from S to R (possibly via CXP) labeled with pseudonym B (Step 10). If S and R do not have a trust agreement in place, steps 7, 8 and 9 are replaced by the PIN as supplied by Recipient R. Thus, a PHR service provider performs the above steps, as a destination of a point-to-point transport, when they notify a third party recipient using a patient identifier B that was different from the identifier A that was presented to the sender.

In review, the invention provides a patient controlled intermediary (Repository S 903) that can “escrow” a transfer of a standard healthcare document 902 intended for Recipient 908 by administering the consent 905 in two separate phases: i) the first phase (typically a notification or account linkage phase applicable to an entire institution, region or the entire country) followed by a ii) second potentially stricter phase that requires the identity (or a trusted ID intermediary) of the Recipient.

In other words, the invention, in certain embodiments, combines the interoperability of standard transfer protocols (e.g., CCR and CXP) with standard single-sign-on and federated trust protocols (Liberty Alliance) to enable fine-grained consent on information disclosure by the patient (or whoever controls Repository S). The PIN access alternative to a federated identity provider is a refinement that adds further value to the service. The foregoing embodiment is distinguishable from pure point-to-point transfers where the trust relationships between sender and recipient are not easily subject to modification by an intermediary and patient-controlled Repository S because transfer the mechanism (CXP) 902 does not specify the patient's Repository S 903 separately from the Recipient's Repository R 907.

The foregoing illustrative embodiments, while depicting various healthcare information embodiments, are also applicable to any information distribution system requiring information owners to regulate and/or control the distribution of personal, corporate, and/or governmental information. For example, the foregoing embodiments may be applied to the distribution of personal credit and/or financial information. In this instance, a consumer may with to allow certain financial institutions, such as certain banks or mortgage lenders, to access the consumer's credit history or other financial information which is stored in various repositories. The foregoing embodiments may be applied to distributing personal credentials, educational information, professional experience information, general personal information, gaming information, purchasing information, marketing information, relationship information, and any other personal information where informed consent is desired. Other entities such as corporate and/or governmental entities may desire to allow other parties access to certain private information where informed consent is desired.

It will be apparent to those of ordinary skill in the art that methods involved in the present invention may be embodied in a computer program product that includes a computer usable and/or readable medium. For example, such a computer usable medium may consist of a read only memory device, such as a CD ROM disk or conventional ROM devices, or a random access memory, such as a hard drive device or a computer diskette, having a computer readable program code stored thereon.

While this invention has been particularly shown and described with references to preferred embodiments thereof, it will be understood by those skilled in the art that various changes in form and details may be made therein without departing from the scope of the invention encompassed by the appended claims.

What is claimed is:

1. A healthcare information interchange system comprising:
a sender for originating one or more healthcare information documents associated with a patient,
a first repository in communication with the sender for i) storing the one or more healthcare information documents received from the sender and ii) distributing the one or more healthcare information documents based on consent rules associated with each of the one or more documents,
a recipient for receiving the one or more healthcare information documents based on the consent rules, and
an identity provider for assigning first and second identities to the patient, the first identity being presented to the first repository by the sender to identify the patient, the second identity being presented by the first repository to the recipient to identify the patient.

2. The system of claim 1, wherein the consent rules are based on a consent agreement between the sender and the first repository.

3. The system of claim 1, wherein the consent agreement is derived from a patient healthcare information restriction form.

4. The system of claim 1, wherein the consent rules are based on whether the one or more healthcare information documents are encrypted.

5. The system of claim 4, wherein the first repository distributes the one or more healthcare information documents if the one or more healthcare information documents are determined to be encrypted.

6. The system of claim 1 comprising a second repository in communication with the first repository for receiving the one or more healthcare information documents based on the consent rules associated with each the one or more healthcare information documents, whereby the recipient accesses the one or more healthcare information documents at the second repository.

7. The system of claim 6 wherein the identity provider publishes public encryption key information related to the recipient.

8. The system of claim 7, wherein the consent rules include determining that the one or more healthcare information documents have been encrypted using an encryption key related to the recipient.

9. The system of claim 6, wherein the consent rules are based at least on a PIN associated with the one or more healthcare information documents that is shared between the sender and recipient, the PIN being presented by the recipient to one of the first and second repositories to enable access to the one or more healthcare information documents.

10. The system of claim 1, wherein the sender includes one of a patient, a physician, a healthcare professional, a laboratory, and a hospital.

11. A method for exchanging healthcare information comprising:
originating, from a sender, one or more healthcare information documents associated with a patient,
storing, at a first repository, the one or more healthcare information documents received from the sender,
distributing, from the first repository, the one or more healthcare information documents based on an access control rule associated with each of the one or more documents, and
receiving, at a recipient, the one or more healthcare information documents based on the consent rules, and
assigning, at an identity provider, first and second identities to the patient, the first identity being presented to the first repository by the sender to identify the patient, the second identity being presented by the first repository to the recipient to identify the patient.

12. The method of claim 11, wherein the consent rules are based on a consent agreement between the sender and the first repository.

13. The method of claim 11, wherein the consent agreement is derived from a patient healthcare information restriction form.

14. The method of claim 11, wherein the consent rules are based on whether the one or more healthcare information documents are encrypted.

15. The method of claim 14 comprising distributing, from the first repository, the one or more healthcare information documents if the one or more healthcare information documents are determined to be encrypted.

16. The method of claim 11 comprising accessing, by the recipient, the one or more healthcare information documents from a second repository in communication with the first repository.

17. The method of claim 16 comprising publishing, at the identity provider, the public encryption key information related to the recipient.

18. The method of claim 17, wherein the consent rules includes determining that the one or more healthcare information documents has been encrypted using an encryption key related to the recipient.

19. The method of claim 16, wherein the consent rules are based at least on a PIN associated with the one or more healthcare information documents that is shared between the sender and recipient, the PIN being presented by the recipient to one of the first and second repositories to enable access to the one or more healthcare information documents.

20. The method of claim 11, wherein the sender includes one of a patient, a physician, a healthcare professional, and a hospital.
